(19) United States
(12) Patent Application Publication
(10) Pub. No.: US 2021/0377523 A1
(43) Pub. Date: Dec. 2, 2021

(54) ENCODING DEVICE, ENCODING METHOD, DECODING DEVICE, AND DECODING METHOD

(71) Applicant: SONY CORPORATION, TOKYO (JP)

(72) Inventors: TAKURO KAWAI, TOKYO (JP); KENICHIRO HOSOKAWA, KANAGAWA (JP); TAKAFUMI MORIFUJI, TOKYO (JP); MASARU IKEDA, KANAGAWA (JP); TAKAHIRO NAGANO, KANAGAWA (JP)

(21) Appl. No.: 16/956,553

(22) PCT Filed: Dec. 13, 2018
(86) PCT No.: PCT/JP2018/045817

§ 371 Date: Jun. 19, 2020

(30) Foreign Application Priority Data
Dec. 27, 2017 (JP) 2017-251817

(51) Int. Cl. H04N 19/117; H04N 19/80; H04N 19/182; H04N 19/169; H04N 19/176

(52) U.S. Cl. CPC H04N 19/117; H04N 19/80; H04N 19/176; H04N 19/1883; H04N 19/182

(57) ABSTRACT

The present technology relates to an encoding device, an encoding method, a decoding device, and a decoding method that enable improvement of image quality. The encoding device performs, on a decoded image that is locally decoded, a filtering process of applying a direct current (DC) prediction formula to generate a filtered image, the DC prediction formula being a prediction formula that includes a DC term and performs product-sum operation of a prescribed tap coefficient and a pixel of the decoded image. Moreover, the encoding device encodes an original image by using the filtered image. The decoding device decodes coded data included in an encoded bit stream by using the filtered image to generate a decoded image. Moreover, the decoding device performs a filtering process of applying the DC prediction formula to the decoded image, to generate the filtered image. The present technology can be applied to a case of encoding and decoding of an image.

### TECHNICAL FIELD

The present technology relates to an encoding device, an encoding method, a decoding device, and a decoding method, and particularly to, for example, an encoding device, an encoding method, a decoding device, and a decoding method that enable improvement of image quality.

### BACKGROUND ART

Work is underway to start standardizing future video coding (FVC) as a succeeding standard of high efficiency video coding (HEVC). As an in loop filter (ILF) used for image encoding and decoding, in addition to a deblocking filter and an adaptive offset filter, a bilateral filter and an adaptive loop filter (ALF) have been considered (for example, see Non Patent Document 1).

Furthermore, a geometry adaptive loop filter (GALF) has been proposed as a filter that improves the existing ALF (for example, see Non Patent Document 2).

### CITATION LIST

### Non Patent Document

Non Patent Document 1: Algorithm description of Joint Exploration Test Model 7 (JEM7), 2017 Aug. 19
Non Patent Document 2: Marta Karczewicz, Li Zhang, Wei-Jung Chien, Xiang Li, “Geometry transformation-based adaptive in-loop filter”, IEEE Picture Coding Symposium (PCS), 2016.

### SUMMARY OF THE INVENTION

### Problems to be Solved by the Invention

With the currently proposed ALF, there is a case where accuracy of restoring image quality deteriorated by encoding is not sufficient, and there is a demand for a proposal of an in-loop filter that can further improve the image quality.

The present technology has been made in view of such a situation, and is intended to improve image quality.

### Solutions to Problems

A decoding device of the present technology is a decoding device including: a decoding unit configured to decode coded data included in an encoded bit stream by using a filtered image, to generate a decoded image; and a filter unit configured to generate the filtered image by performing, on the decoded image generated by the decoding unit, a filtering process of applying a direct current (DC) prediction formula, the DC prediction formula being a prediction formula that includes a DC term and performs product-sum operation of a prescribed tap coefficient and a pixel of the decoded image.

A decoding method of the present technology is a decoding method including: decoding coded data included in an encoded bit stream by using a filtered image, to generate a decoded image; and generating the filtered image by performing, on the decoded image, a filtering process of applying a direct current (DC) prediction formula, the DC prediction formula being a prediction formula that includes a DC term and performs product-sum operation of a prescribed tap coefficient and a pixel of the decoded image.

In the decoding device and the decoding method according to the present technology, coded data included in an encoded bit stream is decoded with use of a filtered image, and a decoded image is generated. Furthermore, the filtering process of applying the direct current (DC) prediction formula is performed on the decoded image, the DC prediction formula being a prediction formula that includes a DC term and performs product-sum operation of a prescribed tap coefficient and a pixel of the decoded image, and the filtered image is generated.

An encoding device of the present technology is an encoding device including: a filter unit configured to generate a filtered image by performing, on a decoded image that is locally decoded, a filtering process of applying a direct current (DC) prediction formula, the DC prediction formula being a prediction formula that includes a DC term and performs product-sum operation of a prescribed tap coefficient and a pixel of the decoded image; and an encoding unit configured to encode an original image by using the filtered image generated by the filter unit.

An encoding method of the present technology is an encoding method including: generating a filtered image by performing, on a decoded image that is locally decoded, a filtering process of applying a direct current (DC) prediction formula, the DC prediction formula being a prediction formula that includes a DC term and performs product-sum operation of a prescribed tap coefficient and a pixel of the decoded image; and encoding an original image by using the filtered image.

In the encoding device and the encoding method of the present technology, the filtering process of applying the direct current (DC) prediction formula is performed on the decoded image that is locally decoded, the DC prediction formula being a prediction formula that includes the DC term and performs product-sum operation of a prescribed tap coefficient and a pixel of the decoded image, and the filtered image is generated. Then, an original image is encoded with use of the filtered image.

Note that the encoding device and the decoding device may be independent devices, or may be internal blocks that form one device.

Furthermore, the encoding device and the decoding device can be realized by causing a computer to execute a program. The program can be provided by being transmitted via a transmission medium or by being recorded on a recording medium.

### Effects of the Invention

According to the present technology, image quality can be improved.

Note that the effects described herein are not necessarily limited, and any of the effects described in the present disclosure may be exhibited.

### BRIEF DESCRIPTION OF DRAWINGS

FIG. 1 is a view for explaining a first example of a prediction formula to be used for a filtering process.

FIG. 2 is a view for explaining a second example of a prediction formula to be used for a filtering process as a prediction process.

FIG. 3 is a view for explaining a third example (a first example of a DC prediction formula) of a prediction formula to be used for the filtering process as the prediction process.

FIG. 4 is a view for explaining a DC tap DC #i.

FIG. 5 is a view for explaining a second example of the DC prediction formula.

FIG. 6 is a view for explaining volume conversion of a tap coefficient.

FIG. 7 is a block diagram illustrating an outline of an embodiment of an image processing system to which the present technology is applied.

FIG. 8 is a block diagram illustrating a configuration example of filter units 23 and 33.

FIG. 9 is a block diagram illustrating a configuration example of a class classification unit 51 and a predicting unit 52.

FIG. 10 is a view for explaining a class classification method.

FIG. 11 is a view for explaining a prediction method.

FIG. 12 is a view for explaining difference ADRC.

FIG. 13 is a block diagram illustrating a configuration example of a class classification unit that performs class classification using differential ADRC.

FIG. 14 is a view illustrating an example of a threshold value table.

FIG. 15 is a view for explaining an example of a plurality of class classification methods.

FIG. 16 is a view for explaining an example of a plurality of prediction methods.

FIG. 17 is a flowchart for explaining an outline of an encoding process by an encoding device 20.

FIG. 18 is a flowchart for explaining an outline of a decoding process by a decoding device 30.

FIG. 19 is a block diagram illustrating a detailed configuration example of the encoding device 20.

FIG. 20 is a block diagram illustrating a configuration example of an ILF 111.

FIG. 21 is a block diagram illustrating a configuration example of a learning device 131.

FIG. 22 is a block diagram illustrating a configuration example of a prediction device 132.

FIG. 23 is a flowchart for explaining an example of the encoding process by the encoding device 20.

FIG. 24 is a flowchart for explaining an example of a predictive encoding process.

FIG. 25 is a flowchart for explaining an example of the filtering process.

FIG. 26 is a block diagram illustrating a detailed configuration example of the decoding device 30.

FIG. 27 is a block diagram illustrating a configuration example of an ILF 206.

FIG. 28 is a block diagram illustrating a configuration example of a prediction device 231.

FIG. 29 is a flowchart for explaining an example of the decoding process by the decoding device 30.

FIG. 30 is a flowchart for explaining an example of a predictive decoding process.

FIG. 31 is a flowchart for explaining an example of the filtering process.

FIG. 32 is a block diagram illustrating a configuration example of an embodiment of a computer to which the present technology is applied.

### MODE FOR CARRYING OUT THE INVENTION

<Documents and the Like that Support Technical Contents and Technical Terms>

The scope disclosed in the present application includes not only the contents described in the present specification and the drawings, but also the contents described in the following documents known at the time of filing of the application.

Document 1: AVC standard (“Advanced video coding for generic audiovisual services”, ITU-T H.264 (April/2017))

Document 2: HEVC standard (“High efficiency video coding”, ITU-T H.265 (December/2016))

Document 3: FVC Algorithm description (Algorithm description of Joint Exploration Test Model 7 (JEM7), 2017 Aug. 19)

That is, the contents described in the above-mentioned documents are also the basis for determining support requirements. For example, quad-tree block structure described in Document 1, and quad tree plus binary tree (QTBT) and block structure described in Document 3 are within the scope of the disclosure of the present technology and satisfy the support requirements of the claims, even in a case where there is no direct description thereof in the embodiment. Furthermore, similarly, technical terms such as parsing, syntax, and semantics, for example, are within the scope of the disclosure of the present technology and satisfy the support requirements of the claims, even in a case where there is no direct description thereof in the embodiment.

Furthermore, in the present specification, “block” (that is not a block indicating a processing part) used for description as a partial region or a unit of processing of an image (picture) indicates any partial region in a picture unless otherwise specified, and a size, a shape, characteristics, and the like are not limited. For example, “block” includes any partial region (unit of processing) such as a transform block (TB), a transform unit (TU), a prediction block (PB), a prediction unit (PU), a smallest coding unit (SCU), a coding unit (CU), a largest coding unit (LCU), a coding tree block (CTB), a coding tree unit (CTU), a transform block, a sub-block, a macro block, a tile, or a slice, described in Documents 1 to 3 described above.

Furthermore, in specifying a size of such a block, it is also possible to indirectly specify the block size in addition to directly specifying the block size. For example, the block size may be specified with use of identification information for identifying the size. Furthermore, for example, the block size may be specified with a ratio with or a difference from a size of a reference block (for example, an LCU, an SCU, or the like). For example, in a case of transmitting information for specifying the block size as a syntax element or the like, the information for indirectly specifying the size as described above may be used as the information. By doing like this, an information amount of the information can be reduced, and encoding efficiency can be improved in some cases. Furthermore, the specification of the block size also includes specification of a range of the block size (for example, specification of a range of allowable block sizes, and the like).

### Definition

In this application, the following terms are defined as follows.

Coded data is data obtained by encoding an image, for example, data obtained by orthogonally transforming and quantizing (a residual of) an image.

An encoded bit stream is a bit stream that includes coded data, and includes encode information related to encoding as necessary. The encode information includes information necessary for decoding coded data, that is, for example, includes at least a quantization parameter QP in a case where quantization is performed in encoding, a motion vector in a case where predictive encoding (motion compensation) is performed in encoding, and the like.

Acquirable information is information that can be acquired from the encoded bit stream. Therefore, the acquirable information is also information that can be acquired by any of an encoding device that encodes an image to generate the encoded bit stream, and a decoding device that decodes the encoded bit stream into an image. The acquirable information includes, for example, encode information included in the encoded bit stream, and an image feature amount of an image obtained by decoding the coded data included in the encoded bit stream.

A prediction formula is a polynomial for prediction of second data from first data. In a case where the first data and the second data are images (data), for example, the prediction formula is a polynomial for prediction of a second image from a first image. Each term of the prediction formula that is such a polynomial includes a product of one tap coefficient and one or more prediction taps. Therefore, the prediction formula is a formula for performing product-sum operation of the tap coefficient and the prediction tap. When (a pixel value of) a pixel as an i-th prediction tap to be used for prediction among pixels of the first image is represented as xᵢ, an i-th tap coefficient as wᵢ, and (a prediction value of a pixel value of) a pixel of the second image as y′, individually, and a polynomial including only a first-order term is adopted as the prediction formula, the prediction formula is represented by a formula y′=Σwᵢxᵢ. In the formula y′=Σwᵢxᵢ, represents a summation for i. The tap coefficient wᵢ included in the prediction formula is obtained by learning for statistically minimizing an error y′−y of the value y′ obtained by the prediction formula, from a true value y. As a learning method for obtaining a tap coefficient, there is a least square method. In learning for obtaining a tap coefficient, with use of a student image, which corresponds to a first image to which the prediction formula is applied, as a student data (an input xᵢ to the prediction formula) serving as a student of the learning, and with use of a teacher image, which corresponds to the second image that is desired to be obtained as a result of applying the prediction formula to the first image, as teacher data (the true value y of the prediction value obtained by operating the prediction formula) serving as a teacher of the learning, a normal equation is obtained by adding coefficients (a summation of coefficients) of individual terms included in the normal equation, and a tap coefficient is obtained by solving the normal equation.

A prediction process is a process of predicting the second image by applying the prediction formula to the first image. In the prediction process, a prediction value of the second image is obtained by performing product-sum operation as an operation of the prediction formula by using (a pixel value of) a pixel of the first image. Performing the product-sum operation by using the first image can be said to be a filtering process of applying a filter to the first image, and the prediction process of performing product-sum operation of the prediction formula (product-sum operation as an operation of the prediction formula) by using the first image can be said to be a type of the filtering process.

A filtered image means an image obtained as a result of the filtering process. The (prediction value of) second image obtained from the first image by the filtering process as the prediction process is the filtered image.

A tap coefficient is a coefficient included in each term of a polynomial that is the prediction formula, and corresponds to a filter coefficient by which a signal to be filtered is multiplied in a tap of a digital filter.

A prediction tap is (a pixel value of) a pixel used for operation of the prediction formula, and is multiplied by the tap coefficient in the prediction formula. The prediction tap includes, in addition to (the pixel value of) the pixel itself, a value obtained from the pixel, for example, a sum or an average value of (pixel values of) the pixels in a certain block, and the like

Here, selecting a pixel or the like as the prediction tap to be used for operation of the prediction formula corresponds to providing (arranging) a connection line to supply a signal serving as an input, to a tap of a digital filter. Therefore, selecting a pixel as the prediction tap to be used for operation of the prediction formula is also referred to as “providing a prediction tap”. This similarly applies to a class tap.

Class classification means classifying a pixel into any one of a plurality of classes. The class classification is performed using, for example, a class tap or the like.

A class tap is (a pixel value of) a pixel used for the class classification. The class classification using the class tap can be performed, for example, by performing threshold value processing on an image feature amount of (a pixel serving as) the class tap. Note that the class classification can be performed not only using the class tap, but also using encode information included in the acquirable information. For example, in a case where a deblocking filter is applied in the encoding device and the decoding device, the class classification can be performed using deblocking filter (DF) information regarding the deblocking filter as the encode information. Specifically, the class classification can be performed by using, as the DF information for every pixel, the fact that whether any one of a strong filter or a weak filter has been applied or neither has been applied in a deblocking filter, for example.

A higher-order term is a term having a product of (pixels as) two or more prediction taps among terms included in a polynomial as a prediction formula.

A D-th order term is a term having a product of D pieces of prediction tap among terms included in a polynomial as a prediction formula. For example, a first-order term is a term having one prediction tap, and a second-order term is a term having a product of two tap coefficients.

A D-th order coefficient means a tap coefficient included in the D-th order term.

A D-th order tap means (a pixel as) a prediction tap included in the D-th order term. Certain one pixel may be a D-th order tap, and may be a D′-th order tap different from the D-th order tap. Furthermore, a tap structure of the D-th order tap and a tap structure of the D′-th order tap different from the D-th order tap need not necessarily be the same.

The tap structure means an arrangement of a pixel as a prediction tap or a class tap (for example, based on a position of a target pixel). The tap structure can also be said to be a way of providing a tap of a prediction tap or a class tap.

A DC prediction formula is a prediction formula including a DC term.

The DC term is a term of a product of a tap coefficient and a value representing a DC component of an image as a prediction tap, among terms included in a polynomial as a prediction formula.

A DC tap means a prediction tap of the DC term, that is, a value representing a DC component.

A DC coefficient means a tap coefficient of the DC term.

A first-order prediction formula is a prediction formula including only a first-order term.

A higher-order prediction formula is a prediction formula including a higher-order term, that is, a prediction formula including a first-order term and a higher-order term of second-order or higher, or a prediction formula including only a higher-order term of second-order or higher.

When an i-th prediction tap (a pixel value or the like) to be used for prediction among pixels of the first image is represented as xᵢ, an i-th tap coefficient as wᵢ, and (a prediction value of a pixel value of) a pixel of the second image obtained by the prediction formula as y, individually, the first-order prediction formula is represented by a formula y=Σwᵢxᵢ.

Furthermore, a higher-order prediction formula including only a first-order term and a second-order term is represented by, for example, a formula y=Σwᵢxᵢ+Σ(Σw_{j,k}xₖ)xⱼ.

Moreover, for example, a DC prediction formula in which the DC term is included in the first-order prediction formula is represented by, for example, a formula Σwᵢxᵢ+w_{DCB}DCB. Here, w_{DCB} represents the DC coefficient, and DCB represents the DC tap.

The tap coefficients of the first-order prediction formula, the higher-order prediction formula, and the DC prediction formula can all be obtained by performing learning with the least square method as described above.

Volume conversion of a tap coefficient means approximating, with a polynomial, a tap coefficient included in a prediction formula, that is, obtaining a coefficient (a seed coefficient) included in the polynomial.

A coefficient prediction formula is a polynomial that approximates a tap coefficient w in volume conversion. The coefficient prediction formula includes a term using a seed coefficient βₘ and a parameter z, and is represented by, for example, a formula w=Σβₘz^{m-1}. In the formula w=Σβₘz^{m-1}, Σ represents a summation for m, and the seed coefficient βₘ represents an m-th coefficient in the coefficient prediction formula. According to the coefficient prediction formula w=Σβₘz^{m-1}, various tap coefficients w are approximated with the parameter z as a variable. As the parameter z, for example, a value corresponding to the acquirable information (for example, the same value as the quantization parameter QP or the like) can be adopted. Furthermore, as the parameter z, for example, additionally, it is possible to adaptively make selection (determination) on the basis of a prescribed index such as optimizing encoding efficiency (for example, rate-distortion (RD) cost or the like).

In the coefficient prediction formula w=Σβₘz^{m-1}, a maximum value M of a variable m for which the summation (Σ) is obtained can be determined to a fixed value in advance. Furthermore, additionally, the maximum value M of the variable m can be adaptively selected on the basis of a prescribed index such as, for example, optimizing encoding efficiency.

The seed coefficient means a coefficient of the coefficient prediction formula used for volume conversion. The seed coefficient can be obtained by learning that is similar to the learning for obtaining a tap coefficient. That is, for example, the seed coefficient βₘ included in the coefficient prediction formula w=Σβₘz^{m-1} can be obtained by performing, with the least square method, for example, learning for statistically minimizing an error w′-w of a value (a prediction value of a tap coefficient) w′ obtained with the coefficient prediction formula w=Σβₘz^{m-1}, from a true value w. The learning for obtaining the seed coefficient βₘ can be performed, for example, by using, as teacher data, a tap coefficient of a prediction formula for predicting an original image from a decoded image that is encoded and decoded with a certain quantization parameter QP, and using a parameter z corresponding to the quantization parameter QP as student data.

A prediction method means a method of a prediction process using a prediction formula. The prediction method is defined (delimited) by, for example, the prediction formula to be used for the prediction process, a tap structure of a prediction tap (a way of providing a tap), a unit for performing the prediction process (a unit of pixels to which the prediction formula of a same tap coefficient is applied), and the like.

Prediction method information is information indicating the prediction method. The prediction method information includes, as necessary, information indicating a prediction formula to be used for the prediction process, information indicating a tap structure of a prediction tap, and information indicating a unit for performing the prediction process.

A class classification method means a method of class classification. The class classification method is defined by, for example, information to be used for the class classification (an image feature amount and the like), a tap structure of a class tap (a way of providing a tap), and a unit for performing the class classification (a unit of pixels classified into a same class in the class classification), and the like.

Classification method information is information indicating the class classification method. The classification method information includes, as necessary, information indicating an image feature amount and the like to be used for class classification, information indicating a tap structure of a class tap, and information indicating a unit for performing the class classification.

Coefficient information is information related to a tap coefficient included in a prediction formula. Various information related to the tap coefficient may be adopted as the coefficient information. For example, the coefficient information includes the tap coefficient itself, a seed coefficient included in a coefficient prediction formula for obtaining the tap coefficient, or a coefficient identification (ID) for identifying the tap coefficient or the seed coefficient. The coefficient ID can be used in specifying a set of tap coefficients or seed coefficients to be used in the prediction process from a plurality of sets of tap coefficients or seed coefficients preset in the decoding device, or tap coefficients or seed coefficients already received by the decoding device. Furthermore, in a case where the coefficient information includes a seed coefficient or a coefficient ID for identifying the seed coefficient, the coefficient information further includes a parameter z to be used for calculating the coefficient prediction formula and an order of the coefficient prediction formula, as necessary. The order of the coefficient prediction formula is, for example, a value M−1, which is smaller by 1 than the maximum value M of the variable m for which the summation (Σ) is obtained, in a case where the coefficient prediction formula is represented by the formula w=Σβₘz^{m-1}. According to the order of the coefficient prediction formula, it is possible to specify a range of the summation (Σ) in obtaining the tap coefficient w in accordance with the coefficient prediction formula w=Σβₘz^{m-1}.

<Outline of Present Technology>

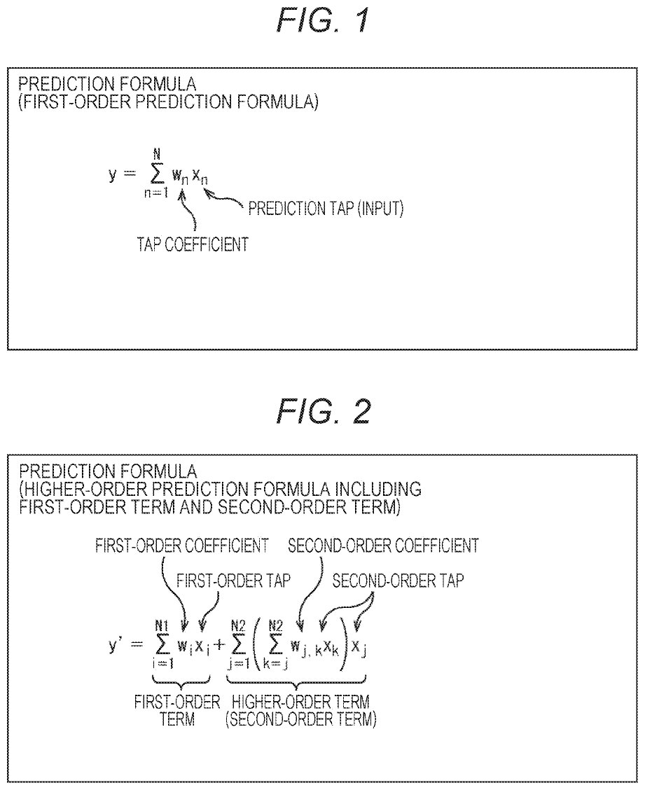

FIG. 1 is a view for explaining a first example of a prediction formula to be used for a filtering process as a prediction process of predicting an original image with respect to a decoded image, from the decoded image subjected to encoding and decoding (including local decoding).

As the prediction formula to be used for (the filtering process as) the prediction process of predicting an original image with respect to the decoded image from the decoded image, for example, a prediction formula of Formula (1) as shown in FIG. 1 can be adopted.

y=Σwₙxₙ (1)

In the prediction formula y=Σwₙxₙ of Formula (1), y represents a (prediction value of a pixel value of) corresponding pixel, which corresponds to a target pixel of interest in the decoded image, of an original image, and Σ represents summation with n changed to an integer from 1 to N. Furthermore, wₙ represents an n-th tap coefficient, and xₙ represents (a pixel value of) a pixel of a decoded image selected as an n-th prediction tap for the target pixel. N represents the number of tap coefficients wₙ (and prediction taps xₙ) included in the prediction formula y=Σwₙxₙ.

The prediction formula y=Σwₙxₙ is a first-order prediction formula including only a first-order term. According to the first-order prediction formula, it is possible to improve image quality of a filtered image obtained by applying the first-order prediction formula to the decoded image with the tap coefficient wₙ having a relatively small data amount. However, with the first-order prediction formula, there is a case where it is difficult to accurately restore details of the original image.

As the prediction formula to be used for the prediction process, in addition to the first-order prediction formula, it is possible to adopt: a higher-order prediction formula that is a polynomial in which the pixel xₙ is second-order or higher; a DC prediction formula that is a polynomial including a DC term; and the like.

FIG. 2 is a view for explaining a second example of the prediction formula to be used for the filtering process as the prediction process.

As the prediction formula to be used for the prediction process, for example, a higher-order prediction formula as shown in FIG. 2 can be adopted.

As the higher-order prediction formula, any polynomial can be adopted as long as it is a polynomial including a higher-order term (a higher-order term of second-order or higher) in which a term is a product of one tap coefficient and (a pixel value of) a pixel as one or more prediction taps. That is, as the higher-order prediction formula, it is possible to adopt, for example: a polynomial including only a first-order term (a term of a first order) and a second-order term (a term of a second order); a polynomial including a first-order term and a plurality of higher-order terms of different orders of second order or higher; a polynomial including one or more high-order terms of second-order or higher; or the like.

However, in the following, in order to simplify the description, a case will be described in which the polynomial of Formula (2) including only a first-order term and a second-order term as shown in FIG. 2 is adopted as the higher-order prediction formula.

y=Σwᵢxᵢ+Σ(Σw_{j,k}xₖ)xⱼ (2)

As shown in FIG. 2, in Formula (2), wᵢxᵢ represents a first-order term, and w_{j,k}xₖxⱼ represents a second-order term. Therefore, the higher-order prediction formula of Formula (2) is the polynomial including only the first-order term and the second-order term. Hereinafter, the higher-order prediction formula of Formula (2) including only the first-order term and the second-order term is also referred to as a second-order prediction formula.

In Formula (2), a summation (Σ) of the first-order term wᵢxᵢ is obtained with a variable i changed to an integer in a range from 1 to N1. N1 represents the number of pixels xᵢ as a first-order tap (a prediction tap of the first-order term) among prediction taps, and the number of first-order coefficients (tap coefficients of the first-order term) wᵢ among the tap coefficients. wᵢ represents an i-th first-order coefficient among the tap coefficients. xᵢ represents (a pixel value of) a pixel as an i-th first-order tap among the prediction taps.

Furthermore, in Formula (2), the first summation of two summations of the second-order term w_{j,k}xₖxⱼ is taken with a variable j changed to an integer in a range from 1 to N2, and the second summation is taken with a variable k changed to an integer in a range from j to N2. N2 represents the number of pixels xⱼ (xₖ) as a second-order tap (a prediction tap of the second-order term) among prediction taps, and the number of second-order coefficients (tap coefficients of the second-order term) w_{j,k} among the tap coefficients. w_{j,k} represents a j×k-th second-order coefficient among the tap coefficients. xⱼ and xₖ represent pixels as j-th and k-th second-order taps among the prediction taps, respectively (k>=j).

Note that, here, in order to describe Formula (2), the first-order tap is represented by xᵢ, and the second-order tap is represented by xⱼ and xₖ. However, in the following, the first-order tap and the second-order tap are not particularly distinguished by a suffix added to x. That is, for example, either of the first-order tap or the second-order tap is described by using, for example, xₙ or the like, as the first-order tap xₙ, the second-order tap xₙ, the prediction tap xₙ, or the like. This similarly applies to the first-order coefficient wᵢ and the second-order coefficient w_{j,k} that are tap coefficients.

Now, a higher-order prediction formula that uses, as the prediction tap, all candidate pixels predetermined as candidates of pixels serving as the prediction tap, and has, as a D-th order term, a term of a product of D pieces of (pixel values of) pixel of individual all-case combinations for selecting D pieces of pixel from the candidate pixels while allowing overlapping, is referred to as an all-case prediction formula.

The higher-order prediction formula of Formula (2) is the all-case prediction formula in a case where the number of candidate pixels of the first-order tap is N1 pieces and the number of candidate pixels of the second-order tap is N2 pieces.

In a case where the number of pixels as the first-order tap is N1 pieces, a number N1′ of the first-order terms (and the first-order coefficients) of the all-case prediction formula is equal to the number N1 of the first-order taps. In a case where the number of pixels as the second-order tap is N2 pieces, a number N2′ of the second-order terms (and second-order coefficients) of the all-case prediction formula is expressed by a formula N2′=_{N2}C₂+N2. ^{N2}C₂ represents the number of combinations for selecting two pieces from N2 pieces without overlapping.

According to a higher-order prediction formula such as Formula (2), in a filtered image obtained by applying the higher-order prediction formula to a decoded image, details of an original image can be accurately restored, which has been difficult with a first-order prediction formula. However, in the higher-order prediction formula, when the number N2 of the candidate pixels of the second-order tap is large, the number N2′ of second-order coefficients becomes enormous since the number N2′ of the second-order coefficients is represented by the formula N2′=_{N2}C₂+N2, and a data amount of the tap coefficient (in particular, the second-order coefficient) transmitted from the encoding device to the decoding device increases, which may deteriorate encoding efficiency.

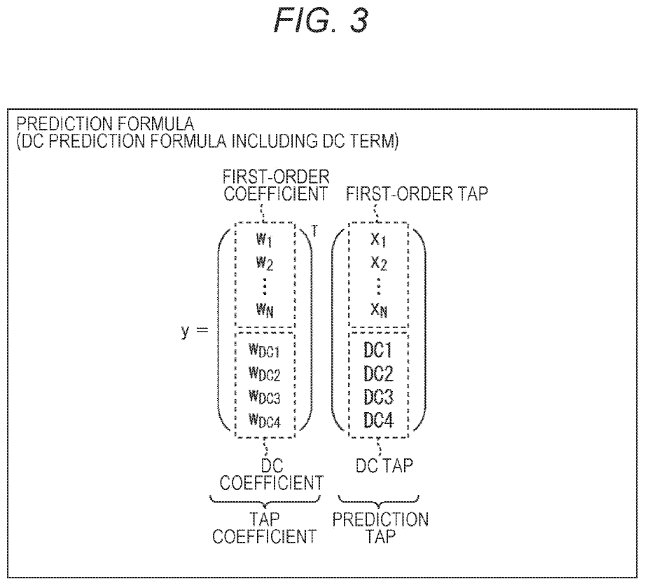

FIG. 3 is a view for explaining a third example of the prediction formula to be used for the filtering process as the prediction process.

That is, FIG. 3 is a view for explaining a first example of the DC prediction formula.

Note that, in the present embodiment, in order to simplify the description, a prediction formula in which a DC term is included in a first-order prediction formula is adopted as the DC prediction formula. However, as the DC prediction formula, a prediction formula in which a DC term is included in a higher-order prediction formula can be adopted.

The DC prediction formula is represented by, for example, Formula (3).

y=WX (3)

In Formula (3), W represents a row vector (a vector obtained by transposing a column vector) having a tap coefficient as an element, and X represents a column vector having a prediction tap as an element.

As shown in FIG. 3, the DC prediction formula of Formula (3) has N pieces of first-order coefficient w₁, w₂, . . . , w_{N} and four pieces of DC coefficient w_{DC1}, w_{DC2}, w_{DC3}, and w_{DC4} as a tap coefficient. Moreover, as shown in FIG. 3, the DC prediction formula of Formula (3) has N pieces of first-order tap x₁, x₂, . . . , x_{N} and four pieces of DC tap DC1, DC2, DC3, and DC4 as the prediction tap.

In this case, the DC prediction formula of Formula (3) is represented by Formula (4).

y=Σwₙxₙ+Σw_{DC #i}DC #i

In Formula (4), the first summation on the right side represents a summation with n changed to an integer in a range from 1 to N, and the second summation on the right side represents a summation with i changed to as 1, 2, 3, and 4.

In the DC prediction formula of Formula (4), w_{DC #i}DC #i is the DC term, and therefore, the DC prediction formula of Formula (4) has four DC terms.

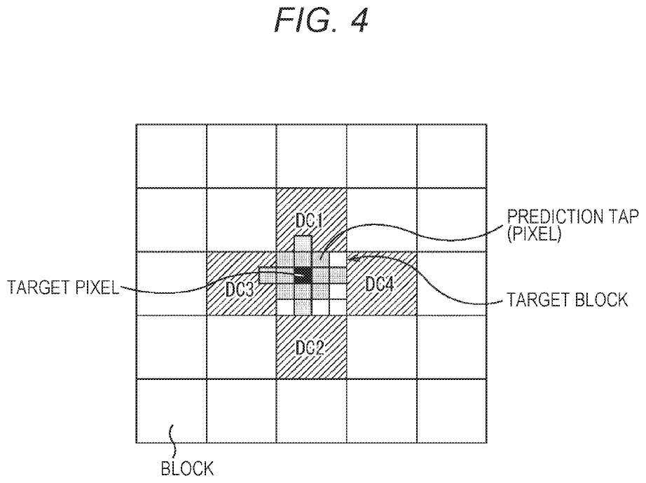

FIG. 4 is a view for explaining a DC tap DC #i in Formula (4).

As the DC tap DC #i, as shown in FIG. 4, it is possible to adopt an average value (or a sum) of pixel values in each of blocks adjacent up, down, left, and right to a block (hereinafter, also referred to as a target block) including a target pixel of a decoded image. As a block for which an average value of pixel values as the DC tap DC #i is obtained, for example, it is possible to adopt a block to which a deblocking filter is applied.

According to the DC prediction formula as Formula (4), encoding distortion such as block distortion can be largely suppressed with an effect of the DC term, in a filtered image obtained by applying the DC prediction formula to a decoded image. However, in the DC prediction formula, for example, although not as much as in the case of the higher-order prediction formula, a data amount of the tap coefficient is increased by an amount of the DC term as compared with the first-order prediction formula having no DC term.

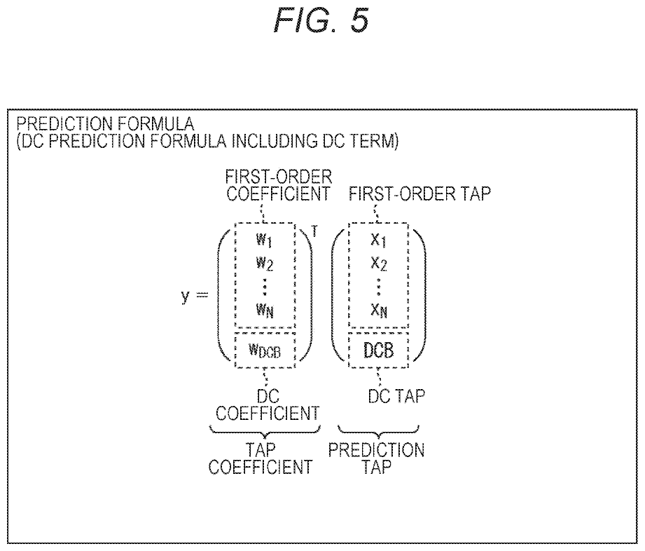

FIG. 5 is a view for explaining a second example of the DC prediction formula.

As shown in FIG. 5, the DC prediction formula of Formula (3) can have, as the tap coefficient, N pieces of first-order coefficient w₁, w₂, . . . , w_{N} and one DC coefficient w_{DCB}. Moreover, as shown in FIG. 5, the DC prediction formula of Formula (3) can have, as the prediction tap, N pieces of first-order tap x₁, x₂, . . . , x_{N} and one DC tap DCB.

In this case, the DC prediction formula of Formula (3) is represented by Formula (5).

y=Σwₙxₙ+w_{DCB}DCB

In the DC prediction formula of Formula (5), w_{DCB}DCB is the DC term, and therefore, the DC prediction formula of Formula (5) has only one DC term.

As the DC tap DCB included in the DC term w_{DNB}DCB of Formula (5), it is possible to adopt an interpolation value obtained by performing interpolation according to a distance between the target pixel and each of blocks adjacent up, down, left, and right to the target block, with use of an average value (or a sum) of pixel values in each of the blocks adjacent up, down, left, and right to the target block shown in FIG. 4. For such interpolation, linear interpolation, bilinear interpolation, or other interpolation can be adopted.

According to the DC prediction formula of Formula (5), encoding distortion such as block distortion can be largely suppressed, similarly to the DC prediction formula of Formula (4). Moreover, in the DC prediction formula of Formula (5), since the number of DC terms is smaller than that of the DC prediction formula of Formula (4), a data amount of the tap coefficient (DC coefficient) can be reduced by the amount.

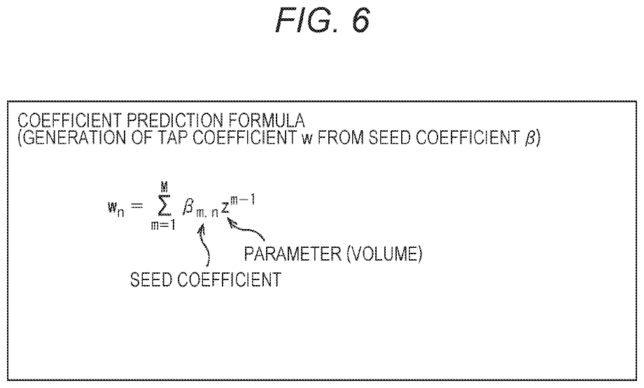

FIG. 6 is a view for explaining volume conversion of a tap coefficient.

In the volume conversion, there is obtained a seed coefficient in a case where a tap coefficient included in the prediction formula is approximated by a polynomial, that is, a coefficient of a coefficient prediction formula that is a polynomial for approximating the tap coefficient.

In the volume conversion, the coefficient prediction formula for obtaining (approximating) the tap coefficient wₙ is represented by, for example, Formula (6) as shown in FIG. 6.

wₙ=Σβ_{m,n}z^{m-1}

Here, in Formula (6), wₙ represents an n-th tap coefficient, and represents a summation with m changed to an integer from 1 to M. β_{m,n} represents an m-th seed coefficient of the coefficient prediction formula for obtaining an n-th tap coefficient wₙ, and z represents a parameter (volume) used to obtain the tap coefficient wₙ by using the seed coefficient β_{m,n}. According to the coefficient prediction formula, it is possible to obtain the tap coefficient wₙ (the tap coefficient wₙ that enables generation of a filtered image having a small error from an original image, for a decoded image having various properties) suitable for a decoded image of various properties (image quality, a motion amount, a scene, and the like) from the seed coefficient β_{m,n}, by giving various parameters z.

Note that, the seed coefficient can be obtained not only for a tap coefficient of the first-order prediction formula, but also for a tap coefficient of the higher-order prediction formula or the DC prediction formula, or a tap coefficient of any other prediction formula.

Here, according to the seed coefficient β_{m,n}, since the tap coefficient wₙ can be obtained from the coefficient prediction formula by giving the parameter z, the seed coefficient β_{m,n} can be said to be information that is (almost) equivalent to the tap coefficient wₙ.

In the encoding device and the decoding device, in a case of adopting, as an ILF filtering process, a prediction process using a prediction formula including a tap coefficient obtained from a seed coefficient, the parameter z of the coefficient prediction formula can be generated, for example, by using acquirable information that can be acquired from an encoded bit stream.

The acquirable information includes, for example, encode information such as the quantization parameter QP included in the encoded bit stream, and an image feature amount of a decoded image obtained by decoding coded data included in the encoded bit stream.

As (a value of) the parameter z, a value corresponding to the encode information or a value corresponding to the image feature amount of the decoded image can be adopted.

For example, by using, as a variable QP: the quantization parameter QP (of a block (a coding unit (CU), and the like)) of a target pixel of the decoded image; an average value of the quantization parameter QP of a frame of the target pixel; or an average value of the quantization parameter QP of a pixel (block) subjected to class classification into a class of the target pixel among pixels of the frame of the target pixel, it is possible to adopt the variable QP as the parameter z (z=QP), or adopt a function value of a function f (QP) having the variable QP as an argument, as the parameter z (z=f (QP)).

Furthermore, for example, by using, as a variable q (I): an image feature amount of a target pixel I of the decoded image (for example, a motion amount of the target pixel I); an image feature amount of a local region including the target pixel I (for example, a motion amount of the local region); or an image feature amount of the entire frame of the target pixel I (a motion amount of full screen motion), it is possible to adopt a function value of a function f (q (I)) having the variable q (I) as an argument, as the parameter z (z=f (q (I))).

Moreover, in addition to one of the variables QP and q (I), a function value of a function f (QP, q (I)) having the both as arguments can be adopted as the parameter z (z=f (QP, q (I))).

Here, the acquirable information can be obtained from the encoded bit stream not only by the encoding device but also by the decoding device. Therefore, in a case where a value corresponding to the acquirable information is adopted as (a value of) the parameter z, there is no need to transmit the parameter z from the encoding device to the decoding device.

Furthermore, the parameter z can be generated in accordance with an original image in addition to being generated in accordance with the acquirable information. For example, it is possible to adopt, as the parameter z, a value corresponding to an image feature amount of the original image, a value corresponding to a peak signal-to-noise ratio (PSNR) and the like of a decoded image obtained using the original image, and the like. However, the original image cannot be obtained by the decoding device. Therefore, in a case of generating the parameter z in accordance with the original image, for example, it is necessary to transmit the parameter z generated in accordance with the original image from the encoding device to the decoding device by including the parameter z in the encoded bit stream, and the like.

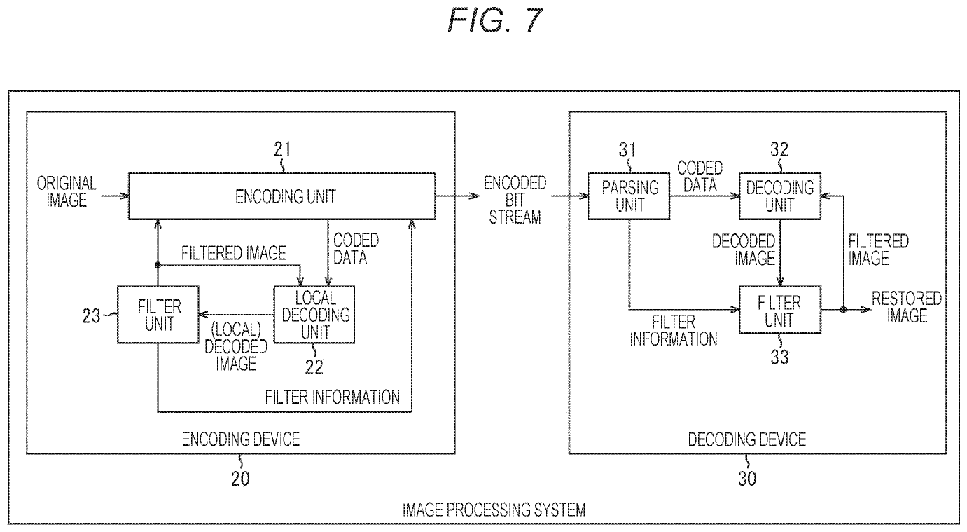

FIG. 7 is a block diagram illustrating an outline of an embodiment of an image processing system to which the present technology is applied.

In FIG. 7, the image processing system includes an encoding device 20 and a decoding device 30.

The encoding device 20 includes an encoding unit 21, a local decoding unit 22, and a filter unit 23.

The encoding unit 21 is supplied with an original image (data), which is an image to be encoded, and a filtered image from the filter unit 23.

The encoding unit 21 uses the filtered image from the filter unit 23 to perform (predictive) encoding on the original image in units of prescribed block such as a CU, for example, and supplies coded data obtained by the encoding to the local decoding unit 22.

That is, the encoding unit 21 subtracts, from the original image, a prediction image of the original image obtained by performing motion compensation on the filtered image from the filter unit 23, and encodes a resulting residual.

The encoding unit 21 is supplied with filter information from the filter unit 23.

The encoding unit 21 generates and transmits (sends) an encoded bit stream including the coded data and the filter information from the filter unit 23.

The local decoding unit 22 is supplied with the coded data from the encoding unit 21, and is also supplied with the filtered image from the filter unit 23.

The local decoding unit 22 performs local decoding on the coded data from the encoding unit 21 by using the filtered image from the filter unit 23, and supplies a resulting (locally) decoded image to the filter unit 23.

That is, the local decoding unit 22 generates a decoded image obtained by decoding the original image, by decoding the coded data from the encoding unit 21 into a residual, and adding, to the residual, the prediction image of the original image obtained by performing motion compensation of the filtered image from the filter unit 23.

The filter unit 23 performs a filtering process as a prediction process of applying a prediction formula to the decoded image from the local decoding unit 22, generates the filtered image, and supplies the filtered image to the encoding unit 21 and the local decoding unit 22.

Furthermore, when performing the filtering process, the filter unit 23 performs, as necessary, learning for obtaining a tap coefficient included in the prediction formula and learning for obtaining a seed coefficient. Then, the filter unit 23 supplies, to the encoding unit 21, filter information including the tap coefficient or the seed coefficient and other information regarding the filtering process, as necessary.

The decoding device 30 includes a parsing unit 31, a decoding unit 32, and a filter unit 33.

The parsing unit 31 receives the encoded bit stream transmitted by the encoding device 20, performs parsing, and supplies filter information obtained by the parsing to the filter unit 33. Moreover, the parsing unit 31 supplies the coded data included in the encoded bit stream to the decoding unit 32.

The decoding unit 32 is supplied with the coded data from the parsing unit 31, and is also supplied with a filtered image from the filter unit 33.

The decoding unit 32 decodes the coded data from the parsing unit 31 by using the filtered image from the filter unit 33, for example, in units of prescribed block such as a CU, and supplies a resulting decoded image to the filter unit 33.

That is, similarly to the local decoding unit 22, the decoding unit 32 generates a decoded image obtained by decoding the original image, by decoding the coded data from the parsing unit 31 into a residual, and adding, to the residual, the prediction image of the original image obtained by performing motion compensation of the filtered image from the filter unit 33.

The filter unit 33 performs a filtering process similar to that of the filter unit 23 on the decoded image from the decoding unit 32, generates the filtered image, and supplies the filtered image to the decoding unit 32.

The filter unit 33 uses the filter information from the parsing unit 31 as necessary when performing the filtering process. Furthermore, the filter unit 33 supplies the filtered image obtained (generated) by the filtering process to the decoding unit 32, and outputs as a restored image obtained by restoring the original image.

As described above, in the encoding device 20, the filter unit 23 can perform the learning for obtaining a tap coefficient included in a prediction formula to be used for the filtering process, or the learning for obtaining a seed coefficient included in a coefficient prediction formula that approximates the tap coefficient.

In a case of performing the learning for obtaining a tap coefficient in the filter unit 23, the filter unit 23 performs the filtering process by using a prediction formula including the tap coefficient. Moreover, the tap coefficient is included in the filter information and transmitted from the encoding device 20 to the decoding device 30. In the filter unit 33 of the decoding device 30, the filtering process is performed by using the prediction formula including the tap coefficient included in the filter information transmitted from the encoding device.

In a case of performing the learning for obtaining a seed coefficient in the filter unit 23, the filter unit 23 performs the filtering process by using a prediction formula including a tap coefficient that is obtained from the seed coefficient and the parameter z. Moreover, the seed coefficient is included in the filter information and transmitted from the encoding device 20 to the decoding device 30. In the filter unit 33 of the decoding device 30, a filtering process is performed by using the prediction formula including the tap coefficient that is obtained from the parameter z and the seed coefficient included in the filter information transmitted from the encoding device.

Note that, in a case of performing the learning for obtaining a seed coefficient in the filter unit 23, in a case where a value corresponding to the acquirable information is adopted as the parameter z to be used for obtaining the tap coefficient together with the seed coefficient, the parameter z is not transmitted from the encoding device 20 to the decoding device 30. However, in a case where the parameter z is generated in accordance with information that is not the acquirable information, such as an original image, for example, the parameter z is included in the filter information together with the seed coefficient, and transmitted from the encoding device 20 to the decoding device 30.

Furthermore, the tap coefficient or the seed coefficient can be preset in the filter units 23 and 33.

In a case where a plurality of sets of tap coefficients or seed coefficients is preset in the filter units 23 and 33, and the filter unit 23 selects one set of tap coefficients or seed coefficients from the plurality of sets of tap coefficients or seed coefficients, and uses the one set of tap coefficients to perform the filtering process, a coefficient ID for identifying the one set of the tap coefficients or seed coefficients used for the filtering process is included in the filter information, and is transmitted from the encoding device 20 to the decoding device 30.

Note that, in a case of performing the learning for obtaining a tap coefficient or a seed coefficient in the filter unit 23, when the tap coefficient or the seed coefficient obtained by the learning (almost) matches the tap coefficient or the seed coefficient transmitted from the encoding device 20 to the decoding device 30 in the past, a coefficient ID for identifying the tap coefficient or the seed coefficient can be included in the filter information and transmitted from the encoding device 20 to the decoding device 30, instead of the tap coefficient or the seed coefficient obtained by the learning.

Furthermore, in the filter units 23 and 33, any one of the first-order prediction formula, the higher-order prediction formula, and the DC prediction formula can be adopted as the coefficient prediction formula.

According to the first-order prediction formula, it is possible to improve image quality of a filtered image obtained by applying the first-order prediction formula to the decoded image with a tap coefficient having a relatively small data amount. According to the higher-order prediction formula, it is possible to accurately restore details of the original image, which has been difficult with a first-order prediction formula, and therefore image quality of the filtered image can be improved. According to the DC prediction formula, encoding distortion such as block distortion can be largely suppressed, and therefore image quality of the filtered image can be improved.

Meanwhile, in the filtering process, that is, the prediction process using the prediction formula, there is an advantage and disadvantage in a prediction method that is a method of the prediction process. The prediction method is defined by, for example, a prediction formula to be used for the prediction process, a tap structure of a prediction tap (a way of providing a tap), and a unit for performing the prediction process. In a prediction tap with a certain tap structure, or in a certain prediction formula, for example, depending on the decoded image, there may be a case where image quality of the filtered image obtained by the prediction process cannot be sufficiently improved, that is, for example, for a slight waveform change of the decoded image, a corresponding waveform change of the original image cannot be sufficiently restored in the filtered image in some cases.

Therefore, in the present technology, by preparing a plurality of prediction methods, adaptively selecting an adopted prediction method to be adopted for the prediction process from the plurality of prediction methods, and performing a prediction process of the adopted prediction method, image quality of the filtered image can be sufficiently improved. Among the plurality of prediction methods, at least a prediction method using the DC prediction formula can be included.

Furthermore, in the filter units 23 and 33, the prediction process on the decoded image can be performed for every class obtained from class classification, by performing the class classification of pixels of the decoded image. The class classification method is defined by, for example, information such as an image feature amount to be used for the class classification, a tap structure of a class tap (a way of providing a tap), and a unit for performing the class classification. In a fixed class classification method, for example, in a case where the decoded image is an image of low image quality with a dull waveform, there is a case where the pixels of the decoded image cannot be appropriately classified, and image quality of the filtered image finally obtained by the prediction process cannot be sufficiently improved in some cases.

Therefore, in the present technology, by preparing a plurality of class classification methods, adaptively selecting an adopted class classification method to be adopted for the class classification from the plurality of class classification methods, and performing the class classification of the adopted class classification method, image quality of the filtered image can be sufficiently improved.

Here, the prediction process performed for every class is also referred to as a class classification prediction process. A basic principle of the class classification prediction process is described in, for example, Japanese Patent Application Laid-Open No. 2005-236633.

In the class classification prediction process, by adaptively selecting (switching) the adopted class classification method and the adopted prediction method, it is possible to improve image quality of a filtered image obtained for a decoded image of various scenes. Information indicating the adopted class classification method, the adopted prediction method, and the like can be transmitted from the encoding device 20 to the decoding device 30 with a small amount of information.

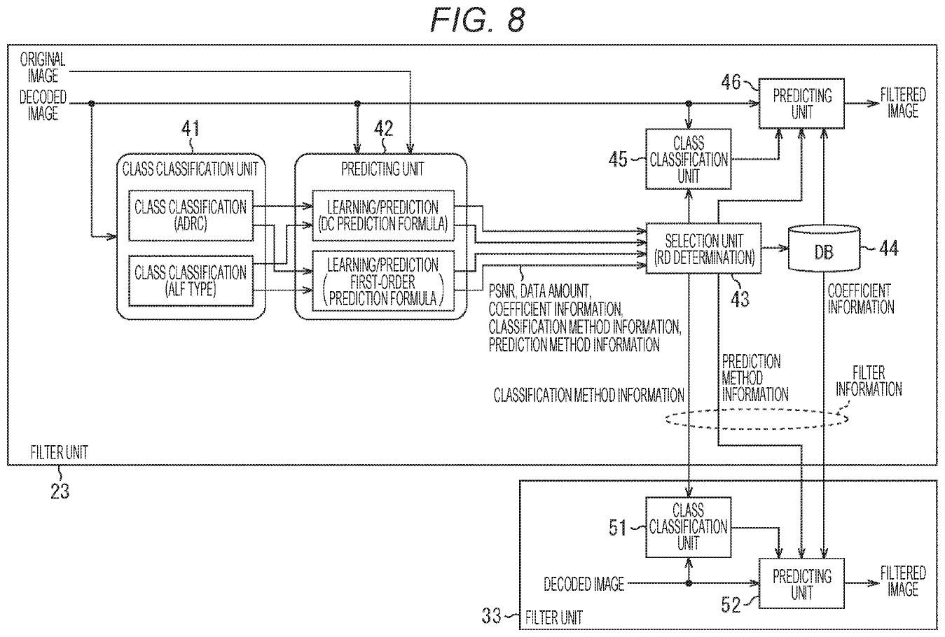

FIG. 8 is a block diagram illustrating a configuration example of the filter units 23 and 33 that adaptively select the adopted class classification method and the adopted prediction method and perform the filtering process as the class classification prediction process.

In FIG. 8, the filter unit 23 includes a class classification unit 41, a predicting unit 42, a selection unit 43, a database (DB) 44, a class classification unit 45, and a predicting unit 46.

The class classification unit 41 is supplied with a decoded image. For each of the plurality of class classification methods, the class classification unit 41 performs class classification of the class classification method for each pixel of the decoded image, and supplies a class of each pixel of the decoded image to the predicting unit 42.

In FIG. 8, the class classification unit 41 performs the class classification with two types of class classification methods, that is, class classification by adaptive dynamic range coding (ADRC) and ALF class classification.

In the class classification by ADRC, a pixel as a class tap is selected from the decoded image, and ADRC is performed on the class tap. In L-bit ADRC, for example, a dynamic range DR=MAX−MIN is obtained, which is a difference between a maximum value MAX and a minimum value MIN of a pixel value of a pixel as the class tap. Moreover, the minimum value MIN is subtracted from a pixel value of each pixel as the class tap, and the subtracted value is divided (requantized) by DR/2^{L}. Then, a bit string in which pixel values of individual L-bit pixels obtained as described above as the class tap are arranged in a prescribed order is outputted as an ADRC code.

Therefore, for example, in 1-bit ADRC, the pixel value of each pixel as the class tap is divided (round down decimals) by an average value of the maximum value MAX and the minimum value MIN, and as a result, the pixel value of each pixel is set to 1 bit (binarized). That is, in 1-bit ADRC, by using the average value of the maximum value MAX and the minimum value MIN of the pixel value of the pixel as the class tap as a classification threshold value for classifying the pixel value, the pixel value of each pixel as the class tap is quantized to 1 when it is equal to or greater than the classification threshold value, and is quantized to 0 when it is not equal to or greater than the classification threshold value. Then, a bit string in which the 1-bit pixel values after quantization are arranged in a prescribed order is outputted as the ADRC code.

In the class classification by ADRC, (a value represented by) such an ADRC code represents a class.

Here, in the following, ADRC means 1-bit ADRC, unless otherwise specified.

In the ALF class classification, the class classification similar to the existing ALF is performed.

Note that, in FIG. 8, in order to simplify the description, the class classification unit 41 performs class classification with each of the two types of class classification methods, but the class classification unit 41 can perform the class classification with one or each of three or more types of class classification methods.

The predicting unit 42 is supplied with a class of each pixel of the decoded image obtained for each of the plurality of class classification methods from the class classification unit 41, and is also supplied with an original image and the decoded image.

For each of the plurality of prediction methods, by performing learning (hereinafter, also referred to as tap coefficient learning) for obtaining a tap coefficient by using the decoded image and the original image corresponding to the decoded image as student data and teacher data, respectively, for every class obtained for each of the plurality of class classification methods from the class classification unit 41, the predicting unit 42 performs, for a combination of each of the plurality of class classification methods and each of the plurality of prediction methods, class classification with a class classification method of the combination, and obtains a tap coefficient for every class used in a case of performing the prediction process of the prediction method of the combination.

Moreover, for the combination of each of the plurality of class classification methods and each of the plurality of prediction methods, the predicting unit 42 performs the filtering process as the prediction process of applying, to the decoded image, the prediction formula including the tap coefficient obtained by the tap coefficient learning, to generate a filtered image.

For the combination of each of the plurality of class classification methods and each of the plurality of prediction methods, the predicting unit 42 obtains PSNR of the filtered image by comparing the filtered image with the original image, and obtains a data amount of an encoded bit stream including coded data obtained by encoding the original image, and information necessary for decoding the coded data (encode information such as a motion vector, a tap coefficient, and the like).

Then, for the combination of each of the plurality of class classification methods and each of the plurality of prediction methods, the predicting unit 42 associates the PSNR, a data amount of the encoded bit stream, classification method information indicating the class classification method, prediction method information indicating a prediction method, and coefficient information regarding the tap coefficient and supplies it to the selection unit 43.

In a case of performing the tap coefficient learning in the predicting unit 42, the coefficient information is the tap coefficient obtained by the tap coefficient learning.

In FIG. 8, the predicting unit 42 performs the prediction process with two types of prediction methods, that is, a prediction process using a DC prediction formula and a prediction process using a first-order prediction formula.

Note that, in FIG. 8, in order to simplify the description, the predicting unit 42 performs the prediction process with each of the two types of prediction methods, but the predicting unit 42 can perform the prediction process with each of three or more types of prediction methods.

The selection unit 43 selects a combination with the optimized encoding efficiency from combinations of each of the plurality of class classification methods and each of the plurality of prediction methods for which the PSNR, the data amount of the encoded bit stream, the classification method information, the prediction method information, and the coefficient information are supplied from the predicting unit 42.

That is, for example, for the combination of each of the plurality of class classification methods and each of the plurality of prediction methods supplied from the predicting unit 42, the selection unit 43 uses the PSNR and the data amount of the encoded bit stream in the combination to obtain, for example, an RD cost as the encoding efficiency. Moreover, the selection unit 43 selects a class classification method and a prediction method of a combination having the best RD cost, respectively, as the adopted class classification method and the adopted prediction method to be adopted for the class classification and the prediction process.

Furthermore, the selection unit 43 selects a tap coefficient as coefficient information in the combination of the adopted class classification method and the adopted prediction method, as an adopted tap coefficient to be adopted for the prediction process, and supplies the tap coefficient to the DB 44 and causes the DB 44 to store it.

Classification method information indicating the adopted class classification method, prediction method information indicating the adopted prediction method, and the adopted tap coefficient as the coefficient information stored in the DB 44 are included in the filter information and supplied to the encoding unit 21 (FIG. 7). Then, in the encoding unit 21, the filter information is included in the encoded bit stream and transmitted from the encoding device 20 to the decoding device 30.

Transmission of the filter information from the encoding device 20 to the decoding device 30 (similarly, generation of filter information, tap coefficient learning, and the like) can be performed, for example, in picture units, slice units, tile units, and any other block units.

The selection unit 43 supplies the classification method information indicating the adopted class classification method to the class classification unit 45, and supplies the prediction method information indicating the adopted prediction method to the predicting unit 46.

The class classification unit 45 is supplied with the classification method information from the selection unit 43, and is also supplied with the decoded image. The class classification unit 45 performs class classification on each pixel of the decoded image with the (adopted) class classification method indicated by the classification method information from the selection unit 43, and supplies a class of each pixel to the predicting unit 46.

The predicting unit 46 is supplied with the prediction method information indicating the adopted prediction method from the selection unit 43, and is also supplied with the class of each pixel of the decoded image and also with the decoded image from the class classification unit 45.

By applying, to the decoded image, a prediction formula including a tap coefficient of the class from the class classification unit 45 among the (adopted) tap coefficients as the coefficient information stored in the DB 44, the predicting unit 46 performs a filtering process as a prediction process of the (adopted) prediction method indicated by the prediction method information from the selection unit 43, and supplies a resulting filtered image to the encoding unit 21 and the local decoding unit 22 (FIG. 8).

In FIG. 8, the filter unit 33 includes a class classification unit 51 and a predicting unit 52.

In the decoding device 30, in the parsing unit 31 (FIG. 7), the filter information included in the encoded bit stream from the encoding device 20 is parsed and supplied to the filter unit 33.

In the filter unit 33, the classification method information included in the filter information is supplied to the class classification unit 51, and the prediction method information and the coefficient information included in the filter information are supplied to the predicting unit 52.

The class classification unit 51 is supplied with the classification method information, and is also supplied with the decoded image. The class classification unit 51 performs class classification on each pixel of the decoded image with the (adopted) class classification method indicated by the classification method information, and supplies a class of each pixel to the predicting unit 52.

The predicting unit 52 is supplied with the prediction method information and the coefficient information, and is also supplied with the decoded image. By applying, to the decoded image, a prediction formula including a tap coefficient of the class from the class classification unit 51 among the (adopted) tap coefficients as the coefficient information, the predicting unit 52 performs a filtering process as a prediction process of the (adopted) prediction method indicated by the prediction method information, and supplies a resulting filtered image to the decoding unit 32 (FIG. 7).

As described above, by performing the class classification and the prediction process with the adopted class classification method and the adopted prediction method selected respectively from the plurality of class classification methods and the plurality of prediction methods, it is possible to improve image quality of the filtered image obtained for the decoded image of various scenes.

Note that the class classification method can be fixed.

Furthermore, in FIG. 8, the predicting unit 42 performs the tap coefficient learning for obtaining a tap coefficient, but the predicting unit 42 can perform learning for obtaining a seed coefficient (hereinafter, also referred to as seed coefficient learning) instead of the tap coefficient learning. In a case of performing the seed coefficient learning in the predicting unit 42, the coefficient information includes a seed coefficient for every class obtained by the seed coefficient learning, and further includes, as necessary, an order of a coefficient prediction formula including the seed coefficient and a parameter z.

That is, in the seed coefficient learning, in a case where the order of the coefficient prediction formula is adaptively selected, the coefficient information includes the adaptively selected order. Furthermore, in a case where the parameter z is generated in accordance with information other than the acquirable information, the coefficient information includes the parameter z.

Furthermore, without the predicting unit 42 performing the tap coefficient learning, a plurality of sets of tap coefficients obtained by tap coefficient learning performed in advance may be preset in the predicting units 42 and 52. In this case, the coefficient information can include a coefficient ID for identifying a set of tap coefficients to be used in the adopted prediction method among the plurality of sets of tap coefficients. Note that, even in a case where the tap coefficient learning is performed in the predicting unit 42, when a latest tap coefficient obtained by the tap coefficient learning matches a tap coefficient transmitted in the past from the encoding device 20 to the decoding device 30 as the coefficient information, a coefficient ID for identifying the tap coefficient transmitted in the past can be included in the coefficient information, instead of the latest tap coefficient obtained by the tap coefficient learning. The above point similarly applies to a seed coefficient.

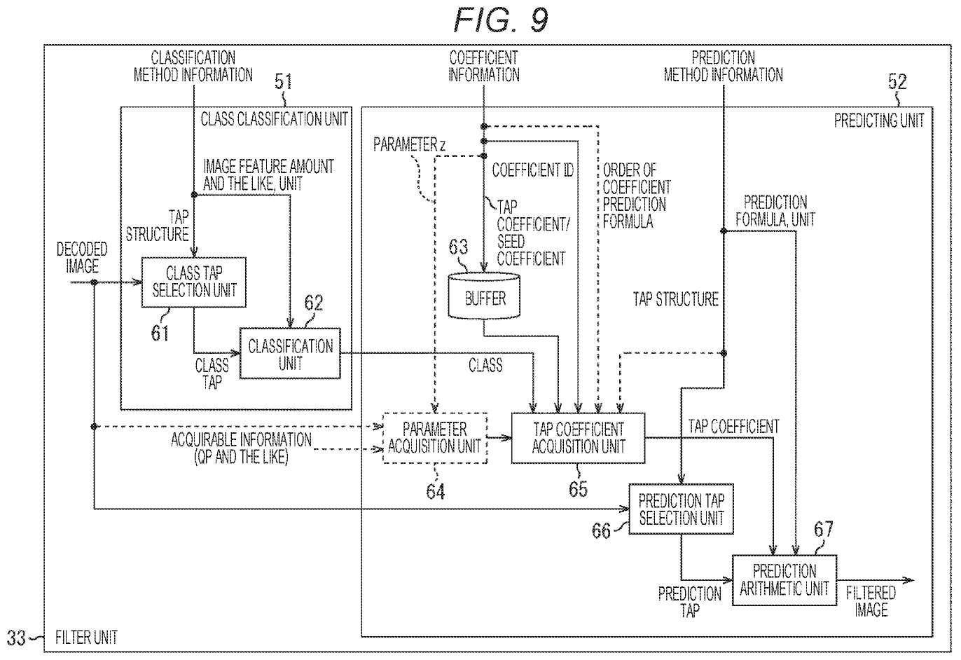

FIG. 9 is a block diagram illustrating a configuration example of the class classification unit 51 and the predicting unit 52 in FIG. 8.

Note that the class classification unit 45 and the predicting unit 46 in FIG. 8 are configured similarly to those in FIG. 9.

The class classification unit 51 includes a class tap selection unit 61 and a classification unit 62.

Here, the classification method information supplied to the class classification unit 51 includes information on an image feature amount and the like to be used for the class classification, a tap structure of a class tap, and information indicating a unit for performing the class classification.

In the classification method information, information indicating the tap structure of the class tap is supplied to the class tap selection unit 61, while information indicating the image feature amount and the like to be used for class classification and the information indicating the unit for performing the class classification are supplied to the classification unit 62.

The class tap selection unit 61 selects a pixel as a class tap having the tap structure indicated by the classification method information, from the decoded image for each pixel of the decoded image, and supplies the pixel to the classification unit 62.

The classification unit 62 extracts the image feature amount indicated by the classification method information from the class tap, and performs the class classification on each pixel of the decoded image by using the image feature amount.

Examples of the image feature amount extracted from the class tap include, for example, an ADRC code (waveform pattern), a dynamic range (DR) that is a difference between a maximum value and a minimum value of a pixel value of a pixel as a class tap, DiffMax that is a maximum value of an absolute difference value of pixel values of pixels adjacent in horizontal, vertical, and diagonal directions in the class tap, DiffMax/DR obtained using the DR and the DiffMax, and other image feature amounts.

Furthermore, the classification unit 62 performs the class classification on each pixel of the decoded image in the unit indicated by the classification method information, for example, in 1-pixel unit, 2×2 pixel unit in lateral and longitudinal directions, and the like. In a case where the class classification is performed in 2×2 pixel unit, for example, four pixels of 2×2 pixels are classified into a same class.

The class of each pixel of the decoded image obtained by the class classification with the classification unit 62 is supplied to (a tap coefficient acquisition unit 65 of) the predicting unit 52.

The predicting unit 52 includes a buffer 63, a parameter acquisition unit 64, the tap coefficient acquisition unit 65, a prediction tap selection unit 66, and a prediction arithmetic unit 67.

Here, the prediction method information supplied to the predicting unit 52 includes a prediction formula to be used for a prediction process, a tap structure of a prediction tap, and information indicating a unit for performing the prediction process. Furthermore, the coefficient information supplied to the predicting unit 52 includes, as necessary, a tap coefficient, a seed coefficient, a coefficient ID, an order of the coefficient prediction formula, and a parameter z.

In the prediction method information, the information indicating the prediction formula to be used for the prediction process and the information indicating the unit for performing the prediction process are supplied to the prediction arithmetic unit 67, and the information indicating the tap structure of the prediction tap is supplied to the prediction tap selection unit 66 and, as necessary, supplied to the tap coefficient acquisition unit 65.

The order of the coefficient prediction formula and the coefficient ID in the coefficient information are supplied to the tap coefficient acquisition unit 65 as necessary, and the tap coefficient or the seed coefficient is supplied to the buffer 63. The parameter z in the coefficient information is supplied to the parameter acquisition unit 64 as necessary.

In a case where the coefficient information includes a tap coefficient or a seed coefficient for every class, the buffer 63 stores the tap coefficient or the seed coefficient for every class.

In a case where the coefficient information includes the parameter z, the parameter acquisition unit 64 acquires the parameter z and supplies the parameter z to the tap coefficient acquisition unit 65. Furthermore, in a case where the coefficient information does not include the parameter z, the parameter acquisition unit 64 acquires the parameter z by generating it from the encode information that is the acquirable information and from a feature amount of the decoded image, and supplies the parameter z to the tap coefficient acquisition unit 65.

In a case where the tap coefficient for every class is stored in the buffer 63, the tap coefficient acquisition unit 65 acquires a tap coefficient of a class of a pixel of the decoded image from the classification unit 62, from the tap coefficients for every class stored in the buffer 63, and supplies the tap coefficients to the prediction arithmetic unit 67.

Note that, in a case where a plurality of sets of tap coefficients for every class is stored in the buffer 63 and the coefficient information includes a coefficient ID, the tap coefficient acquisition unit 65 acquires a tap coefficient of the class of the pixel of the decoded image from the classification unit 62, from a set of tap coefficients for every class identified by the coefficient ID among the plurality of sets of tap coefficients for every class stored in the buffer 63, and supplies the tap coefficient to the prediction arithmetic unit 67.

Furthermore, in a case where the seed coefficient for every class is stored in the buffer 63, the tap coefficient acquisition unit 65 acquires a seed coefficient of the class of the pixel of the decoded image from the classification unit 62 among the seed coefficients for every class stored in the buffer 63. Then, by operating the coefficient prediction formula including the seed coefficient of the class of the pixel of the decoded image and the parameter z from the parameter acquisition unit 64, the tap coefficient acquisition unit 65 obtains a tap coefficient of the class of the pixel of the decoded image from the classification unit 62, and supplies the tap coefficient to the prediction arithmetic unit 67.

In this case, when the coefficient information includes the order of the coefficient prediction formula, the tap coefficient acquisition unit 65 recognizes the order of the coefficient prediction formula with the order included in the coefficient information, and performs operation of the coefficient prediction formula. When the order of the coefficient prediction formula is not included in the coefficient information, the tap coefficient acquisition unit 65 recognizes that the order of the coefficient prediction formula is a default order. Furthermore, the tap coefficient acquisition unit 65 recognizes, as necessary, the number of tap coefficients to be obtained by operation of the coefficient prediction formula from the information regarding the tap structure of the prediction tap included in the prediction method information. In a case where the number of tap coefficients to be obtained by operation of the coefficient prediction formula is determined to the default number in advance, it is not necessary to supply the information indicating the tap structure of the prediction tap to the tap coefficient acquisition unit 65.

In a case where a plurality of sets of seed coefficients for every class is stored in the buffer 63, and the coefficient information includes a coefficient ID, the tap coefficient acquisition unit 65 acquires a seed coefficient of the class of the pixel of the decoded image from the classification unit 62, from a set of seed coefficients for every class identified by the coefficient ID among the plurality of sets of seed coefficients for every class stored in the buffer 63, and obtains a tap coefficient by using the seed coefficient.

In a case where the seed coefficient is not used, portions indicated by a dotted line in FIG. 9 are to be unnecessary. That is, the predicting unit 55 is configured without the parameter acquisition unit 64. Furthermore, the order of the coefficient prediction formula and the parameter z are to be unnecessary. Moreover, it is not necessary to supply the information indicating the tap structure of the prediction tap to the tap coefficient acquisition unit 65.

In the following, in order to simplify the description, the coefficient ID is not used, and the default order is adopted as the order of the coefficient prediction formula. Moreover, the number of tap coefficients to be obtained by operation of the coefficient prediction formula is determined to a default number in advance, and the parameter z is generated (obtained) from the acquirable information.

Therefore, the coefficient information includes the tap coefficient or the seed coefficient, but does not include the order of the coefficient prediction formula, the coefficient ID, and the parameter z. Furthermore, the information indicating the tap structure of the prediction tap is not supplied to the tap coefficient acquisition unit 65.

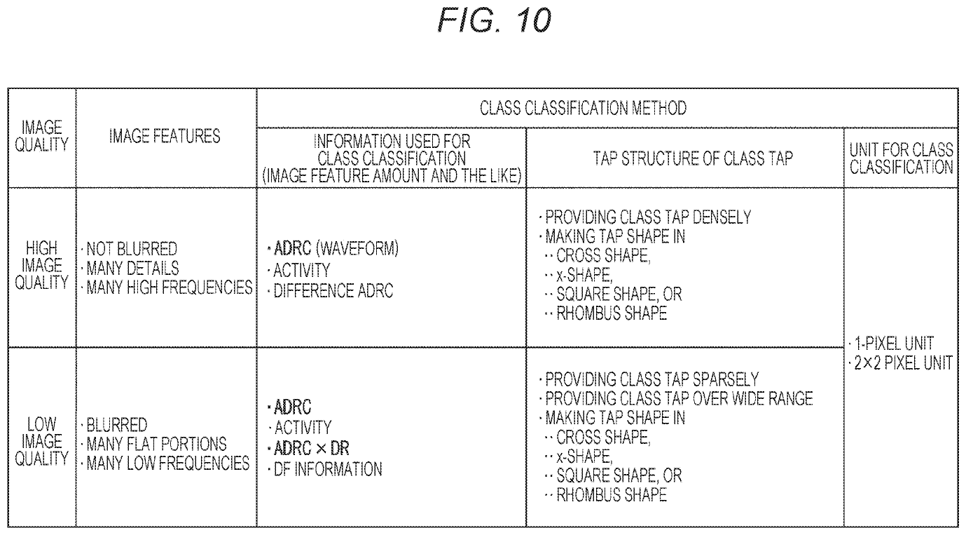

FIG. 10 is a view for explaining a class classification method.

The class classification method is defined by, for example, information to be used for class classification (an image feature amount and the like), a tap structure of a class tap (a way of providing a tap), and a unit for performing the class classification.

The tap structure of the class tap has, for example, variations in which a tap shape, which is a planar shape of the class tap, is a cross shape, an x-shape, a square shape, or a rhombus shape. Furthermore, the tap structure of the class tap has, for example, variations in which the class tap is provided densely or sparsely, and variations such as how wide a range in which the class tap is to be provided around a target pixel.

The information to be used for the class classification has, for example, variations such as ADRC (code), an activity (including an activity in a specific direction, in addition to activities in various directions), difference ADRC (code) described later, a combination of ADRC and DR (ADRC×DR), and the like. Furthermore, in a case where a filter, such as a deblocking filter or an adaptive offset filter other than the filter units 23 and 33, is provided in a preceding stage of the filter units 23 and 33 (hereinafter, also referred to as a pre-stage filter), information regarding the pre-stage filter can be adopted as the information to be used for the class classification. For example, in a case where a deblocking filter is provided as the pre-stage filter, the class classification can be performed by using information on whether any one of a strong filter or a weak filter has been applied or neither has been applied, as deblocking filter (DF) information regarding the deblocking filter. Note that, in a case where the class classification is performed using only the information regarding the pre-stage filter, the class tap is not required.

According to the ADRC or the difference ADRC, it is possible to catch a small waveform change of the decoded image, and to classify pixels in accordance with such a small waveform change. According to the activity and the combination of ADRC and DR, it is possible to classify noise pixels (noisy pixels) and non-noise pixels (edges, textures, and the like). According to the DF information, pixels can be classified so as to be suitable for restoring distortion generated by the deblocking filter.

The unit for performing the class classification has, for example, variations such as 1-pixel unit and 2×2 pixel unit. In a case where the class classification is performed in 2×2 pixel unit, four pixels of 2×2 pixels are classified into a same class. Class classification in 1-pixel unit is effective in a case where the decoded image is a fine image. Since a filtered image obtained in a case of performing the class classification in 2×2 pixel unit is more blurred than a filtered image obtained in a case of performing the class classification in 1-pixel unit, the class classification in 2×2 pixel unit is effective in a case where the decoded image is an image of low image quality.

The tap structure of the class tap, the information to be used for the class classification, and the unit for performing the class classification that define the class classification method can be selected regardless of the image quality of the decoded image. However, the number of selectable class classification methods can be enormous without any restrictions. Therefore, the selectable class classification methods can be classified in accordance with the image quality of the decoded image, for example, as shown in FIG. 10.

For example, in a case where the image quality of the decoded image is high image quality, the decoded image has features such as not being blurred, having many details, and having many high-frequency components. Therefore, the ADRC, the activity, or the difference ADRC can be adopted as the information to be used for the class classification in consideration of such features.

In a case where the image quality of the decoded image is high image quality, as the tap structure of the class tap, it is possible to adopt providing the class tap densely, and adopt making the tap shape in a cross shape, an x-shape, a square shape, or a rhombus shape. Furthermore, as the unit for performing the class classification, 1-pixel unit or 2×2 pixel unit can be adopted.

By adopting the class classification method as described above, it is possible to classify each pixel of the decoded image by catching an edge or a small waveform change in details in the decoded image of high image quality.

Note that the fact that the image quality of the decoded image is high image quality can be determined from, for example, that the quantization parameter QP is small (as compared to a threshold value), that there are many high-frequency components in one screen (frame) of the decoded image, that a region including motion is small (not blurred) in one screen of the decoded image, and the like.

On the other hand, in a case where the image quality of the decoded image is low image quality, the decoded image has features such as being blurred, having many flat portions, and having many low-frequency components. Therefore, the ADRC, the activity, the combination of ADRC and DR, or the DF information can be adopted as the information to be used for the class classification in consideration of such features. Note that the DF information may be adopted only in a case where a deblocking filter exists as the pre-stage filter.

In a case where the image quality of the decoded image is low image quality, as the tap structure of the class tap, it is possible to adopt providing the class tap sparsely and providing the class tap over a wide range, and adopt making the tap shape in a cross shape, an x-shape, a square shape, or a rhombus shape. Furthermore, as the unit for performing the class classification, 1-pixel unit or 2×2 pixel unit can be adopted.

In the decoded image of low image quality, local features such as edges and details are dull. Therefore, by adopting the class classification method as described above, it is possible to classify each pixel of the decoded image so that encoding distortion such as block distortion can be largely reduced by catching a waveform change in a wide range in the decoded image of low image quality.

Note that the fact that the image quality of the decoded image is low image quality can be determined from, for example, that the quantization parameter QP is large, that there are many low-frequency components in one screen of the decoded image, that a region including motion is large (blurred) in one screen of the decoded image, and the like.

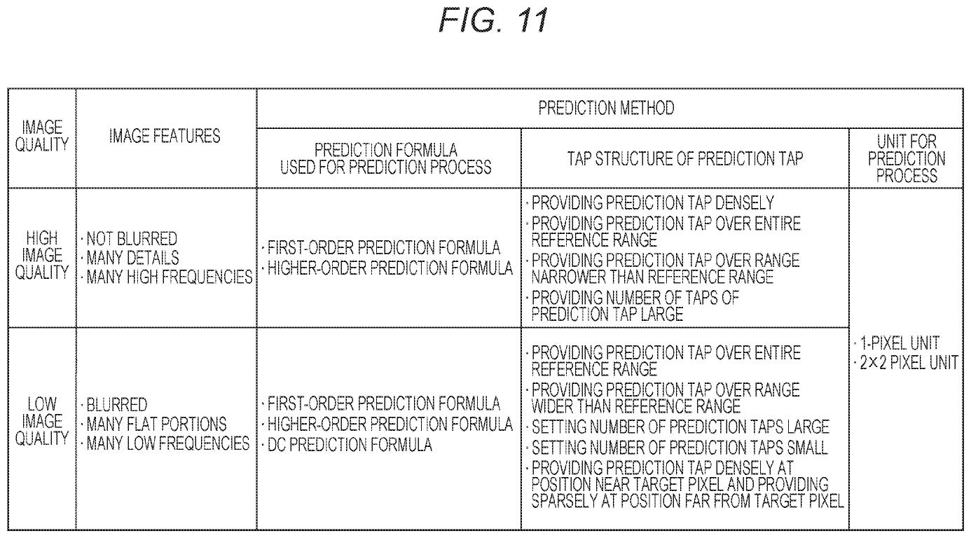

FIG. 11 is a view for explaining a prediction method.

The prediction method is defined by, for example, a prediction formula to be used for a prediction process, a tap structure of a prediction tap (a way of providing a tap), and a unit for performing the prediction process.

The tap structure of the prediction tap has, for example, variations in which a tap shape is a rhombus shape of 13 pixels, 25 pixels, or 41 pixels, and variations in which the prediction tap is provided densely or sparsely. Moreover, the tap structure of the prediction tap has variations such as providing the prediction tap over the entire reference range around a target pixel, providing over a range narrower than the reference range, and being over a wider range than the reference range, and variations such as setting the number of taps of the prediction tap (the number of pixels as the prediction tap) larger than a reference number, smaller than the reference number, or to the reference number. Moreover, the tap structure of the prediction tap has variations of providing the prediction tap densely at a position near the target pixel and providing sparsely at a position far from the target pixel.

Note that the reference range is, for example, a predetermined range such as a range of 7×7 pixels in horizontal and vertical directions. In a case where the reference range is a range of 7×7 pixels, for example, a range of 5×5 pixels can be adopted as a range narrower than the reference range, and, for example, a range of 9×9 pixels can be adopted as a range wider than the reference range. The range as used herein means a range of pixels that can be selected as a prediction tap, and not all pixels within the range are necessarily selected as the prediction tap.

The reference number is, for example, a predetermined number of taps (the number of pixels) of the number of pixels such as 25 pixels. In a case where the reference number is 25 pixels (25 pixels having a rhombus shape around the target pixel), for example, 41 pixels (41 pixels having a rhombus shape around the target pixel) can be adopted as the number of taps larger than the reference number, and, for example, 13 pixels (13 pixels having a rhombus shape around the target pixel) can be adopted as the number of taps smaller than the reference number.

The prediction formula to be used for the prediction process has, for example, variations such as a first-order prediction formula, a higher-order prediction formula, and a DC prediction formula. According to the first-order prediction formula, a filtered image with improved image quality can be obtained with a tap coefficient having a not so large data amount. According to the higher-order prediction formula, it is possible to obtain a filtered image in which details (small waveform changes) of the original image are restored. According to the DC prediction formula, it is possible to obtain a filtered image in which block distortion is largely suppressed.

The unit for performing the prediction process has, for example, variations such as 1-pixel unit and 2×2 pixel unit. In a case where the prediction process is performed in 2×2 pixel unit, the prediction tap is selected with each pixel as a reference for each of four pixels of the 2×2 pixels, but the prediction process is performed using a same tap coefficient, that is, a tap coefficient in a same class. Therefore, in a case where the prediction process is performed in 2×2 pixel unit, four pixels of 2×2 pixels need to be classified into a same class, and the unit for performing the class classification needs to be 2×2 pixel unit.

The prediction process in 1-pixel unit is effective in a case where the decoded image is a fine image. Since a filtered image obtained by the prediction process in 2×2 pixel unit is more blurred than a filtered image obtained by the prediction process in 1-pixel unit, the prediction process in 2×2 pixel unit is effective in a case where the decoded image is an image of low image quality.

The tap structure of the prediction tap, the prediction formula to be used for the prediction process, and the unit for performing the prediction process that define the prediction method can be selected regardless of the image quality of the decoded image. However, the number of selectable prediction methods can be enormous without any restrictions. Therefore, as shown in FIG. 11, for example, the selectable prediction methods can be classified in accordance with the image quality of the decoded image, similarly to the case of the class classification method in FIG. 10.

A decoded image of high image quality and a decoded image of low image quality have the features as described with reference to FIG. 10, and whether the image quality of the decoded image is high image quality or low image quality can also be determined as described with reference to FIG. 10.

In a case where the decoded image has high image quality, as the tap structure of the prediction tap, it is possible to adopt providing the prediction tap densely, and adopt providing the prediction tap over the entire reference range or a range narrower than the reference range. Moreover, as the tap structure of the prediction tap, it is possible to adopt setting the number of taps of the prediction tap larger than the reference number. As the prediction formula to be used for the prediction process, a first-order prediction formula or a higher-order prediction formula can be adopted. As the unit for performing the prediction process, 1-pixel unit or 2×2 pixel unit can be adopted.

By adopting the prediction method as described above, for the decoded image of high image quality, it is possible to generate a filtered image in which a slight waveform change in details of the original image is restored.

On the other hand, in a case where the decoded image is an image of low image quality, as the tap structure of the prediction tap, it is possible to adopt providing the prediction tap over the entire reference range or a range wider than the reference range, and adopt providing the prediction tap densely at a position near the target pixel and providing sparsely at a position far from the target pixel. Moreover, as the tap structure of the prediction tap, it is possible to adopt setting the number of taps of the prediction tap larger or smaller than the reference number. As the prediction formula to be used for the prediction process, a first-order prediction formula, a higher-order prediction formula, or a DC prediction formula can be adopted. As the unit for performing the prediction process, 1-pixel unit or 2×2 pixel unit can be adopted.

By adopting the prediction method as described above, for the decoded image of low image quality, it is possible to generate a filtered image in which encoding distortion such as block distortion is largely reduced, by referring to a wide range of information of the decoded image.

For a decoded image of a low image, since the tap structure of the prediction tap may be particularly sparse or dense, it is effective to provide the prediction tap over a wide range. In a case of providing the prediction tap over a wide range, by providing the prediction tap sparsely (tap skipping), it is possible to suppress an increase in the number of prediction taps and, consequently, an increase in the number of the tap coefficients.

Here, a DC tap as a prediction tap included in a DC term of the DC prediction formula is an average value of pixel values in a block of each of blocks adjacent up, down, left, and right to the target block, or an interpolation value obtained by interpolation using these average values. Therefore, it can be substantially said that the DC tap is a prediction tap provided over a wide range of pixels of the blocks adjacent up, down, left, and right to the target block.

Note that, for a combination of each of the plurality of class classification methods described in FIG. 10 and each of the plurality of prediction methods described in FIG. 11, a large variation may occur in a data amount of the tap coefficient (or the seed coefficient) serving as the coefficient information, depending on the number of classes and the number of tap coefficients of each class.

Therefore, for the tap coefficient (or the seed coefficient) obtained for each combination of each of the plurality of class classification methods and each of the plurality of prediction methods, a data amount of the tap coefficient obtained for each combination can be made nearly equal by, for example, degenerating for combining classes having similar tap coefficients into one class, as necessary.

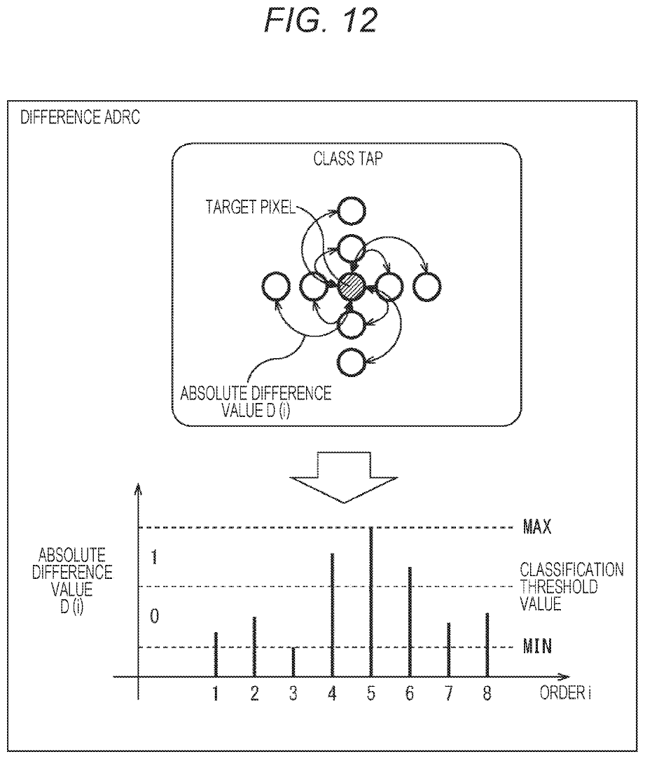

FIG. 12 is a view for explaining difference ADRC.

In the differential ADRC, ADRC is performed on an absolute difference value of a pixel value between, for example, a target pixel as one pixel and each of other pixels, among a plurality of pixels as the class tap selected as the target pixel. In FIG. 12, for the target pixel, nine pixels having a cross shape, that is, the target pixel and every two pixels consecutively located up, down, left, and right thereof, are selected as the class tap. Then, absolute difference values D(1), D(2), . . . , D(8) between the target pixel and each of the other eight pixels of the class tap are obtained, and the ADRC is performed on the eight absolute difference values D(1) to D(8).

In (1 bit) ADRC, as described with reference to FIG. 8, by using, as the classification threshold value, the average value of the maximum value MAX and the minimum value MIN of the pixel value of the pixel as the class tap, a pixel value of each pixel as the class tap is quantized to 1 when it is equal to or greater than the classification threshold value, and is quantized to 0 when it is not equal to or greater than the classification threshold value.

Therefore, in the differential ADRC, by using, as the classification threshold value, the average value of the maximum value and the minimum value of the absolute difference value of the pixel value between the target pixel and each of other pixels, the absolute difference value is quantized to 1 when it is equal to or greater than the classification threshold value, and is quantized to 0 when it is not equal to or greater than the classification threshold value. Then, a bit string in which the absolute difference values of 0 or 1 after quantization are arranged in a prescribed order is outputted as an ADRC code (hereinafter also referred to as a difference ADRC code), for the absolute difference values D(1) to D(8).

According to the class classification using the difference ADRC (code), the pixel (target pixel) is classified on the basis of a difference between pixel values (luminance and the like) of pixels of the target pixel and peripheral pixels.

In the differential ADRC, the classification threshold value in quantizing the absolute difference value changes in accordance with the difference between the maximum value and the minimum value of the absolute difference value, that is, in accordance with a dynamic range of the absolute difference value. Therefore, the target pixel can be classified in accordance with a scene around the target pixel, and therefore, it is possible to generate a filtered image in which distortion at an edge and a shape of a complicated texture are restored, while the edge existing in the original image is maintained.

Meanwhile, for example, there is a case where a change in the pixel value at the edge may be large or small, for edges of characters or geometric patterns. Furthermore, in the difference ADRC, the classification threshold value is uniquely set to the average value of the maximum value and the minimum value of the absolute difference value. For this reason, in the class classification using the difference ADRC, a pixel of an edge in which a pixel value change is large and a pixel of an edge in which a pixel value change is small may be classified into different classes.

However, for the edges of characters and geometric patterns, it is desirable to classify the pixel into a same class and apply a prediction formula including a same tap coefficient regardless of magnitude of the change in the pixel value at the edge.

Therefore, there is a method of fixedly designing the classification threshold value so that the pixel of the edge in which a pixel value change is large and the pixel of the edge in which a pixel value change is small are classified into a same class, in the class classification using the difference ADRC.

However, when the classification threshold value is fixedly designed so that the pixel of the edge in which a pixel value change is large and the pixel of the edge in which a pixel value change is small are classified into a same class, pixels of an image with features other than edges may not be properly classified, and the classification performance of the class classification may be degraded.

Therefore, in class classification using the differential ADRC, the classification threshold value is set not to the average value of the maximum value and the minimum value of the absolute difference value, for example, but can be set flexibly in accordance with a dynamic range of the absolute difference value so that, for example, the pixel of the edge in which a pixel value change is large and the pixel of the edge in which a pixel value change is small are classified into a same class, as necessary.

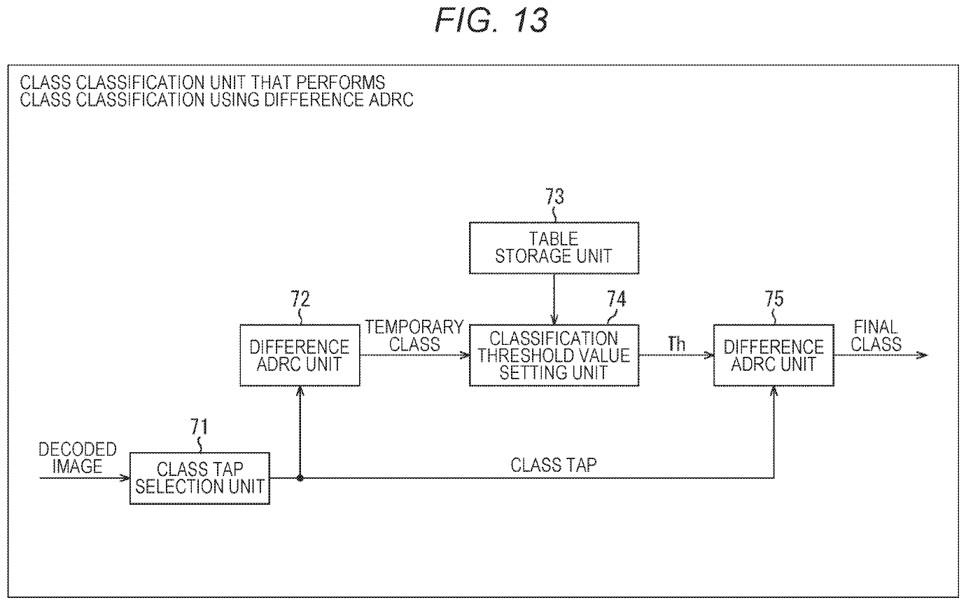

FIG. 13 is a block diagram illustrating a configuration example of a class classification unit that performs class classification using the differential ADRC, in which the classification threshold value is flexibly set in accordance with the dynamic range of the absolute difference value, as described above.

In FIG. 13, the class classification unit includes a class tap selection unit 71, a difference ADRC unit 72, a table storage unit 73, a classification threshold value setting unit 74, and a difference ADRC unit 75.

The class tap selection unit 71 is supplied with a decoded image. The class tap selection unit 71 selects a pixel as a class tap from the decoded image for a target pixel of the decoded image, and supplies the pixel to the difference ADRC units 72 and 75.

The difference ADRC unit 72 performs difference ADRC on the class tap of the target pixel from the class tap selection unit 71, and supplies a resulting class to the classification threshold value setting unit 74, as a temporary class that is a temporary class of the target pixel. Note that, in the difference ADRC unit 72, the difference ADRC is performed by setting a classification threshold value to an average value of a maximum value and a minimum value of an absolute difference value of the pixel as the class tap.

For any temporary class obtained by the difference ADRC unit 72, the table storage unit 73 stores a classification threshold value table (hereinafter, also referred to as a threshold value table) to be used for obtaining a final class that is a final class of a pixel classified into the temporary class.

The classification threshold value setting unit 74 refers to the threshold value table stored in the table storage unit 73. Then, in a case where classification threshold value relationship information indicating a relationship between a classification threshold value Th and a dynamic range DR of the absolute difference value of (the pixel value of) the pixel as the class tap is registered in the threshold value table for the temporary class of the target pixel from the difference ADRC unit 72, the classification threshold value setting unit 74 sets the classification threshold value Th to be used for obtaining the final class in accordance with the classification threshold value relationship information, and supplies the classification threshold value Th to the difference ADRC unit 75.

In a case where the classification threshold value Th is supplied from the classification threshold value setting unit 74, the difference ADRC unit 75 uses the classification threshold value Th to perform the difference ADRC on the class tap of the target pixel from the class tap selection unit 71, and outputs a resulting class as the final class of the target pixel.

Furthermore, in a case where the classification threshold value Th is not supplied from the classification threshold value setting unit 74, the difference ADRC unit 75 performs the difference ADRC on the class tap of the target pixel from the class tap selection unit 71 similarly to the difference ADRC unit 72, and outputs a resulting class as the final class of the target pixel.

Therefore, in a case where the classification threshold value Th is not supplied from the classification threshold value setting unit 74 to the difference ADRC unit 75, in the difference ADRC unit 75, the difference ADRC is performed by setting the classification threshold value to the average value of the maximum value and the minimum value of the absolute difference value of the pixel as the class tap. In this case, it is possible to output the temporary class obtained by the difference ADRC unit 72 as the final class as it is, without performing the difference ADRC in the difference ADRC unit 75.

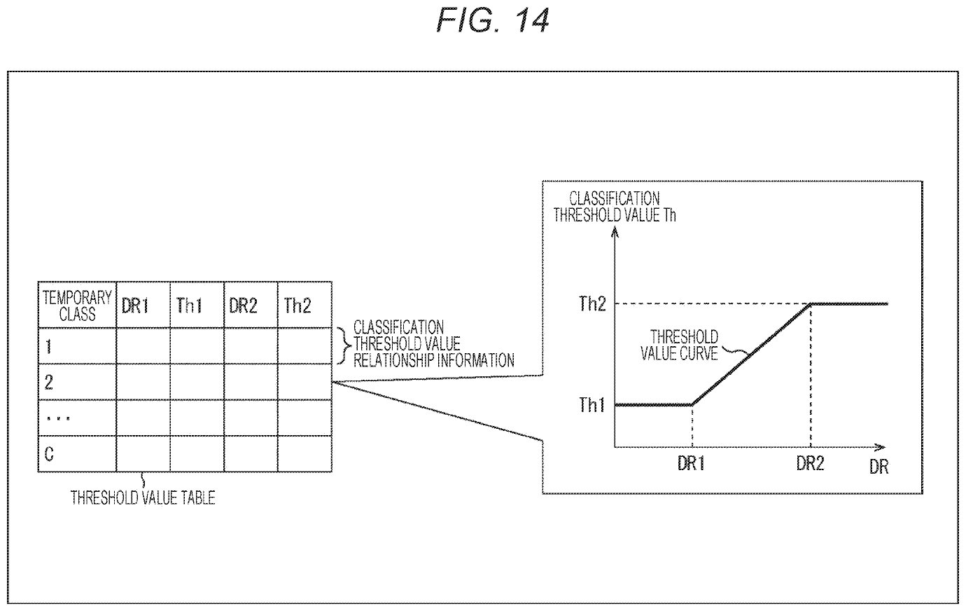

FIG. 14 is a view illustrating an example of the threshold value table stored in the table storage unit 73 in FIG. 13.

In the threshold value table in FIG. 14, the classification threshold value relationship information is registered for the temporary class.

The classification threshold value relationship information is information that defines a threshold value curve representing the classification threshold value Th that changes in accordance with the dynamic range DR of the absolute difference value of the pixel as the class tap, and has, for example, two dynamic ranges DR1 and DR2 and two classification threshold values Th1 and Th2.

As shown in FIG. 14, for example, in a two-dimensional plane where a horizontal axis is the dynamic range DR and a vertical axis is the classification threshold value Th, a curve defined by the classification threshold value relationship information DR1, DR2, Th1, and Th2 is a threshold value curve.

The classification threshold value setting unit 74 sets the classification threshold value Th in accordance with the dynamic range DR of the absolute difference value of the pixel as the class tap, in accordance with the threshold value curve defined by the classification threshold value relationship information of the temporary class.

In a case of performing class classification using the differential ADRC, the threshold value table as described above can be included in the classification method information as necessary, and transmitted from the encoding device 20 to the decoding device 30.

Note that, in the threshold value table, the classification threshold value relationship information DR1, DR2, Th1, and Th2 need not necessarily be registered for all the temporary classes. That is, in the threshold value table, in accordance with the dynamic range DR of the absolute difference value of the pixel as the class tap, the classification threshold value relationship information DR1, DR2, Th1, and Th2 can be registered only for the temporary class for which the classification threshold value Th is desired to be set flexibly.

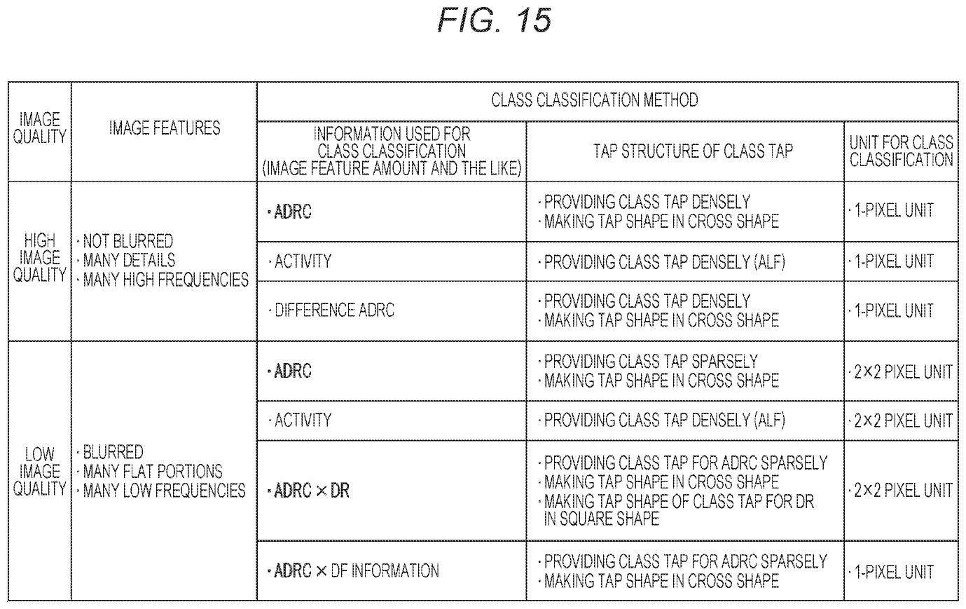

FIG. 15 is a view for explaining an example of a plurality of class classification methods.

As described with reference to FIG. 8, for each of the plurality of class classification methods, the class classification unit 41 performs class classification of the class classification method on each pixel of the decoded image.

On the other hand, the class classification method is defined by information to be used for the class classification (an image feature amount and the like), a tap structure of a class tap (a way of providing a tap), and a unit for performing the class classification.

Therefore, the plurality of class classification methods can be made by preparing a plurality of pieces of information, a plurality of tap structures, and a plurality of units as the information to be used for the class classification, the tap structure of the class tap, and the unit for performing the class classification, respectively, and combining each of the plurality of pieces of information, each of the plurality of tap structures, and each of the plurality of units.

However, in a case of combining each of the plurality of pieces of information, each of the plurality of tap structures, and each of the plurality of units to make a plurality of class classification methods, the number of the plurality of class classification methods may be enormous.

Meanwhile, for the combination of the information to be used for the class classification, the tap structure of the class tap, and the unit for performing the class classification, there may be an appropriate combination.

Therefore, by preparing some appropriate combinations as the combination of the information to be used for the class classification, the tap structure of the class tap, and the unit for performing the class classification, some appropriate combinations can be adopted as a plurality of class classification methods of the class classification performed by the class classification unit 41.

FIG. 15 shows an example of a plurality of class classification methods as appropriate combinations of the information to be used for the class classification, the tap structure of the class tap, and the unit for performing the class classification as described above.

In FIG. 15, similarly to the case of FIG. 10, the selectable class classification methods are divided in accordance with image quality of the decoded image. However, the selectable class classification methods need not necessarily be divided in accordance with the image quality of the decoded image.

In a case where the image quality of the decoded image is high image quality, it is possible to adopt ADRC as the information to be used for the class classification, adopt providing the class tap densely and making a tap shape in a cross shape as the tap structure of the class tap, and adopt 1-pixel unit as the unit for performing the class classification.

Furthermore, it is possible to adopt an activity adopted in the existing ALF as the information to be used for the class classification, adopt providing the class tap densely and making the tap shape in a square shape as adopted in the existing ALF as the tap structure of the class tap, and adopt 1-pixel unit as the unit for performing the class classification. Moreover, it is possible to adopt the difference ADRC as the information to be used for the class classification, adopt providing the class tap densely and making the tap shape in a cross shape as the tap structure of the class tap, and adopt 1-pixel unit as the unit for performing the class classification.

For example, according to the class classification method of adopting the difference ADRC as the information to be used for the class classification, adopting providing the class tap densely and making the tap shape in a cross shape as the tap structure of the class tap, and adopting 1-pixel unit as the unit for performing the class classification, in particular, it is possible to appropriately classify a pixel included in an edge or a complicated texture.

On the other hand, in a case where the image quality of the decoded image is low image quality, it is possible to adopt ADRC as the information to be used for the class classification, adopt providing the class tap sparsely and making the tap shape in a cross shape as the tap structure of the class tap, and adopt 2×2 pixel unit as the unit for performing the class classification. Moreover, it is possible to adopt an activity adopted in the existing ALF as the information to be used for the class classification, adopt providing the class tap densely and making the tap shape in a square shape as adopted in the existing ALF as the tap structure of the class tap, and adopt 2×2 pixel unit as the unit for performing the class classification.

Furthermore, it is possible to adopt a combination (ADRC×DR) of ADRC and DR (a difference between a maximum value and a minimum value of the class wrap) as the information to be used for the class classification, adopt providing a class tap for ADRC sparsely, making the tap shape in a cross shape, and making a tap shape of a class tap for DR in a square shape as the tap structure of the class tap, and adopt 2×2 pixel unit as the unit for performing the class classification.

Besides, in a case where the image quality of the decoded image is low image quality, when a deblocking filter is provided as the pre-stage filter, it is possible to adopt a combination (ADRC×DF information) of the ADRC and the DF information as the information to be used for the class classification, adopt providing the class tap for ADRC sparsely and making the tap shape in a cross shape as the tap structure of the class tap, and adopt 1-pixel unit as the unit for performing the class classification.

For example, according to the class classification method of: adopting the combination of ADRC and DR as the information to be used for the class classification; adopting providing the class tap for ADRC sparsely, making the tap shape in a cross shape, and making the tap shape of the class tap for DR in a square shape as the tap structure of the class tap; and adopting 2×2 pixel unit as the unit for performing the class classification, in particular, pixels included in a flat portion and gradation can be appropriately classified.

Furthermore, for example, according to the class classification method of: adopting the combination of the ADRC and the DF information as the information to be used for the class classification; adopting providing the class tap for ADRC sparsely and making the tap shape in a cross shape as the tap structure of the class tap; and adopting 1-pixel unit as the unit for performing the class classification, in particular, pixels included in block distortion can be appropriately classified. Moreover, the class classification can be performed so as to be suitable for restoring distortion generated by the deblocking filter.

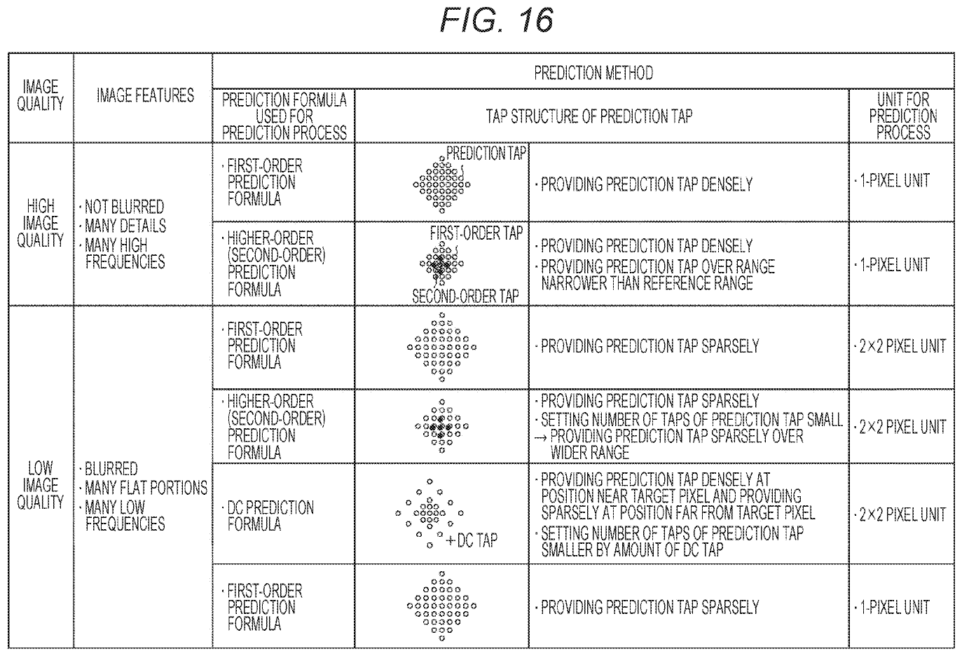

FIG. 16 is a view for explaining an example of a plurality of prediction methods.

As described with reference to FIG. 8, for each of the plurality of prediction methods, the predicting unit 42 performs, on the decoded image, the filtering process (and the tap coefficient learning or the seed coefficient learning) as the prediction process of the prediction method.

On the other hand, the prediction method is defined by a prediction formula to be used for the prediction process, a tap structure of a prediction tap (a way of providing a tap), and a unit for performing the prediction process.

Therefore, the plurality of prediction methods can be made by preparing a plurality of prediction formulas, a plurality of tap structures, and a plurality of units as the prediction formula to be used for the prediction process, the tap structure of the prediction tap, and the unit for performing the prediction process, respectively, and combining each of the plurality of prediction formulas, each of the plurality of tap structures, and each of the plurality of units.

However, in a case of combining each of the plurality of prediction formulas, each of the plurality of tap structures, and each of the plurality of units to make the plurality of prediction methods, the number of the plurality of prediction methods may be enormous.

Meanwhile, for the combination of the prediction formula to be used for the prediction process, the tap structure of the prediction tap, and the unit for performing the prediction process, there may be an appropriate combination.

Therefore, by preparing some appropriate combinations as the combination of the prediction formula to be used for the prediction process, the tap structure of the prediction tap, and the unit for performing the prediction process, some appropriate combinations can be adopted as the plurality of prediction methods of the prediction process performed by the predicting unit 42.

FIG. 16 shows an example of a plurality of prediction methods as appropriate combinations of a prediction formula to be used for the prediction process, a tap structure of the prediction tap, and a unit for performing the prediction process as described above.

In FIG. 16, similarly to the case of FIG. 11, selectable prediction methods are divided in accordance with image quality of the decoded image. However, the selectable prediction methods need not necessarily be divided in accordance with the image quality of the decoded image.

In a case where the image quality of the decoded image is high image quality, it is possible to adopt a first-order prediction formula as the prediction formula to be used for the prediction process, adopt making the tap shape in a rhombus shape and providing the prediction tap densely as the tap structure of the prediction tap, and adopt 1-pixel unit as the unit for performing the prediction process. Moreover, it is possible to adopt a second-order prediction formula as a higher-order prediction formula as the prediction formula to be used for the prediction process, adopt making the tap shape in a rhombus shape, providing the prediction tap densely, and providing the prediction tap over a range narrower than a reference range as the tap structure of the prediction tap, and adopt 1-pixel unit as the unit for performing the prediction process.

Note that, as described above, in a case of adopting the second-order prediction formula as the prediction formula to be used for the prediction process and adopting providing the prediction tap over the range narrower than the reference range as the tap structure of the prediction tap, the second-order tap can be provided over the range narrower than the reference range and a range narrower than a range in which the first-order tap is provided.

On the other hand, in a case where the image quality of the decoded image is low image quality, it is possible to adopt a first-order prediction formula as the prediction formula to be used for the prediction process, adopt making the tap shape in a rhombus shape and providing the prediction tap sparsely as the tap structure of the prediction tap, and adopt 2×2 pixel unit as the unit for performing the prediction process. Moreover, it is possible to adopt a second-order prediction formula as a higher-order prediction formula as the prediction formula to be used for the prediction process, adopt making the tap shape in a rhombus shape, providing the prediction tap sparsely, and setting the number of taps of the prediction tap smaller than a predetermined number as the tap structure of the prediction tap, and adopt 2×2 pixel unit as the unit for performing the prediction process.

Note that, as described above, in a case of adopting providing the prediction tap sparsely and setting the number of taps of the prediction tap smaller than the predetermined number as the tap structure of the prediction tap, for the decoded image of high image quality, the prediction tap is to be provided sparsely and over a wide range as compared with a case where a second-order prediction formula is adopted as the prediction formula to be used for the prediction process.

Besides, in a case where the image quality of the decoded image is low image quality, it is possible to adopt a DC prediction formula as the prediction formula to be used for the prediction process, making the tap shape in a rhombus shape, providing the prediction tap densely at a position near the target pixel and sparsely at a position far from the target pixel, and making the number of taps of the prediction tap smaller by an amount of the DC tap than that of a case of adopting a first-order prediction formula as the tap structure of the prediction tap, and adopt 2×2 pixel unit as the unit for performing the prediction process. Moreover, it is possible to adopt a first-order prediction formula as the prediction formula to be used for the prediction process, adopt making the tap shape in a rhombus shape and providing the prediction tap sparsely as the tap structure of the prediction tap, and adopt 1-pixel unit as the unit for performing the prediction process.

Note that, in the present embodiment, in a case where the image quality of the decoded image is low image quality, the prediction method at a bottom section in FIG. 16 adopts a first-order prediction formula as the prediction formula to be used for the prediction process, adopts making the tap shape in a rhombus shape and providing the prediction tap sparsely as the tap structure of the prediction tap, and adopts 1-pixel unit as the unit for performing the prediction process. This prediction method may be selected in a case of selecting the class classification method shown in the lowermost column in FIG. 15, in which a deblocking filter is provided as the pre-stage filter, the combination of the ADRC and the DF information is adopted as the information to be used for the class classification, providing the class tap for ADRC sparsely and making the tap shape in a cross shape are adopted as the tap structure of the class tap, and 1 pixel unit is adopted as the unit for performing the class classification.

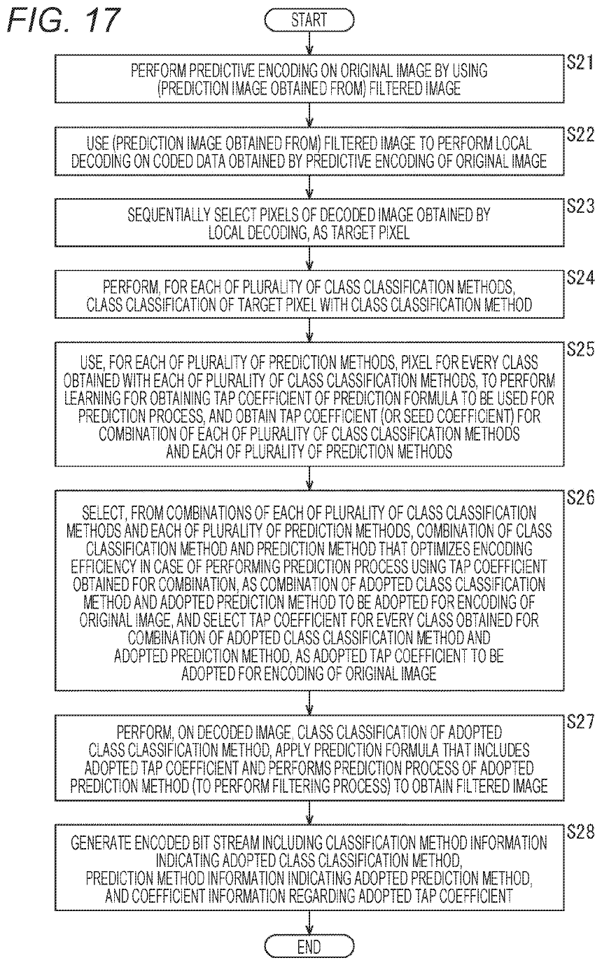

FIG. 17 is a flowchart for explaining an outline of an encoding process by the encoding device 20 in FIG. 7.

Processing according to the flowchart in FIG. 17 is performed, for example, on a frame (picture) basis.

In step S21, the encoding unit 21 (FIG. 7) performs (predictive) encoding on an original image by using a filtered image from the filter unit 23, and supplies coded data obtained by the encoding to the local decoding unit 22, and the process proceeds to step S22.

In step S22, the local decoding unit 22 performs local decoding on the coded data from the encoding unit 21 by using the filtered image from the filter unit 23, and supplies a resulting (local) decoded image to the filter unit 23, and the process proceeds to step S23.

In step S23, in the filter unit 23 (FIG. 8), the class classification unit 41 sequentially selects pixels of the decoded image from the local decoding unit 22 as a target pixel, and the process proceeds to step S24.

In step S24, for each of the plurality of class classification methods, the class classification unit 41 performs class classification of the class classification method on the target pixel of the decoded image, and supplies a class of the target pixel to the predicting unit 42, and the process proceeds to step S25.

In step S25, for each of the plurality of prediction methods, the predicting unit 42 uses the pixel and the original image for every class obtained for each of the plurality of class classification methods from the class classification unit 41, to perform tap coefficient learning (or seed coefficient learning) to obtain a tap coefficient (or seed coefficient) for every class, for each combination of each of the plurality of class classification methods and each of the plurality of prediction methods.

Moreover, for the combination of each of the plurality of class classification methods and each of the plurality of prediction methods, the predicting unit 42 performs a filtering process as the prediction process of applying, to the decoded image, a prediction formula including the tap coefficient obtained by the tap coefficient learning (or a tap coefficient obtained from the seed coefficient obtained by the seed coefficient learning), to generate a filtered image.

For the combination of each of the plurality of class classification methods and each of the plurality of prediction methods, the predicting unit 42 obtains PSNR of the filtered image by comparing the filtered image with the original image, and obtains a data amount of an encoded bit stream including the coded data obtained by encoding the original image and information necessary for decoding the coded data.

Then, for the combination of each of the plurality of class classification methods and each of the plurality of prediction methods, the predicting unit 42 associates and supplies, to the selection unit 43, PSNR, the data amount of the encoded bit stream, classification method information indicating the class classification method, prediction method information indicating the prediction method, and the tap coefficient (or the seed coefficient), and the process proceeds from step S25 to step S26.

In step S26, in a case of performing, from combinations of each of the plurality of class classification methods and each of the plurality of prediction methods, a prediction process using the tap coefficient (or a tap coefficient obtained from the seed coefficient) obtained for the combination, the selection unit 43 selects a combination of a class classification method and a prediction method that optimizes encoding efficiency, as a combination of an adopted class classification method and an adopted prediction method. Moreover, the predicting unit 42 selects, as an adopted tap coefficient (or a seed coefficient), a tap coefficient (or a seed coefficient used to obtain the tap coefficient) for every class obtained for the combination of the adopted class classification method and the adopted prediction method, and includes the tap coefficient in the coefficient information.

The selection unit 43 supplies, to the DB 44, the adopted tap coefficient (or the seed coefficient) included in the coefficient information regarding the combination of the adopted class classification method and the adopted prediction method and causes the DB 44 to store it, and the process proceeds from step S26 to step S27.

Here, classification method information indicating the adopted class classification method, prediction method information indicating the adopted prediction method, and the adopted tap coefficient as the coefficient information stored in the DB 44 are included in the filter information and supplied from the filter unit 23 to the encoding unit 21 (FIG. 7).

Furthermore, the selection unit 43 supplies the classification method information indicating the adopted class classification method to the class classification unit 45, and supplies the prediction method information indicating the adopted prediction method to the predicting unit 46.

In step S27, the class classification unit 45 performs class classification on each pixel of the decoded image with the (adopted) class classification method indicated by the classification method information from the selection unit 43, and supplies a class of each pixel to the predicting unit 46. By applying, to the decoded image, a prediction formula including the tap coefficient of the class from the class classification unit 45 among the adopted tap coefficients (or tap coefficients generated from the seed coefficients) as the coefficient information stored in the DB 44, the predicting unit 46 performs a filtering process as a prediction process of the (adopted) prediction method indicated by the prediction method information from the selection unit 43, and supplies a resulting filtered image to the encoding unit 21 and the local decoding unit 22 (FIG. 8). Then, the process proceeds from step S27 to step S28.

Here, the filtered image supplied from the predicting unit 46 to the encoding unit 21 and the local decoding unit 22 in step S27 is used, for example, in the processing of steps S21 and S22 performed on the next frame of the decoded image.

In step S28, the encoding unit 21 generates and transmits an encoded bit stream including the filter information from the filter unit 23, that is, the classification method information, the prediction method information, and the coefficient information.

Note that, in a case of performing the seed coefficient learning in the predicting unit 42, the coefficient information includes the seed coefficient, and includes an order of a coefficient prediction formula for obtaining the tap coefficient from the seed coefficient, and a parameter z as necessary.

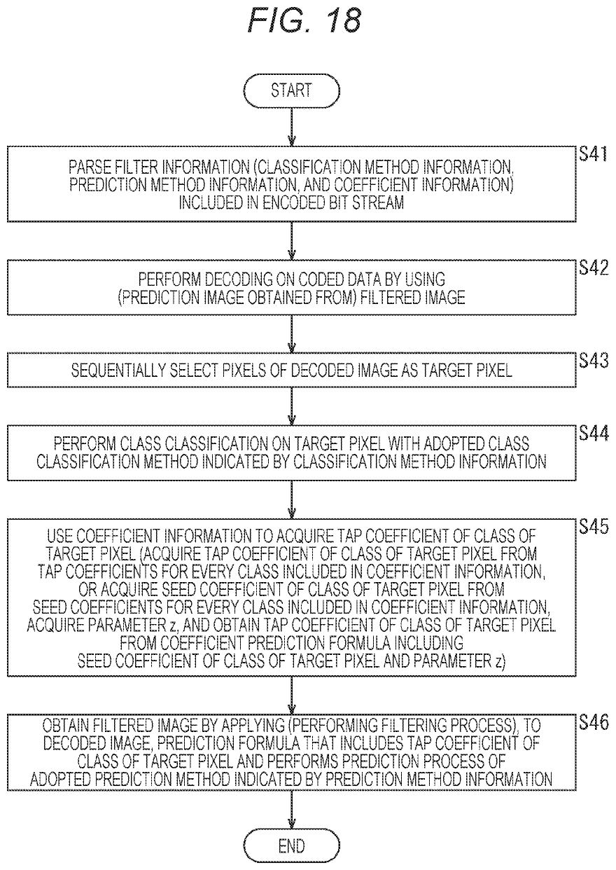

FIG. 18 is a flowchart for explaining an outline of a decoding process by the decoding device 30 in FIG. 7.

Processing according to the flowchart in FIG. 18 is performed on a frame basis, for example, similarly to the encoding process in FIG. 17.

In step S41, the parsing unit 31 (FIG. 7) receives the encoded bit stream transmitted from the encoding device 20, parses the filter information included in the encoded bit stream, and supplies the filter information to the filter unit 33. Moreover, the parsing unit 31 supplies the coded data included in the encoded bit stream to the decoding unit 32, and the process proceeds from step S41 to step S42.

In step S42, the decoding unit 32 performs decoding on the coded data from the parsing unit 31 by using the filtered image from the filter unit 33, and supplies a resulting decoded image to the filter unit 33, and the process proceeds to step S43.

In step S43, in the filter unit 33 (FIG. 8), the class classification unit 51 sequentially selects pixels of the decoded image from the decoding unit 32 as a target pixel, and the process proceeds to step S44.

In step S44, the class classification unit 51 performs class classification on the target pixel with the adopted class classification method indicated by the classification method information included in the filter information, and supplies a resulting class of the target pixel to the predicting unit 52, and the process proceeds to step S45.

In step S45, the predicting unit 52 acquires the (adopted) tap coefficient of the class of the target pixel from the class classification unit 51, from the adopted tap coefficients in the coefficient information included in the filter information, and the process proceeds to step S46.

Here, in a case where the coefficient information includes a tap coefficient for every class, in step S45, the predicting unit 52 acquires the tap coefficient of the class of the target pixel from the tap coefficients for every class included in the coefficient information, as described above.

Furthermore, in a case where the coefficient information includes a seed coefficient for every class, in step S45, the predicting unit 52 acquires the seed coefficient of the class of the target pixel from the seed coefficients for every class included in the coefficient information and acquires the parameter z, and obtains the tap coefficient of the class of the target pixel by operating the coefficient prediction formula including the seed coefficient of the class of the target pixel and the parameter z.

In step S46, by applying a prediction formula including the tap coefficient acquired in step S45 to the decoded image, the predicting unit 52 performs a filtering process as a prediction process of the adopted prediction method indicated by the prediction method information included in the filter information, to generate a filtered image.

The filtered image is supplied from the filter unit 33 to the decoding unit 32 (FIG. 7), and is outputted as a restored image obtained by restoring the original image.

The filtered image supplied from the filter unit 33 to the decoding unit 32 in step S46 is used, for example, in the processing of step S42 performed on the next frame of the decoded image.

<Configuration Example of Encoding Device 20>

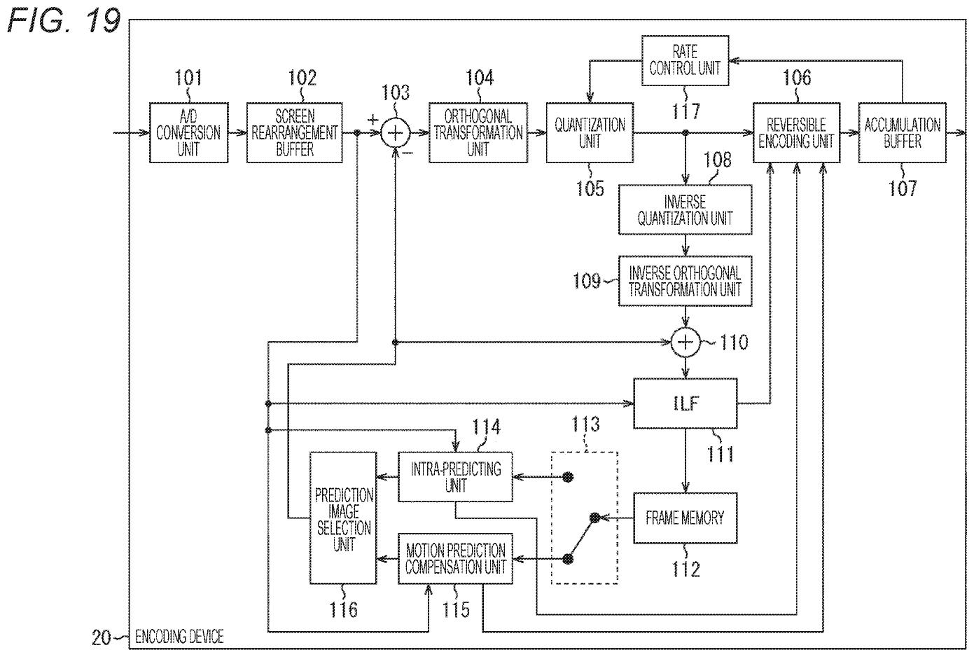

FIG. 19 is a block diagram illustrating a detailed configuration example of the encoding device 20 in FIG. 7.

Note that, in the block diagram described below, illustration of lines for supplying information (data) necessary for processing of each block are omitted as appropriate to avoid complicating the drawing.

In FIG. 19, the encoding device 20 includes an A/D conversion unit 101, a rearrangement buffer 102, an arithmetic unit 103, an orthogonal transformation unit 104, a quantization unit 105, a reversible encoding unit 106, and an accumulation buffer 107. Moreover, the encoding device 20 includes an inverse quantization unit 108, an inverse orthogonal transformation unit 109, an arithmetic unit 110, an ILF 111, a frame memory 112, a selection unit 113, an intra-predicting unit 114, a motion prediction compensation unit 115, a prediction image selection unit 116, and a rate control unit 117.

The A/D conversion unit 101 performs A/D conversion on an original image of an analog signal into an original image of a digital signal, supplies the original image to the rearrangement buffer 102 and causes the rearrangement buffer 102 to store it.

The rearrangement buffer 102 rearranges frames of the original image in accordance with a group of picture (GOP) from a display order to an encoding (decoding) order, and supplies the frames to the arithmetic unit 103, the intra-predicting unit 114, the motion prediction compensation unit 115, and the ILF 111.

The arithmetic unit 103 subtracts, from the original image from the rearrangement buffer 102, a prediction image supplied from the intra-predicting unit 114 or the motion prediction compensation unit 115 via the prediction image selection unit 116, and supplies a residual (prediction residual) obtained by the subtraction to the orthogonal transformation unit 104.

For example, in a case of an image on which inter-encoding is performed, the arithmetic unit 103 subtracts the prediction image supplied from the motion prediction compensation unit 115 from the original image read from the rearrangement buffer 102.

The orthogonal transformation unit 104 applies orthogonal transformation such as discrete cosine transformation or Karhunen-Loeve transformation on the residual supplied from the arithmetic unit 103. Note that any method may be adopted for this orthogonal transformation. The orthogonal transformation unit 104 supplies an orthogonal transformation coefficient obtained by the orthogonal exchange to the quantization unit 105.

The quantization unit 105 quantizes the orthogonal transformation coefficient supplied from the orthogonal transformation unit 104. The quantization unit 105 sets a quantization parameter QP on the basis of a target value of a code amount (a code amount target value) supplied from the rate control unit 117, and quantizes the orthogonal transformation coefficient. Note that any method may be adopted for this quantization. The quantization unit 105 supplies coded data, which is the quantized orthogonal transformation coefficient, to the reversible encoding unit 106.

The reversible encoding unit 106 encodes the quantized orthogonal transformation coefficient as the coded data from the quantization unit 105, with a prescribed reversible encoding method. Since the orthogonal transformation coefficient is quantized under control of the rate control unit 117, the code amount of an encoded bit stream obtained by the reversible encoding of the reversible encoding unit 106 becomes the code amount target value (or approximates the code amount target value) set by the rate control unit 117.

Furthermore, the reversible encoding unit 106 acquires, from each block, encode information necessary for decoding with the decoding device 30, in encode information regarding predictive encoding by the encoding device 20.

Here, examples of the encode information include, for example, a prediction mode of intra-prediction and inter prediction, motion information such as a motion vector, the code amount target value, the quantization parameter QP, a picture type (I, P, B), information of coding unit (CU) and coding tree unit (CTU), and the like.

For example, the prediction mode can be acquired from the intra-predicting unit 114 or the motion prediction compensation unit 115. Furthermore, for example, the motion information can be acquired from the motion prediction compensation unit 115.

The reversible encoding unit 106 acquires the encode information, and also acquires, from the ILF 111, filter information regarding the filtering process in the ILF 111.

The reversible encoding unit 106 encodes the encode information and the filter information with, for example, variable-length encoding or arithmetic encoding such as context-adaptive variable length coding (CAVLC) or context-adaptive binary arithmetic coding (CABAC), and other reversible encoding method, generates an encoded bit stream including the encode information and filter information after encoding, and including the coded data from the quantization unit 105, and supplies the encoded bit stream to the accumulation buffer 107.

The accumulation buffer 107 temporarily accumulates the encoded bit stream supplied from the reversible encoding unit 106. The encoded bit stream accumulated in the accumulation buffer 107 is read at a prescribed timing and transmitted.

The coded data, which is the orthogonal transformation coefficient quantized in the quantization unit 105, is supplied to the reversible encoding unit 106, and is also supplied to the inverse quantization unit 108. The inverse quantization unit 108 inversely quantizes the quantized orthogonal transformation coefficient with a method corresponding to the quantization by the quantization unit 105, and supplies the orthogonal transformation coefficient obtained by the inverse quantization to the inverse orthogonal transformation unit 109.

The inverse orthogonal transformation unit 109 performs inverse orthogonal transformation on the orthogonal transformation coefficient supplied from the inverse quantization unit 108, with a method corresponding to the orthogonal transformation process by the orthogonal transformation unit 104, and supplies a residual obtained as a result of the inverse orthogonal transformation to the arithmetic unit 110.

The arithmetic unit 110 adds the prediction image supplied from the intra-predicting unit 114 or the motion prediction compensation unit 115 via the prediction image selection unit 116, to the residual supplied from the inverse orthogonal transformation unit 109, and consequently obtains (a part of) a decoded image obtained by decoding the original image and output the decoded image.

The decoded image outputted from the arithmetic unit 110 is supplied to the ILF 111.

The ILF 111 performs, for example, a filtering process as a class classification prediction process, to predict (restore) the original image.

The ILF 111 is supplied with the decoded image from the arithmetic unit 110, and is also supplied with the original image corresponding to the decoded image from the rearrangement buffer 102.

The ILF 111 uses, for example, the decoded image from the arithmetic unit 110 and the original image from the rearrangement buffer 102 as student data and teacher data, respectively, and performs tap coefficient learning or seed coefficient learning for each combination of each of a plurality of class classification methods and each of a plurality of prediction methods.

Moreover, in a case of performing, from combinations of each of the plurality of class classification methods and each of the plurality of prediction methods, a prediction process using the tap coefficient obtained for the combination or using a tap coefficient generated (obtained) from the seed coefficient, the ILF 111 selects a combination of a class classification method and a prediction method that optimizes encoding efficiency, as a combination of an adopted class classification method and an adopted prediction method. Moreover, the ILF 111 includes, in the coefficient information as the adopted tap coefficient or the seed coefficient, a tap coefficient or a seed coefficient for every class obtained for the combination of the adopted class classification method and the adopted prediction method.

Then, the ILF 111 generates classification method information indicating the adopted class classification method, prediction method information indicating the adopted prediction method, and filter information including the coefficient information, and supplies the information to the reversible encoding unit 106.

Furthermore, the ILF 111 performs class classification on each pixel of the decoded image with the adopted class classification method indicated by the classification method information of the filter information, and obtains a class of each pixel. Moreover, by applying, to each pixel of the decoded image, a prediction formula including a tap coefficient of the class of the pixel, among tap coefficients generated from the adopted tap coefficient or the seed coefficient included in the coefficient information of the filter information, the ILF 111 performs the filtering process as the prediction process of the adopted prediction method indicated by the prediction method information of the filter information, and outputs a filtered image generated by the filtering process.

The filtered image outputted from the ILF 111 is supplied to the frame memory 112.

Here, in order to simplify the description, it is assumed that, among the tap coefficient learning and the seed coefficient learning, the ILF 111 performs the tap coefficient learning, for example.

The ILF 111 can be made function as one or more filters among a deblocking filter, an adaptive offset filter, a bilateral filter, and an ALF, depending on a student image and a teacher image to be used for the tap coefficient learning.

Furthermore, in a case where the ILF 111 is made function as two or more filters among the deblocking filter, the adaptive offset filter, the bilateral filter, and the ALF, any arrangement order of the two or more filters may be adopted.

Moreover, the ILF 111 can be made function as a filter other than the deblocking filter, the adaptive offset filter, the bilateral filter, and the ALF. Furthermore, although filters other than the ILF 111 are not provided in FIG. 19, one or more of the deblocking filter, the adaptive offset filter, the bilateral filter, and the ALF can be provided in addition to the ILF 111, in one or both of a preceding stage and a subsequent stage of the ILF 111. The above point similarly applies to the decoding device 30.

The frame memory 112 temporarily stores the filtered image supplied from the ILF 111 as a restored image obtained by restoring the original image. The restored image stored in the frame memory 112 is supplied to the selection unit 113 at a necessary timing, as a reference image to be used for generating a prediction image.

The selection unit 113 selects a supply destination of the reference image supplied from the frame memory 112. For example, in a case of performing the intra-prediction in the intra-predicting unit 114, the selection unit 113 supplies the reference image supplied from the frame memory 112 to the intra-predicting unit 114. Furthermore, for example, in a case of performing the inter prediction in the motion prediction compensation unit 115, the selection unit 113 supplies the reference image supplied from the frame memory 112 to the motion prediction compensation unit 115.

The intra-predicting unit 114 uses the original image supplied from the rearrangement buffer 102 and the reference image supplied from the frame memory 112 via the selection unit 113, and performs intra-prediction (in-screen prediction) with a prediction unit (PU) as a unit of processing, for example. On the basis of a prescribed cost function (for example, RD cost and the like), the intra-predicting unit 114 selects an optimal intra-prediction mode, and supplies the prediction image generated with the optimal intra-prediction mode to the prediction image selection unit 116. Furthermore, as described above, the intra-predicting unit 114 appropriately supplies a prediction mode indicating the intra-prediction mode selected on the basis of the cost function, to the reversible encoding unit 106 and the like.

The motion prediction compensation unit 115 uses the original image supplied from the rearrangement buffer 102 and the reference image supplied from the frame memory 112 via the selection unit 113, and performs motion prediction (inter prediction) with PU as a unit of processing, for example. Moreover, the motion prediction compensation unit 115 performs motion compensation in accordance with a motion vector detected by the motion prediction, to generate a prediction image. The motion prediction compensation unit 115 performs inter prediction with a plurality of inter prediction modes prepared in advance, to generate a prediction image.

The motion prediction compensation unit 115 selects an optimal inter prediction mode on the basis of a prescribed cost function of the prediction image obtained for each of the plurality of inter prediction modes. Moreover, the motion prediction compensation unit 115 supplies the prediction image generated with the optimal inter prediction mode to the prediction image selection unit 116.

Furthermore, the motion prediction compensation unit 115 supplies, to the reversible encoding unit 106, a prediction mode indicating the inter prediction mode selected on the basis of the cost function, motion information such as a motion vector necessary in decoding the coded data encoded with the inter prediction mode, and the like.

The prediction image selection unit 116 selects a supply source (the intra-predicting unit 114 or the motion prediction compensation unit 115) of the prediction image to be supplied to the arithmetic units 103 and 210, and supplies the prediction image supplied from the selected supply source to the arithmetic units 103 and 210.

The rate control unit 117 controls a rate of quantization operation of the quantization unit 105 on the basis of a code amount of the encoded bit stream accumulated in the accumulation buffer 107 so as not to cause overflow or underflow. That is, the rate control unit 117 sets a target code amount of the encoded bit stream so as not to cause overflow and underflow of the accumulation buffer 107, and supplies the target code amount to the quantization unit 105.

Note that, in FIG. 19, the arithmetic unit 103 to the reversible encoding unit 106, the inverse quantization unit 108 to the arithmetic unit 110, and the ILF 111 correspond to the encoding unit 21 in FIG. 7, the local decoding unit 22 in FIG. 7, and the filter unit 23 in FIG. 7, respectively.

<Configuration Example of ILF 111>

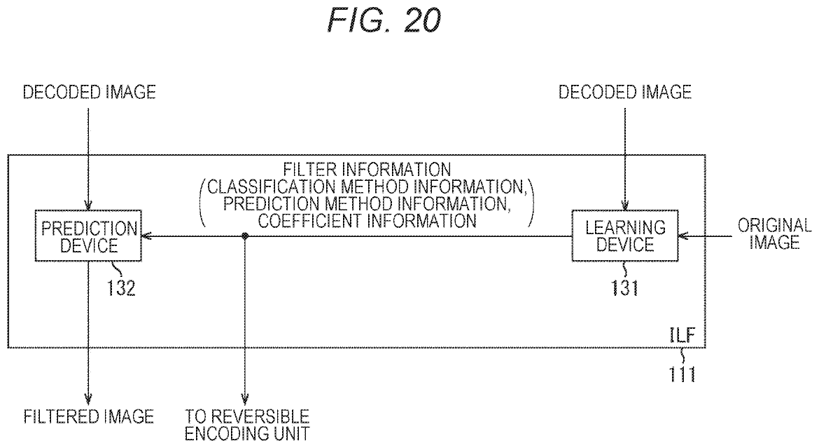

FIG. 20 is a block diagram illustrating a configuration example of the ILF 111 in FIG. 19.

In FIG. 20, the ILF 111 includes a learning device 131 and a prediction device 132.

The learning device 131 is supplied with an original image from the rearrangement buffer 102 (FIG. 19), and is also supplied with a decoded image from the arithmetic unit 110 (FIG. 19).

The learning device 131 uses the decoded image and the original image as student data and teacher data, respectively, to perform tap coefficient learning for each combination of each of the plurality of class classification methods and each of the plurality of prediction methods.

Moreover, in a case of performing, from combinations of each of the plurality of class classification methods and each of the plurality of prediction methods, a prediction process using a tap coefficient obtained for the combination, the learning device 131 selects a combination of a class classification method and a prediction method that optimizes encoding efficiency, as a combination of an adopted class classification method and an adopted prediction method. Moreover, the learning device 131 selects, as an adopted tap coefficient, a tap coefficient for every class obtained for the combination of the adopted class classification method and the adopted prediction method. Then, with the adopted tap coefficient as coefficient information, the learning device 131 generates filter information including: the coefficient information; classification method information indicating the adopted class classification method; and prediction method information indicating the adopted prediction method, and supplies the filter information to the prediction device 132 and also to the reversible encoding unit 106 (FIG. 19).

The prediction device 132 is supplied with the filter information from the learning device 131, and is also supplied with the decoded image from the arithmetic unit 110 (FIG. 19).

The prediction device 132 generates a filtered image by using the filter information from the learning device 131 to perform a class classification prediction process on the decoded image, and supplies the filtered image to the frame memory 112 (FIG. 19).

That is, the prediction device 132 performs class classification on each pixel of the decoded image with the adopted class classification method indicated by the classification method information of the filter information, and obtains a class of each pixel. Moreover, by applying, to each pixel of the decoded image, a prediction formula including a tap coefficient of the class of the pixel among adopted tap coefficients included in the coefficient information of the filter information, the prediction device 132 performs the filtering process as the prediction process of the adopted prediction method indicated by the prediction method information of the filter information, and supplies the filtered image generated by the filtering process to the frame memory 112.

<Configuration Example of Learning Device 131>

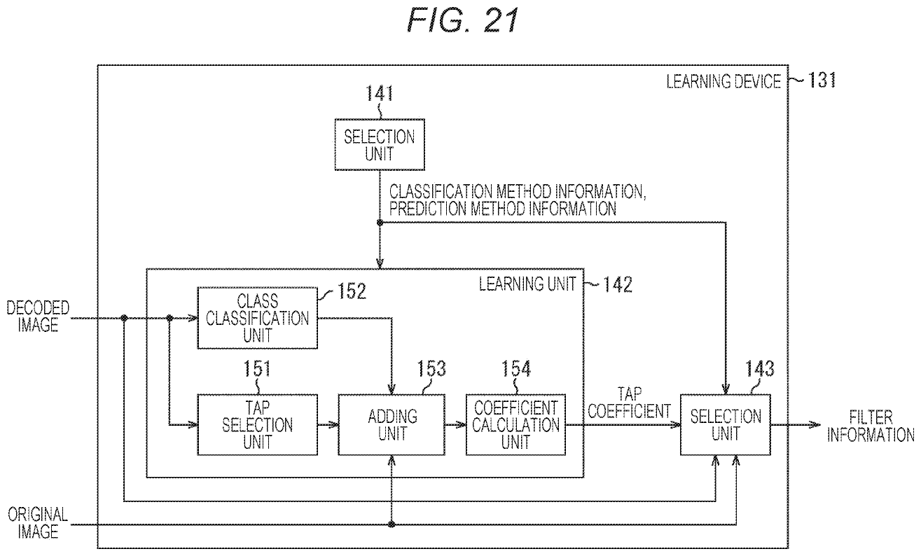

FIG. 21 is a block diagram illustrating a configuration example of the learning device 131 in FIG. 20.

In FIG. 21, the learning device 131 includes a selection unit 141, a learning unit 142, and a selection unit 143.

The selection unit 141 stores, for example, the classification method information of each of the plurality of class classification methods and the prediction method information of each of the plurality of prediction methods as described with reference to FIGS. 15 and 16.

The selection unit 141 selects, as target information, a combination that has not yet been selected as the target information as a target combination among combinations of one of the plurality of pieces of classification method information and one of the plurality of pieces of prediction method information, and supplies the combination to the learning unit 142 and the selection unit 143.

The learning unit 142 includes a tap selection unit 151, a class classification unit 152, an adding unit 153, and a coefficient calculation unit 154, and performs tap coefficient learning with a decoded image and an original image as student data and teacher data, respectively. In the tap coefficient learning, class classification is performed with a class classification method indicated by the classification method information included in the combination as the target information supplied from the selection unit 141, to obtain a tap coefficient in a case where a prediction process is performed with a prediction method indicated by the prediction method information included in the combination as the target information.

The tap selection unit 151 sequentially selects, as a target pixel, pixels of the decoded image as student data. Moreover, in accordance with the prediction method indicated by the prediction method information included in the combination as the target information from the selection unit 141, the tap selection unit 151 selects a pixel as a prediction tap from pixels included in the student image for the target pixel, and supplies the pixel to the adding unit 153.

The class classification unit 152 uses, for example, the pixel of the decoded image to perform class classification on the target pixel with the class classification method indicated by the classification method information included in the combination as the target information from the selection unit 141, and outputs a class of a resulting target pixel to the adding unit 153.

The adding unit 153 selects a corresponding pixel corresponding to the target pixel from the original image as the teacher data, and performs addition of each term included in a normal equation on (a pixel value of) the corresponding pixel and the prediction tap for the target pixel supplied from the tap selection unit 151, for every class of the target pixel supplied from the class classification unit 152. Here, the normal equation for which the addition is performed is determined by the prediction method indicated by the prediction method information included in the combination as the target information from the selection unit 141.

Then, by performing addition on each term included in the normal equation with, as the target pixel, for example, all the pixels of one frame of the decoded image as the student data, the adding unit 153 sets a normal equation for each class, and supplies the normal equation to the coefficient calculation unit 154.

The coefficient calculation unit 154 obtains a tap coefficient for every class by solving the normal equation for each class supplied from the adding unit 153.

The coefficient calculation unit 154 supplies the tap coefficient for every class for the target information obtained as described above, to the selection unit 143.

The selection unit 143 is supplied with the target information from the selection unit 141, supplied with the tap coefficient for every class for the target information from (the coefficient calculation unit 154 of) the learning unit 142, and also supplied with a decoded image and an original image as student data and teacher data for tap coefficient learning.

The selection unit 143 associates and stores the combination of the class classification method and the prediction method as the target information from the selection unit 141 and the tap coefficient for the target information from the learning unit 142.

From tap coefficients for each combination of the class classification method and the prediction method sequentially supplied as the target information from the selection unit 141, the selection unit 143 selects, as the adopted tap coefficient, a tap coefficient that optimizes encoding efficiency in a case of performing the filtering process as the class classification prediction process by using the tap coefficient. Here, in performing the class classification prediction process, the selection unit 143 performs the class classification with a class classification method included in the combination associated with the tap coefficient to be used, and performs the prediction process with a prediction method included in the combination associated with the tap coefficient to be used.

The selection unit 143 selects the class classification method and the prediction method included in the combination associated with the adopted tap coefficient, as an adopted class classification method and an adopted prediction method, respectively. Then, with the adopted tap coefficient as coefficient information, the selection unit 143 generates filter information including: the coefficient information; classification method information indicating the adopted class classification method; and prediction method information indicating the adopted prediction method, and supplies the filter information to the prediction device 132 (FIG. 20) and also to the reversible encoding unit 106 (FIG. 19).

<Configuration Example of Prediction Device 132>

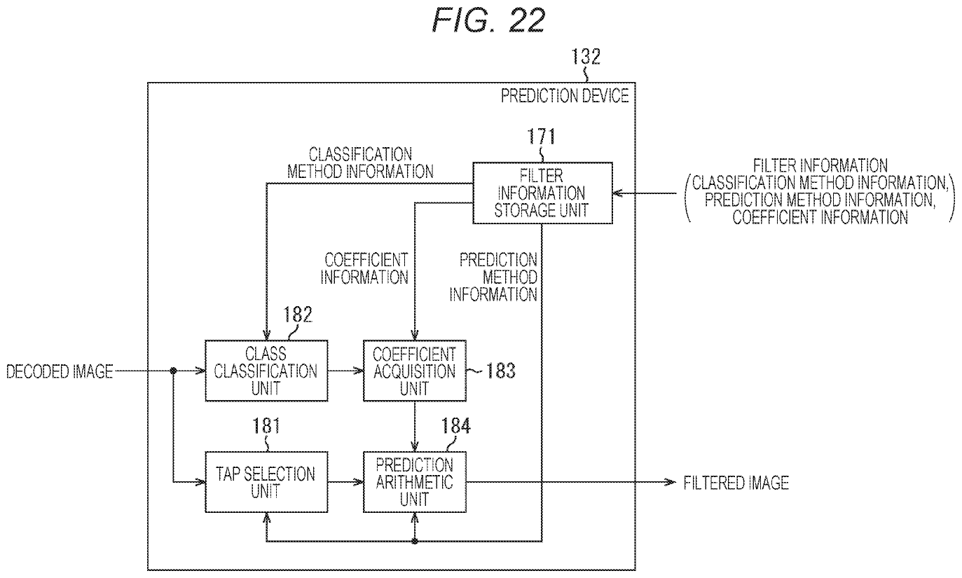

FIG. 22 is a block diagram illustrating a configuration example of the prediction device 132 in FIG. 20.

In FIG. 22, the prediction device 132 includes a filter information storage unit 171, a tap selection unit 181, a class classification unit 182, a coefficient acquisition unit 183, and a prediction arithmetic unit 184.

The filter information storage unit 171 stores filter information supplied from (the selection unit 143 (FIG. 21) of) the learning device 131. Classification method information included in the filter information stored in the filter information storage unit 171 is supplied to the class classification unit 182. Furthermore, coefficient information included in the filter information stored in the filter information storage unit 171 is supplied to the coefficient acquisition unit 183, and prediction method information included in the filter information is supplied to the tap selection unit 181 and the prediction arithmetic unit 184.

The tap selection unit 181 and the class classification unit 182 are supplied with a decoded image from the arithmetic unit 110.

The tap selection unit 181 sequentially selects, as a target pixel, pixels of the decoded image. Moreover, for the target pixel, the tap selection unit 181 selects, from the decoded image, a pixel as a prediction tap having a tap structure according to the adopted prediction method indicated by the prediction method information stored in the filter information storage unit 171, and supplies the pixel to the prediction arithmetic unit 184.

The class classification unit 182 uses the decoded image and the like to perform class classification on the target pixel with the adopted class classification method indicated by the classification method information stored in the filter information storage unit 171, and supplies a resulting class of the target pixel to the coefficient acquisition unit 183.

The coefficient acquisition unit 183 stores tap coefficients for every class as coefficient information stored in the filter information storage unit 171, and acquires a tap coefficient of the class of the target pixel from the class classification unit 182 among the stored tap coefficients. Moreover, the coefficient acquisition unit 183 supplies the tap coefficient of the class of the target pixel to the prediction arithmetic unit 184.

By using the prediction tap from the tap selection unit 181 and the tap coefficient supplied from the coefficient acquisition unit 183 to perform operation of the prediction formula according to the adopted prediction method indicated by the prediction method information stored in the filter information storage unit 171, the prediction arithmetic unit 184 obtains a prediction value of a pixel of an original image, and supplies a filtered image having the prediction value as a pixel value to the frame memory 112 (FIG. 19).

<Encoding Process>

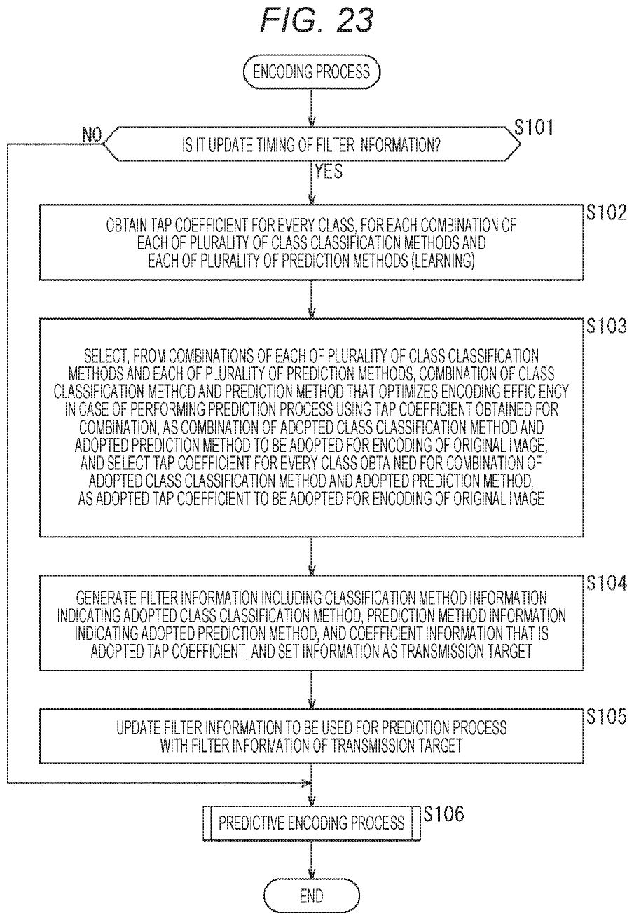

FIG. 23 is a flowchart for explaining an example of the encoding process by the encoding device 20 in FIG. 19.

Note that an order of individual steps of the encoding process shown in FIG. 23 and the like is an order for convenience of description, and individual steps of an actual encoding process are appropriately performed in parallel and in a necessary order. This similarly applies to the processing described later.

In the encoding device 20, the learning device 131 (FIG. 21) of the ILF 111 temporarily stores a decoded image supplied thereto, and also temporarily stores an original image corresponding to the decoded image.

Then, in step S101, the learning device 131 determines whether or not a current timing is an update timing for updating filter information.

Here, the update timing of the filter information can be determined in advance such as every one or more frames (pictures), every one or more sequences, every one or more slices, and every one or more lines of a prescribed block such as CTU, for example.

Furthermore, as the update timing of the filter information, in addition to a periodic (fixed) timing such as a timing of every one or more frames (pictures), it is possible to adopt so-called dynamic timings, such as a timing when S/N of the filtered image becomes equal to or less than a threshold value (a timing when an error of the filtered image with respect to the original image becomes equal to or greater than a threshold value), and a timing when (a sum of absolute values of) a residual becomes equal to or greater than a threshold value.

Here, for example, it is assumed that the learning device 131 performs tap coefficient learning by using one frame of the decoded image and the original image, and a timing of every one frame is the update timing of the filter information.

When it is determined in step S101 that the current timing is not the update timing of the filter information, the process skips steps S102 to S105 and proceeds to step S106.

Furthermore, when it is determined in step S101 that the current timing is the update timing of the filter information, the process proceeds to step S102, and the learning device 131 performs the tap coefficient learning for obtaining a tap coefficient for every class, for each combination of each of the plurality of class classification methods and each of the plurality of prediction methods.

That is, the learning device 131 uses, for example, the decoded image and the original image stored during a period from the previous update timing to the current update timing (here, the latest one-frame decoded image and original image supplied to the learning device 131 (the ILF 111)), to perform the tap coefficient learning, and obtains the tap coefficient for every class, for each combination of each of the plurality of class classification methods and each of the plurality of prediction methods.

Then, the process proceeds from step S102 to step S103, and in a case of performing, from combinations of each of the plurality of class classification methods and each of the plurality of prediction methods, a prediction process using the tap coefficient for every class obtained for the combination, the learning device 131 selects a combination of a class classification method and a prediction method that optimizes encoding efficiency, as a combination of an adopted class classification method and an adopted prediction method. Moreover, the learning device 131 selects, as an adopted tap coefficient, a tap coefficient for every class obtained for the combination of the adopted class classification method and the adopted prediction method, and the process proceeds from step S103 to step S104.

In step S104, with the adopted tap coefficient as coefficient information, the learning device 131 generates filter information including the coefficient information; classification method information indicating the adopted class classification method and prediction method information indicating the adopted prediction method, and supplies the filter information to the prediction device 132 (FIG. 22) and the reversible encoding unit 106 (FIG. 19).

The reversible encoding unit 106 (FIG. 19) sets the filter information from the learning device 131 as a transmission target, and the process proceeds from step S104 to step S105. The filter information set as the transmission target is included in an encoded bit stream and transmitted in a predictive encoding process performed in step S106 described later.

In step S105, the prediction device 132 updates the filter information stored in the filter information storage unit 171 (FIG. 22) with the filter information from the learning device 131 (stores the filter information in a form of overwriting), and the process proceeds to step S106.

In step S106, the predictive encoding process is performed on the original image, and the encoding process ends.

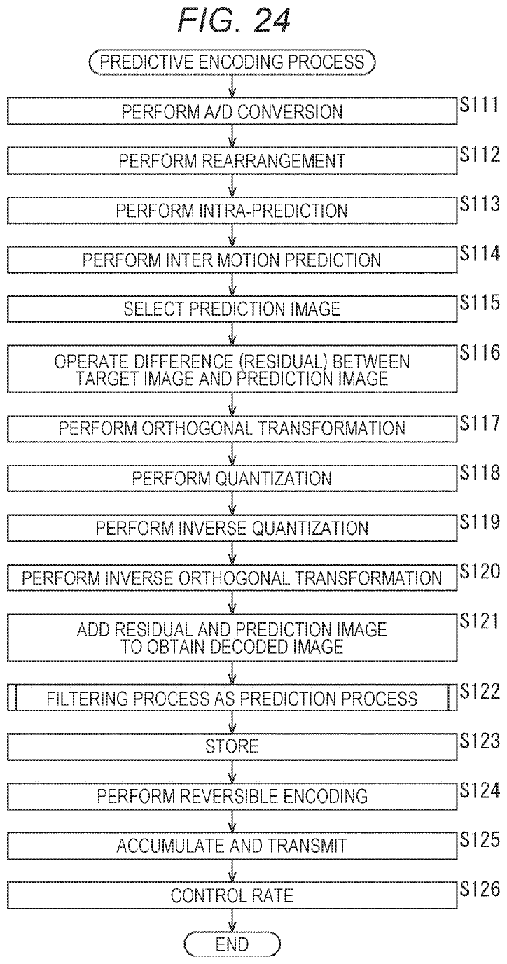

FIG. 24 is a flowchart for explaining an example of the predictive encoding process in step S106 in FIG. 23.

In the predictive encoding process, in step S111, the A/D conversion unit 101 (FIG. 19) performs A/D conversion on an original image and supplies the original image to the rearrangement buffer 102, and the process proceeds to step S112.

In step S112, the rearrangement buffer 102 stores the original image from the A/D conversion unit 101, and rearranges the original image and outputs it in an encoding order, and the process proceeds to step S113.

In step S113, the intra-predicting unit 114 performs an intra-prediction process of the intra-prediction mode, and the process proceeds to step S114. In step S114, the motion prediction compensation unit 115 performs an inter motion prediction process of performing motion prediction and motion compensation with the inter prediction mode, and the process proceeds to step S115.

In the intra-prediction process of the intra-predicting unit 114 and the inter motion prediction process of the motion prediction compensation unit 115, cost functions of various prediction modes are operated and a prediction image is generated.

In step S115, the prediction image selection unit 116 determines an optimal prediction mode on the basis of each cost function obtained by the intra-predicting unit 114 and the motion prediction compensation unit 115. Then, the prediction image selection unit 116 selects and outputs a prediction image generated by the intra-predicting unit 114, and a prediction image with the optimal prediction mode among the prediction images generated by the motion prediction compensation unit 115, and the process proceeds from step S115 to step S116.

In step S116, the arithmetic unit 103 operates a residual between the prediction image outputted by the prediction image selection unit 116 and the target image to be encoded, which is the original image outputted by the rearrangement buffer 102, and supplies the residual to the orthogonal transformation unit 104, and the process proceeds to step S117.

In step S117, the orthogonal transformation unit 104 orthogonally transforms the residual from the arithmetic unit 103, supplies a resulting orthogonal transformation coefficient to the quantization unit 105, and the process proceeds to step S118.

In step S118, the quantization unit 105 quantizes the orthogonal transformation coefficient from the orthogonal transformation unit 104, and supplies a quantization coefficient obtained by the quantization to the reversible encoding unit 106 and the inverse quantization unit 108, and the process proceeds to step S119.

In step S119, the inverse quantization unit 108 inversely quantizes the quantized coefficient from the quantization unit 105, and supplies a resulting orthogonal transformation coefficient to the inverse orthogonal transformation unit 109, and the process proceeds to step S120. In step S120, the inverse orthogonal transformation unit 109 performs inverse orthogonal transformation on the orthogonal transformation coefficient from the inverse quantization unit 108, and supplies a resulting residual to the arithmetic unit 110, and the process proceeds to step S121.

In step S121, the arithmetic unit 110 adds the residual from the inverse orthogonal transformation unit 109 and the prediction image outputted by the prediction image selection unit 116, and generates a decoded image corresponding to the original image subjected to operation of the residual by the arithmetic unit 103. The arithmetic unit 110 supplies the decoded image to the ILF 111, and the process proceeds from step S121 to step S122.

In step S122, the ILF 111 performs the filtering process as the prediction process (class classification prediction process) on the decoded image from the arithmetic unit 110, and supplies a filtered image obtained by the filtering process to the frame memory 112, and the process proceeds from step S122 to step S123.

In step S123, the frame memory 112 stores the filtered image supplied from the ILF 111 as a restored image obtained by restoring the original image, and the process proceeds to step S124. The filtered image stored as the restored image in the frame memory 112 is used as a reference image from which the prediction image is generated in steps S113 and S114.

In step S124, the reversible encoding unit 106 encodes coded data that is the quantized coefficient from the quantization unit 105, and generates an encoded bit stream including the coded data. Moreover, the reversible encoding unit 106 encodes, as necessary, encode information such as a quantization parameter QP used for quantization in the quantization unit 105, the prediction mode obtained by the intra-prediction process in the intra-predicting unit 114, and the prediction mode and motion information obtained by the inter motion prediction process by the motion prediction compensation unit 115, and includes the encode information in the encoded bit stream.

Furthermore, the reversible encoding unit 106 encodes the filter information set as the transmission target in step S104 in FIG. 23 as necessary, and includes the filter information in the encoded bit stream. Then, the reversible encoding unit 106 supplies the encoded bit stream to the accumulation buffer 107, and the process proceeds from step S124 to step S125.

In step S125, the accumulation buffer 107 accumulates the encoded bit stream from the reversible encoding unit 106, and the process proceeds to step S126. The encoded bit stream accumulated in the accumulation buffer 107 is appropriately read and transmitted.

In step S126, on the basis of a code amount (generated code amount) of the encoded bit stream accumulated in the accumulation buffer 107, the rate control unit 117 controls a rate of the quantization operation of the quantization unit 105 so as not to cause overflow or underflow, and the encoding process ends.

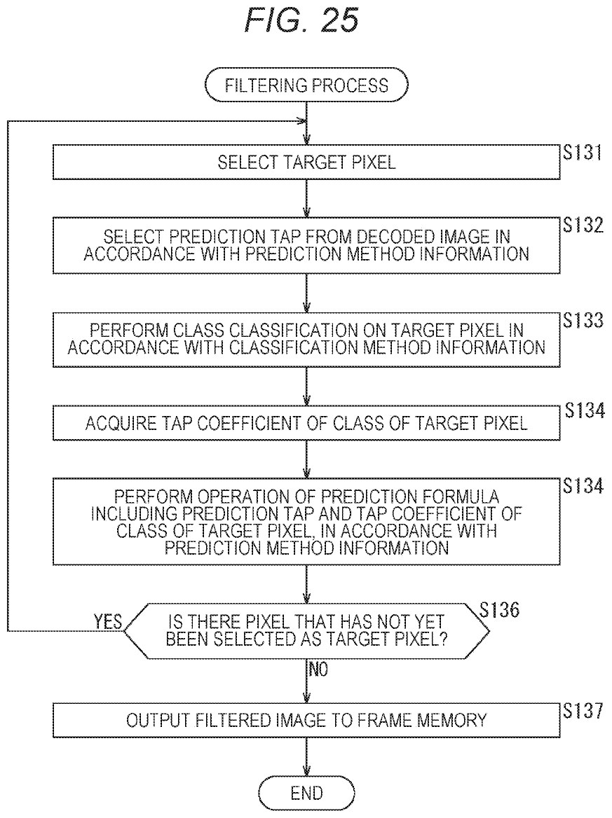

FIG. 25 is a flowchart illustrating an example of a filtering process performed in step S122 in FIG. 24.

In step S131, the prediction device 132 (FIG. 22) of the ILF 111 selects, as the target pixel, one pixel that has not yet been set as the target pixel among pixels of (a block as) the decoded image supplied from the arithmetic unit 110, and the process proceeds to step S132.

In step S132, for the target pixel, the prediction device 132 selects, from the decoded image, a pixel as a prediction tap having a tap structure according to the adopted prediction method indicated by the prediction method information included in the latest filter information stored in the filter information storage unit 171 in step S105 (FIG. 23), and the process proceeds to step S133.

In step S133, the prediction device 132 performs class classification on the target pixel with the adopted class classification method indicated by the classification method information included in the latest filter information stored in the filter information storage unit 171 in step S105, and the process proceeds to step S134.

In step S134, the prediction device 132 acquires a tap coefficient of the class of the target pixel from tap coefficients for every class as the coefficient information included in the latest filter information stored in the filter information storage unit 171 in step S105, and the process proceeds to step S135.

In step S135, the prediction device 132 performs a filtering process of applying, to the decoded image, a prediction formula that is formed with use of the prediction tap for the target pixel and the tap coefficient of the class of the target pixel and is according to the adopted prediction method indicated by the prediction method information stored in the filter information storage unit 171, that is, performs operation of the prediction formula, to obtain a filtered image.

Thereafter, the process proceeds from step S135 to step S136, and the prediction device 132 determines whether or not there is a pixel that has not yet been set as the target pixel among the pixels of (a block as) the decoded image from the arithmetic unit 110. When it is determined in step S136 that there is a pixel that has not yet been set as the target pixel, the process returns to step S131, and similar processing is repeated.

Furthermore, when it is determined in step S136 that there is no pixel that has not yet been set as the target pixel, the process proceeds to step S137, and the prediction device 132 supplies, to the frame memory 112 (FIG. 19), the filtered image including the pixel value obtained for (a block as) the decoded image from the arithmetic unit 110. Then, the filtering process ends, and the process returns.

<Configuration Example of Decoding Device 30>

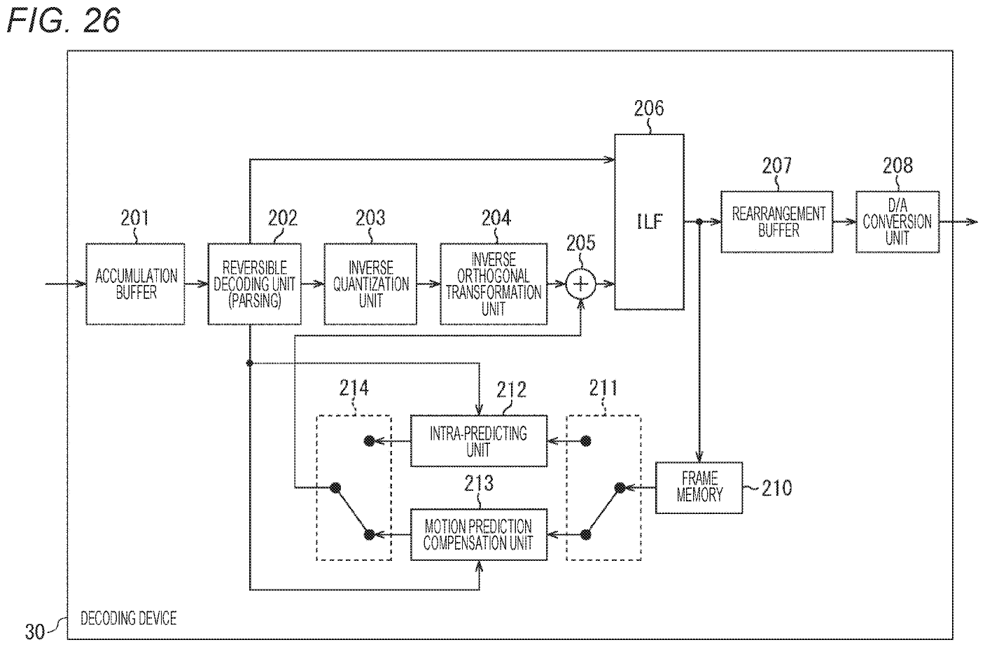

FIG. 26 is a block diagram illustrating a detailed configuration example of the decoding device 30 in FIG. 7.

In FIG. 26, the decoding device 30 includes an accumulation buffer 201, a reversible decoding unit 202, an inverse quantization unit 203, an inverse orthogonal transformation unit 204, an arithmetic unit 205, an ILF 206, a rearrangement buffer 207, and a D/A conversion unit 208. Furthermore, the decoding device 30 includes a frame memory 210, a selection unit 211, an intra-predicting unit 212, a motion prediction compensation unit 213, and a selection unit 214.

The accumulation buffer 201 temporarily accumulates an encoded bit stream transmitted from the encoding device 20, and supplies the encoded bit stream to the reversible decoding unit 202 at a prescribed timing.

The reversible decoding unit 202 receives the encoded bit stream from the accumulation buffer 201, and decodes the encoded bit stream with a method corresponding to the encoding method of the reversible encoding unit 106 in FIG. 19.

Then, the reversible decoding unit 202 supplies a quantization coefficient as coded data included in a decoding result of the encoded bit stream to the inverse quantization unit 203.

Furthermore, the reversible decoding unit 202 has a function of parsing. The reversible decoding unit 202 parses necessary encode information and filter information included in the decoding result of the encoded bit stream, and supplies the encode information to the intra-predicting unit 212, the motion prediction compensation unit 213, and other necessary blocks. Moreover, the reversible decoding unit 202 supplies the filter information to the ILF 206.

The inverse quantization unit 203 inversely quantizes the quantized coefficient as the coded data from the reversible decoding unit 202 with a method corresponding to the quantization method of the quantization unit 105 in FIG. 19, and supplies an orthogonal transformation coefficient obtained by the inverse quantization to the inverse orthogonal transformation unit 204.

The inverse orthogonal transformation unit 204 performs inverse orthogonal transformation on the orthogonal transformation coefficient supplied from the inverse quantization unit 203 with a method corresponding to the orthogonal transformation method of the orthogonal transformation unit 104 in FIG. 19, and supplies a resulting residual to the arithmetic unit 205.

The arithmetic unit 205 is supplied with the residual from the inverse orthogonal transformation unit 204, and is also supplied with a prediction image from the intra-predicting unit 212 or the motion prediction compensation unit 213 via the selection unit 214.

The arithmetic unit 205 adds the residual from the inverse orthogonal transformation unit 204 and the prediction image from the selection unit 214 to generate a decoded image, and supplies the decoded image to the ILF 206.

The ILF 206 performs a filtering process based on a class classification prediction process similarly to the ILF 111 in FIG. 19, and predicts (restores) an original image.

The ILF 206 is supplied with the decoded image from the arithmetic unit 205, and is also supplied with the filter information from the reversible decoding unit 202. The ILF 206 performs class classification on each pixel of the decoded image with an adopted class classification method indicated by classification method information of the filter information, and obtains a class of each pixel. Moreover, by applying, to each pixel of the decoded image, a prediction formula including a tap coefficient of the class of the pixel among adopted tap coefficients as coefficient information included in the filter information, the ILF 206 performs the filtering process as a prediction process of an adopted prediction method indicated by prediction method information of the filter information, and outputs a filtered image generated by the filtering process.

The filtered image outputted by the ILF 206 is an image similar to the filtered image outputted by the ILF 111 in FIG. 19, and is supplied to the rearrangement buffer 207 and the frame memory 210.

The rearrangement buffer 207 temporarily stores the filtered image supplied from the ILF 206 as a restored image obtained by restoring the original image, rearranges an order of frames (pictures) of the restored image from an encoding (decoding) order to a display order, and supplies the restored image to the D/A conversion unit 208.

The D/A conversion unit 208 performs D/A conversion on the restored image supplied from the rearrangement buffer 207, and outputs the restored image to a display (not shown) to display it.

The frame memory 210 temporarily stores the filtered image supplied from the ILF 206. Moreover, the frame memory 210 supplies, to the selection unit 211, the filtered image as a reference image to be used for generating a prediction image, at a prescribed timing or on the basis of an external request from the intra-predicting unit 212, the motion prediction compensation unit 213, or the like.

The selection unit 211 selects a supply destination of the reference image supplied from the frame memory 210. In a case of decoding an intra-coded image, the selection unit 211 supplies the reference image supplied from the frame memory 210 to the intra-predicting unit 212. Furthermore, in a case of decoding an inter-encoded image, the selection unit 211 supplies the reference image supplied from the frame memory 210 to the motion prediction compensation unit 213.

In accordance with a prediction mode included in the encode information supplied from the reversible decoding unit 202, the intra-predicting unit 212 uses the reference image supplied from the frame memory 210 via the selection unit 211, to perform intra-prediction with the intra-prediction mode used in the intra-predicting unit 114 in FIG. 19. Then, the intra-predicting unit 212 supplies a prediction image obtained by the intra-prediction to the selection unit 214.

In accordance with the prediction mode included in the encode information supplied from the reversible decoding unit 202, the motion prediction compensation unit 213 uses the reference image supplied from the frame memory 210 via the selection unit 211, to perform inter prediction with the inter prediction mode used in the motion prediction compensation unit 115 in FIG. 19. The inter prediction uses motion information and the like included in the encode information supplied from the reversible decoding unit 202, as necessary.

The motion prediction compensation unit 213 supplies the prediction image obtained by the inter prediction to the selection unit 214.

The selection unit 214 selects the prediction image supplied from the intra-predicting unit 212 or the prediction image supplied from the motion prediction compensation unit 213, and supplies the prediction image to the arithmetic unit 205.

Note that, in FIG. 26, the reversible decoding unit 2027, the inverse quantization unit 203 to the arithmetic unit 2057, and the ILF 206 correspond to the parsing unit 31 in FIG. 7, the decoding unit 32 in FIG. 7, and the filter unit 33 in FIG. 7, respectively.

<Configuration Example of ILF 206>

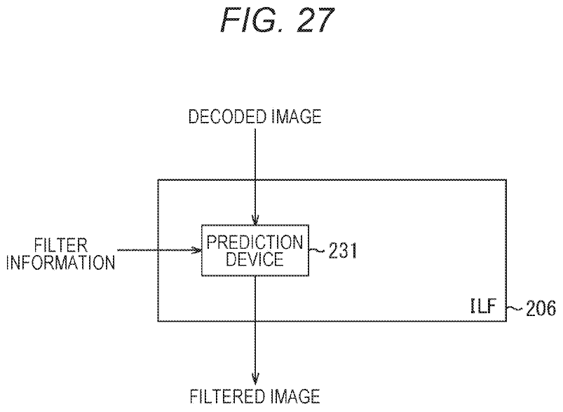

FIG. 27 is a block diagram illustrating a configuration example of the ILF 206 in FIG. 26.

In FIG. 27, the ILF 206 includes a prediction device 231.

The prediction device 231 is supplied with a decoded image from the arithmetic unit 205 (FIG. 26), and is also supplied with filter information from the reversible decoding unit 202.

The prediction device 231 uses filter information from the reversible decoding unit 202 to perform a filtering process as a class classification prediction process to generate a filtered image having a prediction value of the original image as a pixel value, and supplies the filtered image to the rearrangement buffer 207 and the frame memory 210 (FIG. 26).

That is, the prediction device 231 performs class classification on each pixel of the decoded image with an adopted class classification method indicated by classification method information of the filter information, and obtains a class of each pixel. Moreover, by applying, to each pixel of the decoded image, a prediction formula including a tap coefficient of the class of the pixel among adopted tap coefficients included in coefficient information of the filter information, the prediction device 231 performs the filtering process as the prediction process of an adopted prediction method indicated by a prediction method information of the filter information, and supplies a filtered image generated by the filtering process to the rearrangement buffer 207 and the frame memory 210.

<Configuration Example of Prediction Device 231>

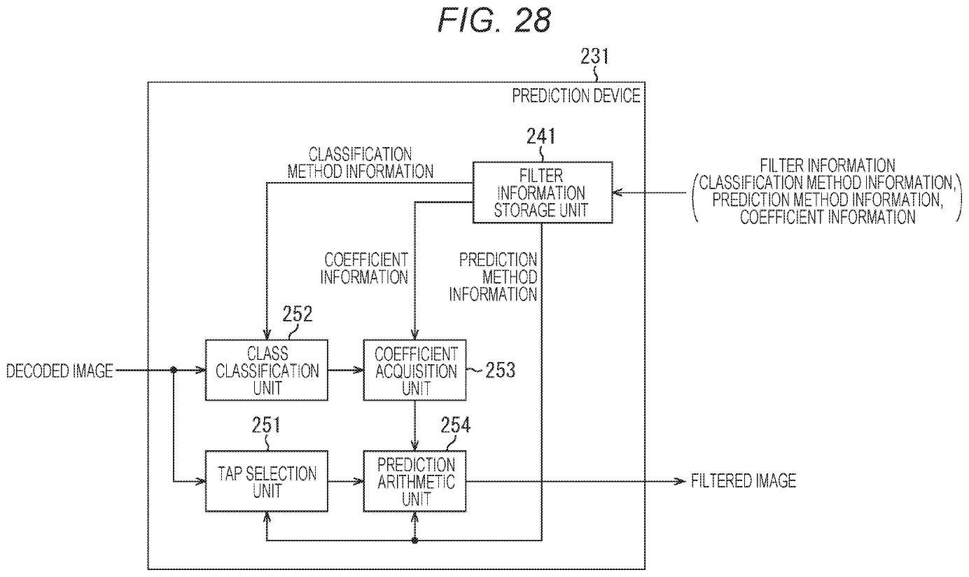

FIG. 28 is a block diagram illustrating a configuration example of the prediction device 231 in FIG. 27.

In FIG. 28, the prediction device 231 includes a filter information storage unit 241, a tap selection unit 251, a class classification unit 252, a coefficient acquisition unit 253, and a prediction arithmetic unit 254.

The filter information storage unit 241 and the tap selection unit 251 to the prediction arithmetic unit 254 have similar configurations to those of the filter information storage unit 171 and the tap selection unit 181 to the prediction arithmetic unit 184 in FIG. 22, respectively. Further, the prediction device 231 performs processing similar to that of the prediction device 132 in FIG. 22. Therefore, a description thereof will be omitted.

<Decoding Processing>

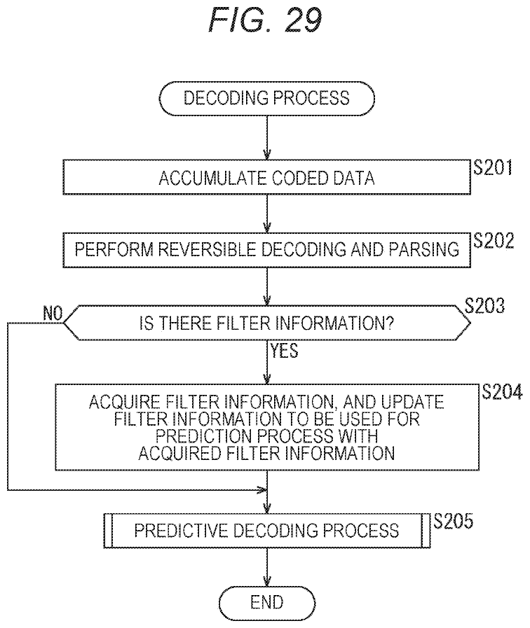

FIG. 29 is a flowchart for explaining an example of the decoding process by the decoding device 30 in FIG. 26.

In the decoding process, in step S201, the accumulation buffer 201 temporarily accumulates an encoded bit stream transmitted from the encoding device 20, and appropriately supplies the encoded bit stream to the reversible decoding unit 202, and the process proceeds to step S202.

In step S202, the reversible decoding unit 202 receives and decodes the encoded bit stream supplied from the accumulation buffer 201, and supplies a quantization coefficient as coded data included in a decoding result of the encoded bit stream, to the inverse quantization unit 203.

Furthermore, in a case where the decoding result of the encoded bit stream includes filter information and encode information, the reversible decoding unit 202 parses the filter information and the encode information. Then, the reversible decoding unit 202 supplies the necessary encode information to the intra-predicting unit 212, the motion prediction compensation unit 213, and other necessary blocks. Furthermore, the reversible decoding unit 202 supplies the filter information to the ILF 206.

Thereafter, the process proceeds from step S202 to step S203, and the ILF 206 determines whether or not the filter information has been supplied from the reversible decoding unit 202.

When it is determined in step S203 that the filter information has not been supplied, the process skips step S204 and proceeds to step S205.

Furthermore, when it is determined in step S203 that the filter information has been supplied, the process proceeds to step S204, and the prediction device 231 (FIG. 28) acquires the filter information from the reversible decoding unit 202. Moreover, the prediction device 231 updates filter information stored in the filter information storage unit 241 of the prediction device 231, with the filter information from the reversible decoding unit 202.

Then, the process proceeds from step S204 to step S205, a predictive decoding process is performed, and the decoding process ends.

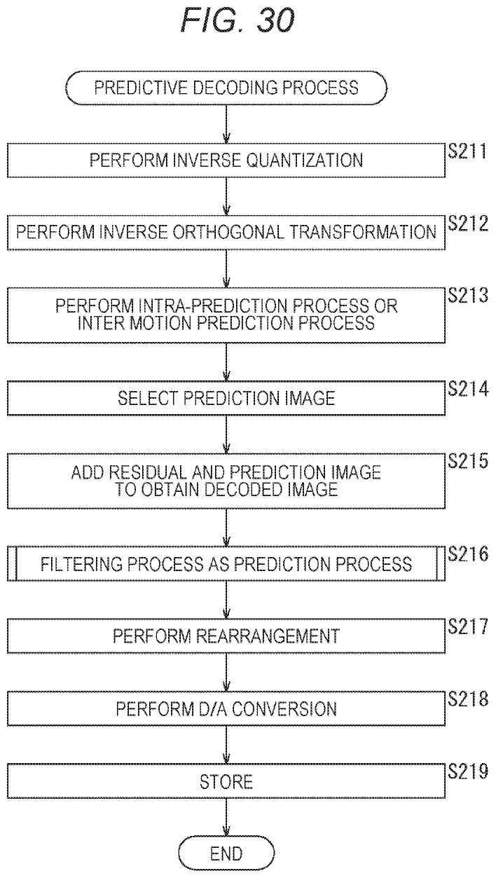

FIG. 30 is a flowchart for explaining an example of the predictive decoding process in step S205 in FIG. 29.

In step S211, the inverse quantization unit 203 inversely quantizes a quantization coefficient from the reversible decoding unit 202, and supplies a resulting orthogonal transformation coefficient to the inverse orthogonal transformation unit 204, and the process proceeds to step S212.

In step S212, the inverse orthogonal transformation unit 204 performs an inverse orthogonal transformation on the orthogonal transformation coefficient from the inverse quantization unit 203, and supplies a resulting residual to the arithmetic unit 205, and the process proceeds to step S213.

In step S213, the intra-predicting unit 212 or the motion prediction compensation unit 213 uses a reference image supplied from the frame memory 210 via the selection unit 211 and encode information supplied from the reversible decoding unit 202, to perform an intra-prediction process or an inter motion prediction process of generating a prediction image. Then, the intra-predicting unit 212 or the motion prediction compensation unit 213 supplies the prediction image obtained by the intra-prediction process or the inter motion prediction process to the selection unit 214, and the process proceeds from step S213 to step S214.

In step S214, the selection unit 214 selects the prediction image supplied from the intra-predicting unit 212 or the motion prediction compensation unit 213, and supplies the prediction image to the arithmetic unit 205, and the process proceeds to step S215.

In step S215, the arithmetic unit 205 generates a decoded image by adding a residual from the inverse orthogonal transformation unit 204 and the prediction image from the selection unit 214. Then, the arithmetic unit 205 supplies the decoded image to ILF 206, and the process proceeds from step S215 to step S216.

In step S216, the ILF 206 applies a filtering process as a prediction process (class classification prediction process) on a decoded image from the arithmetic unit 205, and supplies a filtered image obtained by the filtering process to the rearrangement buffer 207 and the frame memory 210, and the process proceeds from step S216 to step S217.

In step S217, the rearrangement buffer 207 temporarily stores the filtered image supplied from the ILF 206 as a restored image. Moreover, the rearrangement buffer 207 rearranges the stored restored image in a display order and supplies the image to the D/A conversion unit 208, and the process proceeds from step S217 to step S218.

In step S218, the D/A conversion unit 208 performs D/A conversion on the restored image from the rearrangement buffer 207, and the process proceeds to step S219. The restored image after the D/A conversion is outputted to and displayed on a display (not shown).

In step S219, the frame memory 210 stores the filtered image supplied from the ILF 206 as a restored image, and the decoding process ends. The restored image stored in the frame memory 210 is used as a reference image from which the prediction image is generated in the intra-prediction process or the inter motion prediction process in step S213.

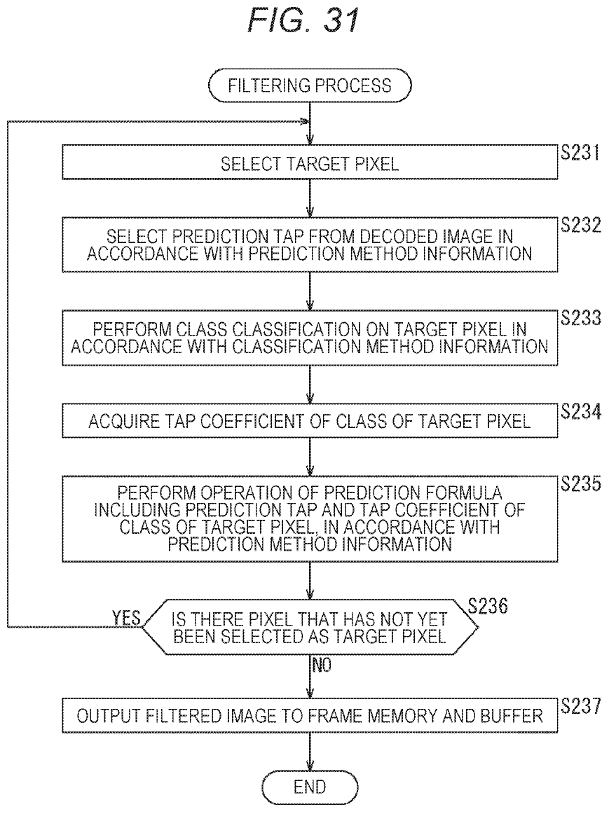

FIG. 31 is a flowchart illustrating an example of the filtering process performed in step S216 in FIG. 30.

In step S231, the prediction device 231 (FIG. 28) of the ILF 206 selects, as a target pixel, one pixel that has not yet been set as the target pixel among pixels of (a block as) the decoded image supplied from the arithmetic unit 205, and the process proceeds to step S232.

In step S232, for the target pixel, the prediction device 231 selects, from the decoded image, a pixel as a prediction tap having a tap structure according to an adopted prediction method indicated by prediction method information included in the latest filter information stored in the filter information storage unit 241 in step S204 (FIG. 29), and the process proceeds to step S233.

In step S233, the prediction device 231 performs class classification on the target pixel with an adopted class classification method indicated by classification method information included in the latest filter information stored in the filter information storage unit 241 in step S204, and the process proceeds to step S234.

In step S234, the prediction device 231 acquires a tap coefficient of a class of the target pixel from tap coefficients for every class as coefficient information included in the latest filter information stored in the filter information storage unit 241 in step S204, and the process proceeds to step S235.

In step S235, the prediction device 231 performs a filtering process of applying, to the decoded image, a prediction formula that is formed with use of the prediction tap for the target pixel and the tap coefficient of the class of the target pixel and is according to an adopted prediction method indicated by prediction method information stored in the filter information storage unit 241, that is, performs operation of the prediction formula to obtain a filtered image.

Thereafter, the process proceeds from step S235 to step S236, and the prediction device 231 determines whether or not there is a pixel that has not yet been set as the target pixel among the pixels of (a block as) the decoded image from the arithmetic unit 205. When it is determined in step S236 that there is a pixel that has not yet been set as the target pixel, the process returns to step S231, and similar processing is repeated.

Furthermore, when it is determined in step S236 that there is no pixel that has not yet been set as the target pixel, the process proceeds to step S237, and the prediction device 231 supplies the filtered image including a pixel value obtained for (a block as) the decoded image from the arithmetic unit 205 to the rearrangement buffer 207 and the frame memory 210 (FIG. 26). Then, the filtering process ends, and the process returns.

<Description of Computer Applied with Present Technology>

Next, the series of processes described above can be performed by hardware or also performed by software. In a case where the series of processes is performed by software, a program that forms the software is installed in a general-purpose computer and the like.

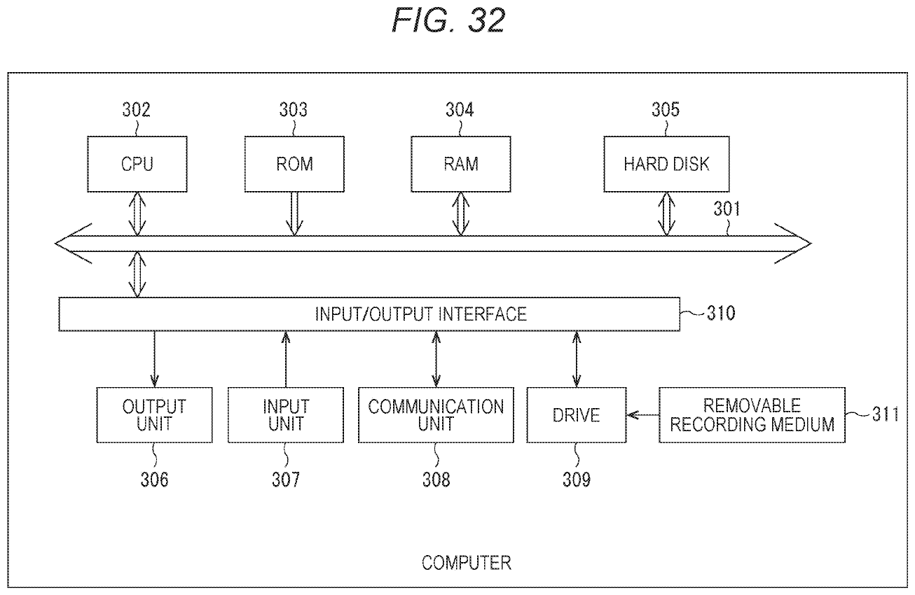

FIG. 32 is a block diagram illustrating a configuration example of an embodiment of a computer to be installed with a program for executing the series of processes described above.

The program can be recorded in advance on a hard disk 305 or a ROM 303 as a recording medium built in the computer.

Alternatively, the program can be stored (recorded) in a removable recording medium 311. Such a removable recording medium 311 can be provided as so-called package software. Here, examples of the removable recording medium 311 include, for example, a flexible disk, a compact disc read only memory (CD-ROM), a magneto optical (MO) disk, a digital versatile disc (DVD), a magnetic disk, a semiconductor memory, and the like.

Note that the program can be installed in the computer from the removable recording medium 311 as described above, or can be downloaded to the computer via a communication network or a broadcast network and installed in the built-in hard disk 305. That is, for example, the program can be wirelessly transferred from a download site to the computer via an artificial satellite for digital satellite broadcasting, or can be transferred by wire to the computer via a network such as a local area network (LAN) and the Internet.

The computer incorporates a central processing unit (CPU) 302, and an input/output interface 310 is connected to the CPU 302 via a bus 301.

When a command is inputted by a user operating an input unit 307 or the like via the input/output interface 310, in response to this, the CPU 302 executes a program stored in the read only memory (ROM) 303. Alternatively, the CPU 302 loads a program stored in the hard disk 305 into a random access memory (RAM) 304 and executes the program.

Therefore, the CPU 302 performs the processing according to the above-described flowchart or the processing performed by the configuration of the above-described block diagram. Then, as necessary, the CPU 302 causes a processing result to be outputted from an output unit 306 or transmitted from a communication unit 308 via the input/output interface 310, for example, and further to be recorded on the hard disk 305, and the like.

Note that the input unit 307 includes a keyboard, a mouse, a microphone, and the like. Furthermore, the output unit 306 includes a liquid crystal display (LCD), a speaker, and the like.

Here, in this specification, the processing performed by the computer according to the program needs not necessarily be performed in chronological order with the order described as the flowchart. That is, the processing performed by the computer according to the program includes processing executed in parallel or individually (for example, parallel processing or processing by an object).

Furthermore, the program may be processed by one computer (processor), or may be distributed and processed by a plurality of computers. Moreover, the program may be transferred to a remote computer to be executed.

Moreover, in this specification, a system means a set of a plurality of components (devices, modules (parts), and the like), and it does not matter whether or not all components are in a same housing. Therefore, a plurality of devices housed in separate housings and connected via a network, and a single device with a plurality of modules housed in one housing are both systems.

Note that the embodiment of the present technology is not limited to the above-described embodiment, and various modifications can be made without departing from the scope of the present technology.

For example, the present technology can have a cloud computing configuration in which one function is shared and processed in cooperation by a plurality of devices via a network.

Furthermore, each step described in the above-described flowchart can be executed by one device, and also shared and executed by a plurality of devices.

Moreover, in a case where one step includes a plurality of processes, the plurality of processes included in the one step can be executed by one device, and also shared and executed by a plurality of devices.

Furthermore, the effects described in this specification are merely examples and are not limited, and other effects may be present.

<Applicable Target of the Present Technology>

The present technology can be applied to any image encoding/decoding method. That is, unless there is a contradiction with the present technology described above, any specifications of various types of processing related to image encoding and decoding, such as transformation (inverse transformation), quantization (inverse quantization), and encoding (decoding), prediction, may be adopted, and are not limited to the example described above. Furthermore, some of these processes may be omitted unless there is a contradiction with the present technology described above.

<Unit of Processing>

Any unit of data in which various types of information described above are set and any unit of data targeted for various types of processing may be adopted, and are not limited to the examples described above. For example, these pieces of information and processing may be individually set for each transform unit (TU), transform block (TB), prediction unit (PU), prediction block (PB), coding unit (CU), largest coding unit (LCU), sub-block, block, tile, slice, picture, sequence, or component, or may target data of those units of data. Of course, this unit of data may be set for each piece of information and processing, and it is not necessary that units of data of all information and processing are unified. Note that these pieces of information may be stored at any place, and may be stored in a header, a parameter set, and the like of the above-described unit of data. Furthermore, these pieces of information may be stored at a plurality of locations.

<Control Information>

Control information related to the present technology described in each embodiment described above may be transmitted from the encoding side to the decoding side. For example, it is possible to transmit control information (for example, enabled flag) for controlling whether or not application of the present technology described above is permitted (or prohibited). Furthermore, for example, control information indicating a target to which the present technology described above is applied (or a target to which the present technology is not applied) may be transmitted. For example, control information specifying a block size (upper or lower limit, or both), a frame, a component, a layer, or the like to which the present technology is applied (or application is permitted or prohibited) may be transmitted.

<Block Size Information>

In specifying a size of a block to which the present technology is applied, it is also possible to indirectly specify the block size in addition to directly specifying the block size. For example, the block size may be specified with use of identification information for identifying the size.

Furthermore, for example, the block size may be specified with a ratio with or a difference from a size of a reference block (for example, an LCU, an SCU, or the like). For example, in a case of transmitting information for specifying the block size as a syntax element or the like, the information for indirectly specifying the size as described above may be used as the information. By doing like this, an information amount of the information can be reduced, and encoding efficiency may also be improved in some cases. Furthermore, the specification of the block size also includes specification of a range of the block size (for example, specification of a range of allowable block sizes, and the like).

<Others>

Note that, in this specification, “flag” is information for identifying a plurality of states, and includes not only information to be used for identifying two states of true (1) or false (0), but also information that enables identification of three or more states. Therefore, a value that can be taken by the “flag” may be, for example, a binary value of I/O, or may be a ternary value or more. That is, the number of bits included in the “flag” can take any number, and may be 1 bit or a plurality of bits. Furthermore, for the identification information (including the flag), in addition to a form in which the identification information is included in a bit stream, a form is assumed in which difference information of the identification information with respect to a certain reference information is included in the bit stream. Therefore, in this specification, the “flag” and the “identification information” include not only the information thereof but also the difference information with respect to the reference information.

Note that the present technology can have the following configurations.

<1>

A decoding device including:

a decoding unit configured to decode coded data included in an encoded bit stream by using a filtered image, to generate a decoded image; and

a filter unit configured to generate the filtered image by performing, on the decoded image generated by the decoding unit, a filtering process of applying a direct current (DC) prediction formula, the DC prediction formula being a prediction formula that includes a DC term and performs product-sum operation of a prescribed tap coefficient and a pixel of the decoded image.

<2>

The decoding device according to <1>, in which

the filter unit applies, to the decoded image, a prediction formula of an adopted prediction method to be adopted for the filtering process, in which the adopted prediction method is selected from a plurality of prediction methods including at least a prediction method using the DC prediction formula.

<3>

The decoding device according to <2>, in which

the filter unit applies, to the decoded image, a prediction formula of the adopted prediction method selected from a plurality of prediction methods including at least a prediction method using the DC prediction formula; and a prediction method using a higher-order prediction formula that is a prediction formula including a higher-order term of second-order or higher.

<4>

The decoding device according to <2> or <3>, in which

the filter unit applies, to the decoded image, a prediction formula of the adopted prediction method selected from a plurality of prediction methods including at least a prediction method using the DC prediction formula; and a prediction method using a first-order prediction formula that is a prediction formula including only a first-order term.

<5>

The decoding device according to any one of <2> to <4>, further including:

a parsing unit configured to parse prediction method information indicating the adopted prediction method included in the encoded bit stream, in which

the filter unit applies, to the decoded image, a prediction formula of the adopted prediction method indicated by the prediction method information parsed by the parsing unit.

<6>

The decoding device according to <5>, in which

the prediction method information includes: information indicating a prediction formula of the adopted prediction method; and information indicating a tap structure of a prediction tap that is a pixel to be used for operation of the prediction formula.

<7>

The decoding device according to any one of <1> to <6>, in which

the filter unit

performs class classification of classifying a pixel of the decoded image into any one of a plurality of classes, and

applies, to a pixel of the decoded image, the prediction formula including the tap coefficient of a class of the pixel.

<8>

The decoding device according to <7>, in which

the filter unit performs the class classification with a class classification method selected from a plurality of class classification methods.

<9>

The decoding device according to <8>, further including:

a parsing unit configured to parse classification method information indicating an adopted class classification method to be adopted for the class classification, in which the adopted class classification method is included in the encoded bit stream and selected from the plurality of class classification methods, in which

the filter unit performs the class classification with the adopted class classification method indicated by the classification method information parsed by the parsing unit.

<10>

The decoding device according to any one of <1> to <9>, in which

the decoding unit decodes the coded data with, as a unit of processing, a coding unit (CU) of a quad-tree block structure or a quad tree plus binary tree (QTBT) block structure.

<11>

A decoding method including:

decoding coded data included in an encoded bit stream by using a filtered image, to generate a decoded image; and

generating the filtered image by performing, on the decoded image, a filtering process of applying a direct current (DC) prediction formula, the DC prediction formula being a prediction formula that includes a DC term and performs product-sum operation of a prescribed tap coefficient and a pixel of the decoded image.

<12>

An encoding device including:

a filter unit configured to generate a filtered image by performing, on a decoded image that is locally decoded, a filtering process of applying a direct current (DC) prediction formula, the DC prediction formula being a prediction formula that includes a DC term and performs product-sum operation of a prescribed tap coefficient and a pixel of the decoded image; and

an encoding unit configured to encode an original image by using the filtered image generated by the filter unit.

<13>

The encoding device according to <12>, in which

the filter unit applies, to the decoded image, a prediction formula of an adopted prediction method to be adopted for the filtering process, in which the adopted prediction method is selected from a plurality of prediction methods including at least a prediction method using the DC prediction formula.

<14>

The encoding device according to <13>, in which

the filter unit applies, to the decoded image, a prediction formula of the adopted prediction method selected from a plurality of prediction methods including at least a prediction method using the DC prediction formula; and a prediction method using a higher-order prediction formula that is a prediction formula including a higher-order term of second-order or higher.

<15>

The encoding device according to <13> or <14>, in which

the filter unit applies, to the decoded image, a prediction formula of the adopted prediction method selected from a plurality of prediction methods including at least a prediction method using the DC prediction formula; and a prediction method using a first-order prediction formula that is a prediction formula including only a first-order term.

<16>

The encoding device according to any one of <13> to <15>, in which

the encoding unit generates an encoded bit stream including: coded data obtained by encoding the original image; and prediction method information indicating the adopted prediction method.

<17>

The encoding device according to <16>, in which

the prediction method information includes: information indicating a prediction formula of the adopted prediction method; and information indicating a tap structure of a prediction tap that is a pixel to be used for operation of the prediction formula.

<18>

The encoding device according to any one of <12> to <17>, in which

the filter unit

performs class classification of classifying a pixel of the decoded image into any one of a plurality of classes, and

applies, to a pixel of the decoded image, the prediction formula including the tap coefficient of a class of the pixel.

<19>

The encoding device according to <18>, in which

the filter unit performs the class classification with a classification method selected from a plurality of class classification methods.

<20>

The encoding device according to <19>, in which

the encoding unit generates an encoded bit stream including: coded data obtained by encoding the original image; and classification method information indicating an adopted class classification method to be adopted for the class classification, in which the adopted class classification method is selected from the plurality of class classification methods.

<21>

The encoding device according to any one of <12> to <20>, in which

the encoding unit encodes the original image with, as a unit of processing, a coding unit (CU) of a quad-tree block structure or a quad tree plus binary tree (QTBT) block structure.

<22>

An encoding method including:

generating a filtered image by performing, on a decoded image that is locally decoded, a filtering process of applying a direct current (DC) prediction formula, the DC prediction formula being a prediction formula that includes a DC term and performs product-sum operation of a prescribed tap coefficient and a pixel of the decoded image; and

encoding an original image by using the filtered image.

### REFERENCE SIGNS LIST

20 Encoding device
21 Encoding unit
22 Local decoding unit
23 Filter unit
30 Decoding device
31 Parsing unit
32 Decoding unit
33 Filter unit
41 Class classification unit
42 Predicting unit
43 Selection unit
44 DB
45 Class classification unit
46 Predicting unit
51 Class classification unit
52 Predicting unit
61 Class tap selection unit
62 Classification unit
63 Buffer
64 Parameter acquisition unit
65 Tap coefficient acquisition unit
66 Prediction tap selection unit
67 Prediction arithmetic unit
71 Class tap selection unit
72 Difference ADRC unit
73 Table storage unit
74 Classification threshold value setting unit
75 Difference ADRC unit
101 A/D conversion unit
102 Rearrangement buffer
103 Arithmetic unit
104 Orthogonal transformation unit
105 Quantization unit
106 Reversible encoding unit
107 Accumulation buffer
108 Inverse quantization unit
109 Inverse orthogonal transformation unit
110 Arithmetic unit
111 ILF
112 Frame memory
113 Selection unit
114 Intra-predicting unit
115 Motion prediction compensation unit
116 Prediction image selection unit
117 Rate control unit
131 Learning device
132 Prediction device
141 Selection unit
142 Learning unit
143 Selection unit
151 Tap selection unit
152 Class classification unit
153 Adding unit
154 Coefficient calculation unit
171 Filter information storage unit
181 Tap selection unit
182 Class classification unit
183 Coefficient acquisition unit
184 Prediction arithmetic unit
201 Accumulation buffer
202 Reversible decoding unit
203 Inverse quantization unit
204 Inverse orthogonal transformation unit
205 Arithmetic unit
206 ILF
207 Rearrangement buffer
208 D/A conversion unit
210 Frame memory
211 Selection unit
212 Intra-predicting unit
213 Motion prediction compensation unit
214 Selection unit
231 Prediction device
241 Filter information storage unit
251 Tap selection unit
252 Class classification unit
253 Coefficient acquisition unit
254 Prediction arithmetic unit
301 Bus
302 CPU
303 ROM
304 RAM
305 Hard disk
306 Output unit
307 Input unit
308 Communication unit
309 Drive
310 Input/output interface
311 Removable recording medium

1. A decoding device comprising:
a decoding unit configured to decode coded data included in an encoded bit stream by using a filtered image, to generate a decoded image;
a filter unit configured to generate the filtered image by performing, on the decoded image generated by the decoding unit, a filtering process of applying a direct current (DC) prediction formula, the DC prediction formula being a prediction formula that includes a DC term and performs product-sum operation of a prescribed tap coefficient and a pixel of the decoded image.

2. The decoding device according to claim 1, wherein
the filter unit applies, to the decoded image, a prediction formula of an adopted prediction method to be adopted for the filtering process, the adopted prediction method being selected from a plurality of prediction methods including at least a prediction method using the DC prediction formula.

3. The decoding device according to claim 2, wherein
the filter unit applies, to the decoded image, a prediction formula of the adopted prediction method selected from a plurality of prediction methods including at least a prediction method using the DC prediction formula; and a prediction method using a higher-order prediction formula that is a prediction formula including a higher-order term of second-order or higher.

4. The decoding device according to claim 2, wherein
the filter unit applies, to the decoded image, a prediction formula of the adopted prediction method selected from a plurality of prediction methods including at least a prediction method using the DC prediction formula; and a prediction method using a first-order prediction formula that is a prediction formula including only a first-order term.

5. The decoding device according to claim 2, further comprising:
a parsing unit configured to parse prediction method information indicating the adopted prediction method included in the encoded bit stream, wherein
the filter unit applies, to the decoded image, a prediction formula of the adopted prediction method indicated by the prediction method information parsed by the parsing unit.

6. The decoding device according to claim 5, wherein
the prediction method information includes: information indicating a prediction formula of the adopted prediction method; and information indicating a tap structure of a prediction tap that is a pixel to be used for operation of the prediction formula.

7. The decoding device according to claim 1, wherein
the filter unit
performs class classification of classifying a pixel of the decoded image into any one of a plurality of classes, and
applies, to a pixel of the decoded image, the prediction formula including the tap coefficient of a class of the pixel.

8. The decoding device according to claim 7, wherein
the filter unit performs the class classification with a class classification method selected from a plurality of class classification methods.

9. The decoding device according to claim 8, further comprising:
a parsing unit configured to parse classification method information indicating an adopted class classification method to be adopted for the class classification, the adopted class classification method being included in the encoded bit stream and selected from the plurality of class classification methods, wherein
the filter unit performs the class classification with the adopted class classification method indicated by the classification method information parsed by the parsing unit.

10. The decoding device according to claim 1, wherein
the decoding unit decodes the coded data with, as a unit of processing, a coding unit (CU) of a quad-tree block structure or a quad tree plus binary tree (QTBT) block structure.

11. A decoding method comprising:
decoding coded data included in an encoded bit stream by using a filtered image, to generate a decoded image; and
generating the filtered image by performing, on the decoded image, a filtering process of applying a direct current (DC) prediction formula, the DC prediction formula being a prediction formula that includes a DC term and performs product-sum operation of a prescribed tap coefficient and a pixel of the decoded image.

12. An encoding device comprising:
a filter unit configured to generate a filtered image by performing, on a decoded image that is locally decoded, a filtering process of applying a direct current (DC) prediction formula, the DC prediction formula being a prediction formula that includes a DC term and performs product-sum operation of a prescribed tap coefficient and a pixel of the decoded image; and
an encoding unit configured to encode an original image by using the filtered image generated by the filter unit.

13. The encoding device according to claim 12, wherein
the filter unit applies, to the decoded image, a prediction formula of an adopted prediction method to be adopted for the filtering process, the adopted prediction method being selected from a plurality of prediction methods including at least a prediction method using the DC prediction formula.

14. The encoding device according to claim 13, wherein
the filter unit applies, to the decoded image, a prediction formula of the adopted prediction method selected from a plurality of prediction methods including at least a prediction method using the DC prediction formula; and a prediction method using a higher-order prediction formula that is a prediction formula including a higher-order term of second-order or higher.

15. The encoding device according to claim 13, wherein
the filter unit applies, to the decoded image, a prediction formula of the adopted prediction method selected from a plurality of prediction methods including at least a prediction method using the DC prediction formula; and a prediction method using a first-order prediction formula that is a prediction formula including only a first-order term.

16. The encoding device according to claim 13, wherein
the encoding unit generates an encoded bit stream including coded data obtained by encoding the original image and prediction method information indicating the adopted prediction method.

17. The encoding device according to claim 16, wherein
the prediction method information includes: information indicating a prediction formula of the adopted prediction method; and information indicating a tap structure of a prediction tap that is a pixel to be used for operation of the prediction formula.

18. The encoding device according to claim 12, wherein
the filter unit
performs class classification of classifying a pixel of the decoded image into any one of a plurality of classes, and
applies, to a pixel of the decoded image, the prediction formula including the tap coefficient of a class of the pixel.

19. The encoding device according to claim 18, wherein
the filter unit performs the class classification with a class classification method selected from a plurality of class classification methods.

20. The encoding device according to claim 19, wherein
the encoding unit generates an encoded bit stream including: coded data obtained by encoding the original image; and classification method information indicating an adopted class classification method to be adopted for the class classification, the adopted class classification method being selected from the plurality of class classification methods.

21. The encoding device according to claim 12, wherein
the encoding unit encodes the original image with, as a unit of processing, a coding unit (CU) of a quad-tree block structure or a quad tree plus binary tree (QTBT) block structure.

22. An encoding method comprising:
generating a filtered image by performing, on a decoded image that is locally decoded, a filtering process of applying a direct current (DC) prediction formula, the DC prediction formula being a prediction formula that includes a DC term and performs product-sum operation of a prescribed tap coefficient and a pixel of the decoded image; and
encoding an original image by using the filtered image.
